(19) United States
(12) Patent Application Publication
(10) Pub. No.: US 2026/0301079 A1
(43) Pub. Date: Oct. 1, 2026

(54) SYSTEMS AND METHODS FOR MULTI-LINE INSURANCE PREPAREDNESS, RISK DETECTION, AND CLAIMS MANAGEMENT USING AI-ASSISTED ANALYSIS AND AUTOMATED WORKFLOW ENGINES

(71) Applicant: Magnolia Claim Management, Forsyth, GA (US)

(72) Inventors: Jennifer Nichole Taylor, Macon, GA (US); Patricia Cooper, Macon, GA (US)

(73) Assignee: Magnolia Claim Management, Forsyth, GA (US)

(21) Appl. No.: 19/572,210

(22) Filed: Mar. 19, 2026

Related U.S. Application Data
(60) Provisional application No. 63/778,921, filed on Mar. 27, 2025.

(51) Int. Cl. G06Q 40/08; G06F 40/174

(52) U.S. Cl. CPC G06Q 40/084; G06F 40/174; G06Q 40/09

(57) ABSTRACT

The present invention relates to computer-implemented systems and methods for processing homeowners' insurance policies and claim-related documents to generate evidence-anchored, machine-usable outputs for preparedness and claim readiness. A document ingestion interface receives a policy document file and optionally claim-related document files. Processors extract policy text, segment the text into clauses, and generate a canonical coverage data structure comprising standardized coverage fields. An evidence index maps canonical entries to corresponding source spans in segmented clause data. The system detects missing coverage-relevant fields and performs staged external enrichment using an AI web retrieval agent to retrieve supplemental property data and, based thereon, hazard classification data, including FEMA flood zone data, generating an enriched coverage data structure. Based on the enriched coverage data structure, the system generates a coverage-gap vector comprising gap signals including gap type, severity, confidence, and evidence references, and outputs gap signals with corresponding highlighted source spans.

### CROSS-REFERENCE TO RELATED APPLICATIONS

This application contains subject matter that is related to the subject matter of the following co-pending application. The below-listed application is hereby incorporated herein by reference in its entirety:
This is a U.S. non-provisional application that claims the benefits of a U.S. provisional application, Ser. No. 63/778,921, inventor Jennifer Nichole Taylor, entitled “AI-Powered Insurance Policy Analysis & Advocacy Platform”, filed Mar. 27, 2025.

### TECHNICAL FIELD OF THE INVENTION

This invention relates to insurance document processing and risk assessment systems, and particularly to computer-implemented systems and methods for ingesting homeowners' insurance policy and claim-related documents, transforming unstructured policy language into canonical machine-usable coverage data structures with evidence-anchored traceability, performing staged external data enrichment to populate missing property and hazard fields, generating computed coverage-gap vectors with severity and confidence values, and driving event-driven claim readiness workflows including task graph sequencing, deadline timer management, and template-ready claim artifact generation.

### BACKGROUND OF THE INVENTION

Before our invention, homeowners and other insured parties commonly faced significant difficulty understanding what their insurance policies actually covered, what exclusions or special limits applied, and what conditions could affect recovery during a claim. Insurance policies and related claim correspondence are typically lengthy, dense, and inconsistent across carriers, with key coverage terms distributed across declarations pages, forms, endorsements, and embedded clauses. Even sophisticated readers can struggle to locate and interpret the operative language, particularly where the same coverage concept is expressed using different terminology, formatting, or cross-references. As a result, coverage gaps and misalignments between expectations and policy terms are frequently discovered only after a loss occurs, when time pressure and documentation requirements are greatest.

Many prior approaches rely heavily on manual review by the insured, agents, adjusters, or other professionals. Manual review is slow, error-prone, and difficult to reproduce because different reviewers may interpret the same language differently, and because users often work from incomplete or outdated policy copies. In addition, manual review typically does not provide a reliable way to trace conclusions back to specific policy clauses in a manner that is readily verifiable by the insured or by downstream stakeholders. When a user is told that a coverage limitation exists, the user often cannot quickly confirm where the limitation appears, whether it is modified by an endorsement, or whether it applies in the particular context of the claim.

Other prior approaches provide generalized checklists or educational summaries intended to explain common types of coverage. While such materials can be helpful at a high level, they frequently do not reflect the insured's actual policy language and do not adapt to endorsements, special limits, and conditions that vary materially across policies. These approaches also tend to be disconnected from the user's real-world property context. Many homeowners' policies do not explicitly state coverage-relevant property attributes, and hazard classifications often depend on external data sources. As a result, prior approaches can struggle to quantify exposure or prioritize risks in a meaningful way when key property details are missing, uncertain, or scattered across disparate sources.

In the claim context, prior approaches often require users to manage a growing volume of claim correspondence and documents using email folders, paper files, and ad hoc spreadsheets. Deadlines may be buried in letters or policy conditions, and tracking obligations frequently depends on manual calendar entry and personal diligence. When new documents arrive, users must repeatedly re-evaluate what tasks are required and what has already been submitted, which can lead to missed deadlines, incomplete responses, duplicated effort, and unnecessary escalation. The absence of a consistent and structured way to relate policy conditions, claim events, and required documentation further increases the likelihood of confusion and errors.

Additionally, prior approaches typically lack a unified mechanism for generating claim-ready documentation outputs that are consistent, complete, and traceable to the underlying policy terms and supporting records. Users often assemble proof-of-loss materials and supporting documentation manually, which can lead to inconsistent formatting, omitted information, and uncertainty about which documents support which assertions. Without a structured workflow, it is difficult for users to maintain organized packages of materials that can be reused, shared, or audited over time.

The present invention addresses these and other shortcomings by providing systems and methods for multi-line insurance preparedness, risk detection, and claims management using artificial intelligence (AI)-assisted analysis and automated workflow engines. For these reasons and shortcomings, as well as other reasons and shortcomings, there is a long-felt need that gives rise to the present invention.

### SUMMARY OF THE INVENTION

The shortcomings of the prior art are overcome, and additional advantages are provided through the provision of an insurance policy-and-claim document normalization and event-driven claims readiness automation system that ingests a policy document file and an associated claim-related document file and executes a computer-implemented processing pipeline that converts heterogeneous, unstructured policy text into machine-usable intermediate representations with evidence-anchored traceability. In an exemplary embodiment, the system performs text extraction to generate policy text data, segments the policy text data into policy clauses to generate segmented clause data, and generates a canonical coverage data structure comprising standardized coverage fields including a coverage type field, a limit field, a sublimit field, an exclusion field, and a condition field. The system further generates an evidence index that maps entries of the canonical coverage data structure to corresponding source spans in the segmented clause data, enabling deterministic retrieval and display of supporting policy language for computed outputs.

In an exemplary embodiment, the system improves reliability and completeness of automated policy analysis by detecting missing coverage-relevant fields within the canonical coverage data structure and initiating an artificial intelligence web enrichment operation using an AI web retrieval agent to retrieve supplemental property data from one or more external data sources. The retrieved property data can include one or more of home size, home configuration, home construction attributes, and home valuation values, and the system generates an enriched coverage data structure by inserting the retrieved property data into the canonical coverage data structure to populate missing fields required for downstream computations. Based on the enriched coverage data structure, the system generates a coverage-gap vector data structure comprising gap signals that include a gap type, a severity value, a confidence value, and an evidence reference that references the evidence index, and outputs via a user interface at least one gap signal together with a corresponding source span identified by the evidence reference. In this manner, the system provides a technical improvement in computer processing of heterogeneous insurance policy documents by automatically augmenting a standardized coverage representation with externally retrieved property data and producing reproducible, evidence-anchored gap signals suitable for automated ranking, reporting, and downstream workflow control across policies that omit coverage-relevant fields.

Additional shortcomings of the prior art are overcome, and additional advantages are provided through the provision of an insurance policy-and-claim document normalization and event-driven claims readiness automation system that ingests a policy document file and a plurality of claim-related document files associated with a claim record and executes a computer-implemented workflow that converts heterogeneous claim correspondence into machine-usable event and workflow representations. In an exemplary embodiment, the system generates, from the policy document file, a canonical coverage data structure comprising standardized coverage fields including at least a condition field, and generates an evidence index that maps an entry in the canonical coverage data structure to a corresponding source span in extracted policy text, thereby enabling evidence-anchored traceability for policy-derived conditions and deadlines.

In an exemplary embodiment, the system classifies each claim-related document file into a corresponding document event type to generate a document event stream, and generates and maintains, based on the document event stream and the condition field, a task graph data structure comprising task nodes and dependency edges. The system further maintains a deadline timer data structure comprising deadline timers associated with corresponding task nodes and updates the task graph by adding, removing, or re-ranking one or more task nodes responsive to detecting changes in the document event stream. In this manner, the system provides a technical improvement in computer processing of heterogeneous claim-related document files by automatically controlling task sequencing and timer state using standardized intermediate representations, enabling reproducible, time-aware workflow automation that reduces manual tracking and improves deadline compliance.

Additionally, the shortcomings of the prior art are overcome, and additional advantages are provided through the provision of an insurance policy-and-claim document normalization and event-driven claims readiness automation system that ingests a policy document file, an inventory dataset, and an associated claim-related document file and executes a computer-implemented pipeline that converts policy constraints and inventory records into structured, evidence-anchored claim documentation outputs. In an exemplary embodiment, the system generates, from the policy document file, a canonical coverage data structure comprising standardized coverage fields including at least a sublimit field and a deductible field, and generates an evidence index that maps an entry in the canonical coverage data structure to a corresponding source span in extracted policy text, thereby preserving a deterministic evidence path to the policy language establishing applicable special limits and deductibles.

In an exemplary embodiment, the system generates, from the inventory dataset, an inventory item data structure comprising inventory item entries including at least an item category field and an item value field, detects missing coverage-relevant property fields within the canonical coverage data structure, and performs staged external enrichment by initiating a first artificial intelligence web enrichment operation to retrieve supplemental property data and a second artificial intelligence web enrichment operation to retrieve FEMA flood zone data based on one or more values of the supplemental property data. The system generates an enriched coverage data structure by inserting the retrieved property and hazard data into the canonical coverage data structure and generates a discrepancy data structure by comparing a sublimit field of the enriched coverage data structure to an item value field of at least one inventory item entry having a corresponding item category field, wherein the discrepancy data structure includes an evidence citation referencing the evidence index. The system then generates a claim artifact data structure comprising an artifact output field configured to populate a claim-ready document template using the discrepancy data structure and the inventory item data structure. In this manner, the system provides a technical improvement in computer processing by transforming unstructured policy constraints and inventory inputs, augmented by staged external data enrichment, into a template-ready artifact output with evidence-anchored traceability suitable for automated claim preparation, submission, and dispute packaging.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention, with advantages and features, refer to the description and the drawings.

### BRIEF DESCRIPTION OF THE FIGURES

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings, in which:

FIG. 1 illustrates one example of a public-facing landing page of the insurance policy-and-claim document normalization system, including a user interface presenting an introductory overview of automated policy analysis functionality and a call-to-action interface element configured to initiate a policy document upload or user authentication process;

FIG. 2 illustrates one example of an informational interface section of the system describing coverage risk categories and homeowner exposure areas, including example uncovered risk types (e.g., rebuilding cost gaps, water-related exclusions, additional living expense limits, and code upgrade exclusions), and further illustrating explanatory text indicating that automated policy scanning identifies hidden financial exposure values;

FIG. 3 illustrates one example of a document simplification interface configured to receive uploaded insurance-related documents (including policy forms, endorsements, declarations pages, insurer correspondence, estimates, or claim correspondence), wherein the interface transmits the document to a processing core configured to perform text extraction, clause segmentation, and plain-language summarization;

FIG. 4 illustrates one example of a safety and preparedness checklist interface configured to receive user inputs corresponding to property protection measures (e.g., smoke detectors, surge protection, emergency documentation), and wherein the checklist responses are stored as structured preparedness data used in the generation of a preparedness score;

FIG. 5 illustrates one example of a generated AI policy scan report interface presenting structured output derived from canonical coverage data extraction, including: identified critical coverage gaps, moderate risk areas, policy strengths, computed total potential exposure values, a dynamically generated action recommendation section, and other information. The interface presents exposure values derived from coverage-gap vector generation and provides a user-selectable action element to initiate remediation steps

FIG. 6 illustrates one example of a claim lifecycle dashboard interface displaying an active claim score computed from task completion state values within an event-driven task graph data structure, including a progress indicator and a claim mode activation control;

FIG. 7 illustrates one example of a preparedness dashboard interface presenting a preparedness score generated from structured checklist data and canonical policy data, including a computed readiness percentage and a visual progress indicator reflecting coverage optimization and documentation completeness;

FIG. 8 illustrates one example of an overall system architecture for the insurance policy-and-claim document normalization and event-driven claims readiness automation system, including a document ingestion interface, one or more processors, a non-transitory memory, and a user interface;

FIG. 9 illustrates one example of a high-level dataflow pipeline showing policy document ingestion→text extraction→clause segmentation→canonical coverage data structure generation→evidence index generation→coverage-gap vector generation→user interface output;

FIG. 10 illustrates one example of a data enrichment subsystem configured to detect missing coverage-relevant fields within a canonical coverage data structure and retrieve supplemental risk and valuation data from one or more external data sources, including public property records, FEMA flood zone databases, construction cost indices, and geographic hazard repositories. The subsystem applies statistical exposure modeling formulas to compute adjusted financial exposure values;

FIG. 11 illustrates one example of a gap signal view incorporating enriched severity computation, including presentation of a gap type, severity, confidence, and a highlighted source span linked via an evidence reference, wherein the severity value is adjusted based on externally retrieved hazard or valuation data;

FIG. 12 illustrates one example of an exposure modeling subsystem configured to apply one or more statistical or formula-based computations to enriched coverage data, including use of hazard modifiers, replacement cost values, and coverage shortfall percentages to generate an adjusted exposure value;

FIG. 13 illustrates one example of a user interface dashboard presenting enriched exposure outputs, including identified coverage gaps, adjusted exposure values, and a risk percentile ranking derived from external data enrichment and statistical modeling;

FIG. 14 illustrates one example of a hybrid external data retrieval architecture configured to detect missing coverage-relevant fields within a canonical coverage data structure and retrieve supplemental risk and valuation data through multiple retrieval pathways, including (i) structured application programming interface (API) connections, (ii) an AI-driven web retrieval agent, and (iii) a manual user entry interface, wherein retrieved data is normalized through a normalization layer and stored within an enriched coverage data structure;

FIG. 15 illustrates one example of a confidence composition subsystem configured to compute a gap signal confidence value as a weighted combination of multiple contributing factors, including a clause alignment score, a field completeness score, an external data authority score, and a model reliability score, wherein each factor is assigned a corresponding weight and combined to generate a composite confidence score associated with a detected coverage gap;

FIG. 16 illustrates one example of a risk percentile computation subsystem configured to compare an enriched exposure value against a reference distribution dataset and generate a percentile ranking output, wherein the percentile ranking represents a relative risk position of a homeowner's exposure value within a population-level exposure distribution;

FIG. 17 illustrates one example of an exposure modeling computation subsystem configured to generate an adjusted exposure value using enriched coverage data, including computation of replacement cost values and application of hazard modifier values to determine an adjusted replacement cost and a modeled coverage shortfall used to output an adjusted exposure value;

FIG. 18 illustrates one example of an end-to-end gap detection and prioritization workflow configured to identify missing or insufficient coverage fields within canonical coverage data, retrieve supplemental data via structured APIs, AI web retrieval, or manual entry, normalize the retrieved data, compute a composite confidence score, apply exposure modeling to generate an adjusted exposure value, and output prioritized gap results including a risk percentile calculation and ranked gap list;

FIG. 19 illustrates one example of a canonicalization subsystem that applies a normalization table to heterogeneous insurer terminology to generate coverage entry objects with standardized coverage fields (coverage type, limit, sublimit, exclusion, condition);

FIG. 20 illustrates one example of an internal structure of the canonical coverage data structure, depicting multiple coverage entry objects and the standardized coverage fields, including a condition field storing one or more deadline parameters;

FIG. 21 illustrates one example of an evidence index mapping mechanism that associates each entry in the canonical coverage data structure to a corresponding source span in segmented clause data, including example evidence references used by downstream outputs;

FIG. 22 illustrates one example of coverage-gap vector generation, including a plurality of gap signals each having a gap type, severity, confidence, and evidence reference, and including the generation of a clause alignment score and a field completeness score used to compute the confidence field;

FIG. 23 illustrates one example of a gap detection pattern library, and rule set versioning, including example exclusion patterns, sublimit patterns, and deadline-based patterns, and showing how a rule set version identifier is logged to a provenance log;

FIG. 24 illustrates one example of a provenance and auditability module, including creation of a document hash, timestamps, rule set versions, and a machine-readable export record containing the canonical coverage data structure, the evidence index, and the coverage-gap vector;

FIG. 25 illustrates one example of a user interface presentation of a gap signal with the corresponding source span highlighted and linked via the evidence reference, illustrating evidence-anchored explainability;

FIG. 26 illustrates one example of document event stream generation from a plurality of claim-related document files, including classification into document event types (denial, information request, reservation-of-rights, estimate) and optional classifier confidence values;

FIG. 27 illustrates one example of an event-driven task graph data structure, showing task nodes, dependency edges, task identifier fields, required artifact fields, deadline fields, and completion state fields;

FIG. 28 illustrates one example of a deadline timer subsystem that maintains a plurality of deadline timers, computes time-to-deadline values, applies a time-to-deadline threshold, and generates notification signals;

FIG. 29 illustrates one example of task graph updating logic responsive to a change in the document event stream, including adding/removing tasks and re-ranking tasks based on (i) time-to-deadline and (ii) an event type priority value;

FIG. 30 illustrates one example of a communication log data structure linked to task nodes, including communication timestamps, communication channel fields, and communication summary fields, and showing how communications are associated with workflow tasks;

FIG. 31 illustrates one example of an inventory subsystem generating an inventory item data structure with inventory item entries including an item category field, an item value field, and optional receipt attachment identifiers;

FIG. 32 illustrates one example of discrepancy generation between policy coverage constraints and inventory entries, including comparison of a sublimit value to an item value to generate a discrepancy data structure with discrepancy type, discrepancy severity, and an evidence citation field referencing the evidence index;

FIG. 33 illustrates one example of claim artifact generation that populates a claim-ready document template (e.g., a proof-of-loss template) using the discrepancy data structure and the inventory item data structure, including insertion of an itemized list, a computed subtotal, and evidence citations;

FIG. 34 illustrates one example of an inclusion rule evaluation for claim artifact population, including a rule requiring a receipt attachment identifier and illustrating selection of inventory item entries that satisfy the inclusion rule;

FIG. 35 illustrates one example of creation and storage of a dispute package data structure, including a document list field identifying the policy document file and claim-related document file, a timestamp field, and inclusion of the claim artifact data structure; and

FIG. 36 illustrates one example of end-to-end operation states (“policy analysis mode” and “claim mode”) showing how the same canonical coverage data structure and evidence index are reused across (i) coverage-gap vector generation, (ii) event-driven task graph generation, and (iii) claim artifact generation for practical application and enablement.

The detailed description explains the preferred embodiments of the invention, together with advantages and features, by way of example, with reference to the drawings.

### DETAILED DESCRIPTION OF THE INVENTION

Homeowners routinely purchase insurance with the expectation that, if a loss occurs, the policy will respond in a predictable way. In practice, homeowners' policies are dense, highly variable across carriers, and frequently modified by endorsements, exclusions, special limits, and condition clauses that are difficult to interpret without specialized expertise. Even when a homeowner has a complete copy of the policy, critical information is distributed across multiple sections and documents, and different forms can describe the same concept using different terminology or formatting. As a result, homeowners often do not discover meaningful coverage gaps until a claim occurs, at which point time pressure and documentation requirements increase the likelihood of missed deadlines, incomplete submissions, and preventable financial exposure. This problem is amplified when a policy document is incomplete, when home details are not explicitly stated in the policy forms, or when risk factors depend on external data such as flood zone classification, elevation, local building code considerations, or construction cost indices.

Existing approaches commonly rely on manual review, generalized checklists, or static summaries that do not provide reproducible, evidence-anchored outputs. Many tools focus on presenting explanations rather than producing machine-usable data structures that can drive downstream computations, workflow automation, and document preparation. In addition, many homeowners are unable to supply all the information necessary to quantify exposure, such as accurate home configuration details, replacement cost drivers, or hazard classifications. In those cases, a system that merely reads policy text cannot reliably compute exposure or rank risks in a consistent way.

The present invention addresses these limitations with a computer-implemented system that ingests homeowners' insurance policy documents and claim related documents and transforms the unstructured text into a canonical coverage data structure suitable for machine processing. The system segments extracted policy text into clauses and generates an evidence index that maps normalized coverage entries to corresponding source spans in the policy text, enabling traceable, reproducible outputs. Based on the canonical coverage data structure, the system generates a coverage-gap vector data structure containing gap signals that include computed severity and confidence values and evidence references. The confidence values may be computed from multiple contributing factors, including clause alignment and field completeness metrics, thereby improving reliability and enabling downstream prioritization.

The system further improves coverage analysis in cases where the policy documents do not contain complete coverage-relevant information by performing staged enrichment. In a first enrichment stage, the system uses an artificial intelligence (AI)-driven retrieval mechanism, structured interface access, and/or user-provided input to obtain property attribute data such as home size, configuration, construction attributes, and valuation parameters, and inserts those values into an enriched coverage representation. In a second enrichment stage, the system uses at least one value produced by the first enrichment stage to retrieve hazard classification data, including FEMA flood zone information, and incorporates that hazard data into the enriched coverage representation. The resulting enriched coverage data structure enables statistical exposure modeling and severity scaling that are not possible using policy text alone, and supports the generation of user-facing reports that quantify potential exposure and present evidence-anchored explanations.

In addition to pre-claim preparedness analysis, the invention supports claim readiness and claim execution by generating and maintaining structured workflow data, including task graphs and deadline timers that can be updated based on incoming claim documents and extracted policy conditions. In some implementations, the system generates claim artifacts, such as structured dispute packages and proof-of-loss preparation outputs, using the same canonical and enriched representations, thereby improving consistency between policy interpretation, risk estimation, and claim documentation. The figures illustrate representative user interfaces and reports, a system architecture and processing pipeline, the staged enrichment subsystem, confidence score composition, exposure modeling and percentile ranking, evidence-anchored gap signal presentation, and workflow automation elements.

### Definations

In the present invention, the term “about” is intended to mean a value that may vary from a stated value by a tolerance consistent with measurement accuracy, implementation variability, and the context of use.

In the present invention, the term “approximately” is intended to mean a value that may vary from a stated value by a tolerance consistent with measurement accuracy, implementation variability, and the context of use.

In the present invention, the term “substantially” is intended to mean largely, but not necessarily wholly, the stated characteristic, with allowances for ordinary engineering, implementation, and measurement tolerances.

In the present invention, the term “range” or “ranging from” is intended to mean that each intervening value between the stated endpoints is included, as if expressly recited, and that the endpoints are included unless expressly stated otherwise.

In the present invention, the term “between X and Y” is intended to mean inclusive of X and Y unless expressly indicated as exclusive.

In the present invention, the term “at least one of A, B, and C” is intended to mean any one or more of A, B, and C, including any combination thereof.

In the present invention, the term “and/or” is intended to mean any one or more of the associated items, including any combination thereof.

In the present invention, the term “configured to” is intended to mean arranged, designed, programmed, or otherwise enabled to perform a stated function, including by executing machine-readable instructions.

In the present invention, the term “policy document file” is intended to mean any digital file containing insurance policy information, including declarations pages, policy forms, endorsements, riders, and attached schedules, in any file format.

In the present invention, the term “claim-related document file” is intended to mean any digital file associated with a claim record, including correspondence, letters, portal messages, estimates, scopes, invoices, receipts, photographs, and requests for information.

In the present invention, the term “text extraction” is intended to mean a computer-implemented operation that generates machine-readable text data from a document file, including by parsing embedded text, optical character recognition, layout reconstruction, or combinations thereof.

In the present invention, the term “policy text data” is intended to mean machine-readable text content derived from a policy document file and stored in a format suitable for computational processing.

In the present invention, the term “clause” is intended to mean a segmented unit of policy text, including a sentence, paragraph, section, table row, or other portion of text treated as a discrete addressable unit by the system.

In the present invention, the term “segmented clause data” is intended to mean a structured collection of clauses produced from policy text data, wherein each clause is associated with an identifier and a locational descriptor.

In the present invention, the term “source span” is intended to mean a locational descriptor identifying where text appears in a document, including by page number, character offsets, line offsets, bounding box coordinates, clause identifier, or combinations thereof.

In the present invention, the term “canonical coverage data structure” is intended to mean a machine-usable structured representation of policy coverage information comprising standardized coverage fields and one or more coverage entry objects normalized from heterogeneous policy language.

In the present invention, the term “coverage entry object” is intended to mean a structured record within a canonical coverage data structure corresponding to a coverage concept, limitation, exclusion, special limit, condition, or endorsement-derived requirement.

In the present invention, the term “coverage type field” is intended to mean a standardized field storing a normalized coverage category token or label associated with a coverage entry object.

In the present invention, the term “limit field” is intended to mean a standardized field storing a coverage limit value and, optionally, associated units and qualifiers.

In the present invention, the term “sublimit field” is intended to mean a standardized field storing a special limit value applicable to a subcategory, condition, or enumerated category of property or loss.

In the present invention, the term “exclusion field” is intended to mean a standardized field storing a normalized exclusion descriptor, exclusion token, or exclusion classification used for computational evaluation.

In the present invention, the term “condition field” is intended to mean a standardized field storing one or more policy conditions, including time-based conditions, procedural duties, or other requirements affecting coverage or claim handling.

In the present invention, the term “deadline parameter” is intended to mean a normalized, machine-readable representation of a time-based requirement, including a duration, a date, a trigger event plus duration, or combinations thereof.

In the present invention, the term “evidence index” is intended to mean a machine-usable mapping structure that links one or more entries or fields of a canonical or enriched coverage data structure to corresponding source spans in segmented clause data.

In the present invention, the term “evidence reference” is intended to mean an identifier, pointer, or key that references an entry in an evidence index for retrieving one or more source spans.

In the present invention, the term “missing coverage-relevant field” is intended to mean a standardized field determined by the system to be absent, incomplete, invalid, inconsistent, or otherwise insufficient for one or more downstream computations.

In the present invention, the term “AI web retrieval agent” is intended to mean a computer-implemented retrieval module that performs controlled acquisition of external data from one or more sources, including by generating queries, retrieving results, extracting candidate values, and transforming extracted values into structured fields.

In the present invention, the term “first AI web enrichment operation” is intended to mean an enrichment process that retrieves property-related supplemental data and inserts the retrieved data into a structured representation.

In the present invention, the term “second AI web enrichment operation” is intended to mean an enrichment process that retrieves hazard-related supplemental data based on one or more values obtained in a first AI web enrichment operation and inserts the retrieved data into a structured representation.

In the present invention, the term “supplemental property data” is intended to mean data values describing property attributes, configuration, construction, or valuation, retrieved from external sources and/or user input.

In the present invention, the term “supplemental hazard data” is intended to mean data values describing hazard classifications or hazard modifiers, including flood-zone-related information, retrieved from external sources and/or user input.

In the present invention, the term “FEMA flood zone data” is intended to mean hazard classification information corresponding to one or more FEMA flood zone designations and associated attributes, including any derived tokens, modifiers, or normalized representations.

In the present invention, the term “normalization table” is intended to mean a stored mapping of heterogeneous terms, identifiers, and qualifiers to standardized vocabulary tokens used in canonicalization.

In the present invention, the term “enriched coverage data structure” is intended to mean a machine-usable structured representation produced by inserting one or more externally retrieved or user-provided values into a canonical coverage data structure to populate missing or supplemental fields.

In the present invention, the term “coverage-gap vector data structure” is intended to mean a machine-usable structured collection of gap signals generated from canonical and/or enriched coverage data.

In the present invention, the term “gap signal” is intended to mean a structured record indicating a detected gap, limitation, inconsistency, or risk condition, comprising at least a gap type field and one or more computed fields.

In the present invention, the term “gap type field” is intended to mean a field storing a normalized classification of a gap signal, including exclusion-related gaps, sublimit-related gaps, condition-related gaps, or adequacy-related gaps.

In the present invention, the term “severity field” is intended to mean a computed field representing the magnitude or importance of a gap signal, including numerical and/or categorical severity representations.

In the present invention, the term “confidence field” is intended to mean a computed field representing a reliability measure for a gap signal based on one or more computed metrics, including clause match scoring and field completeness scoring.

In the present invention, the term “clause match score” is intended to mean a computed value representing alignment between a clause and a detection rule, pattern, or classifier output.

In the present invention, the term “coverage-field completeness score” is intended to mean a computed value representing completeness and validity of required fields in a canonical or enriched coverage data structure.

In the present invention, the term “document event type” is intended to mean a standardized classification assigned to a claim-related document file based on extracted content and/or structural cues.

In the present invention, the term “document event stream” is intended to mean a machine-usable time-ordered structure comprising document event entries generated from claim-related document files.

In the present invention, the term “task graph data structure” is intended to mean a machine-usable graph representation comprising task nodes and dependency edges used to control workflow sequencing.

In the present invention, the term “task node” is intended to mean a structured record representing a workflow task, including fields for task identification, required artifacts, timing parameters, and completion state.

In the present invention, the term “dependency edge” is intended to mean a directed relationship between task nodes indicating ordering, gating, or dependency constraints.

In the present invention, the term “deadline timer data structure” is intended to mean a machine-usable collection of deadline timer records associated with task nodes and used to compute time-to-deadline values.

In the present invention, the term “time-to-deadline threshold” is intended to mean a stored value used to trigger a notification, escalation, or re-ranking when a computed time-to-deadline satisfies the threshold.

In the present invention, the term “notification signal” is intended to mean a machine-generated output configured to trigger an alert through one or more channels, including an in-application alert, email, SMS, or push notification.

In the present invention, the term “inventory dataset” is intended to mean a digital dataset describing items of property, including item descriptors, categories, values, and optionally documentation identifiers.

In the present invention, the term “inventory item data structure” is intended to mean a machine-usable structured collection of inventory item entries generated from an inventory dataset.

In the present invention, the term “discrepancy data structure” is intended to mean a machine-usable record generated by comparing one or more policy constraints to one or more inventory item entries and storing the comparison result with evidence anchoring.

In the present invention, the term “claim artifact data structure” is intended to mean a machine-usable structured output configured to populate a claim-ready document template.

In the present invention, the term “claim-ready document template” is intended to mean a structured document schema with placeholders configured to be populated using machine-usable data structures to generate a claim submission or support document.

In the present invention, the term “dispute package data structure” is intended to mean a machine-usable container that stores a list of associated documents and one or more claim artifacts together with a timestamp for retrieval, sharing, or audit.

In the present invention, the term “computer-implemented” is intended to mean implemented at least in part by one or more processors executing machine-readable instructions stored in a non-transitory memory.

In the present invention, the term “module” is intended to mean a hardware component, a software component, or a combination thereof, including one or more routines, services, models, or instruction sets executable by one or more processors.

In the present invention, the term “processing core” is intended to mean one or more processors and associated memory configured to execute document ingestion, extraction, segmentation, canonicalization, enrichment, scoring, and output generation operations.

In the present invention, the term “client computing device” is intended to mean a device capable of rendering a user interface and transmitting or receiving data, including a smartphone, tablet, laptop, desktop, or other computing device.

In the present invention, the term “user interface” is intended to mean a graphical and/or programmatic interface configured to present computed outputs and receive user inputs, including web interfaces, mobile interfaces, and application programming interfaces.

In the present invention, the term “user session” is intended to mean a logical context for processing one or more documents and storing associated intermediate representations, including a session identifier and associated state information.

In the present invention, the term “claim record” is intended to mean a structured record representing a claim context, including identifiers linking policy documents, claim-related documents, inventory data, tasks, and generated artifacts.

In the present invention, the term “policy analysis mode” is intended to mean an operational state in which the system generates outputs related to coverage gaps, exposure estimation, and preparedness scoring using canonical and enriched coverage representations.

In the present invention, the term “claim mode” is intended to mean an operational state in which the system generates and updates workflow tasks, deadline timers, and claim artifacts using canonical and enriched coverage representations and claim-related document events.

In the present invention, the term “provenance metadata” is intended to mean metadata associated with an input, intermediate representation, or computed output, including one or more of source identifiers, timestamps, version identifiers, and confidence indicators.

In the present invention, the term “source identifier” is intended to mean an identifier of an origin of a value, including an external data source, an API endpoint, a web resource, a user entry source, or an internal computation source.

In the present invention, the term “authority score” is intended to mean a computed or assigned indicator of reliability of a data source or retrieved value, including, based on source type, recency, consistency across sources, or user confirmation.

In the present invention, the term “retrieval log” is intended to mean a stored record of an external data retrieval operation, including one or more of a query descriptor, a source identifier, a retrieval timestamp, and a retrieved value identifier.

In the present invention, the term “hazard modifier” is intended to mean a scaling factor derived from hazard classification data and applied to a computed shortfall, severity value, or exposure value.

In the present invention, the term “replacement cost value” is intended to mean a computed value estimating a cost to repair or replace a structure based on one or more property attributes and one or more cost index values.

In the present invention, the term “coverage shortfall” is intended to mean a computed difference between a modeled requirement value and an applicable policy limit value or sublimit value.

In the present invention, the term “modeled exposure value” is intended to mean a computed value representing estimated financial exposure associated with one or more gap signals, including, based on coverage shortfall and hazard modifier application.

In the present invention, the term “reference distribution dataset” is intended to mean a dataset storing population-level exposure values or exposure proxies used to compute percentile rankings for a modeled exposure value.

In the present invention, the term “percentile ranking” is intended to mean a computed comparative metric indicating a relative position of a modeled exposure value within a reference distribution dataset.

In the present invention, the term “priority score” is intended to mean a computed value used to rank tasks or gap signals, including, based on one or more of time-to-deadline, event type priority, severity, and confidence.

In the present invention, the term “event type priority value” is intended to mean a stored value associated with a document event type used to influence task creation, escalation, or re-ranking.

In the present invention, the term “required artifact” is intended to mean an item of documentation or data required for completion of a task node, including a proof-of-loss form, estimate, invoice, receipt, photograph set, or correspondence response.

In the present invention, the term “artifact detection” is intended to mean a computer-implemented operation that determines whether an ingested document or dataset satisfies a required artifact field.

In the present invention, the term “completion state” is intended to mean a machine-readable indicator of a status of a task node, including incomplete, complete, pending, verified, or other defined states.

In the present invention, the term “re-ranking” is intended to mean computing an updated ordering of task nodes or gap signals using one or more computed priority inputs.

In the present invention, the term “inclusion rule” is intended to mean a stored rule used to select inventory item entries for inclusion in a claim artifact, including requirements for supporting documentation identifiers and/or value thresholds.

In the present invention, the term “template population” is intended to mean inserting structured values from one or more data structures into defined fields of a claim-ready document template to produce a populated output.

In the present invention, the term “machine-readable export record” is intended to mean a stored output record comprising one or more intermediate representations and computed outputs, including at least one of canonical coverage data, enriched coverage data, evidence index entries, gap signals, or provenance metadata.

In the present invention, the term “rule set version identifier” is intended to mean a value identifying a version of detection patterns, thresholds, weights, or other configuration used in generating gap signals, confidence values, or exposure computations.

In the present invention, the term “model version identifier” is intended to mean a value identifying a version of a classifier, retrieval model, or other model component used in generating classifications, confidence values, or retrieval outputs.

In the present invention, the term “risk category” is intended to mean a normalized classification used to group one or more gap signals, tasks, or recommendations, including categories associated with water risk, rebuild adequacy, code upgrades, loss of use, and special limits.

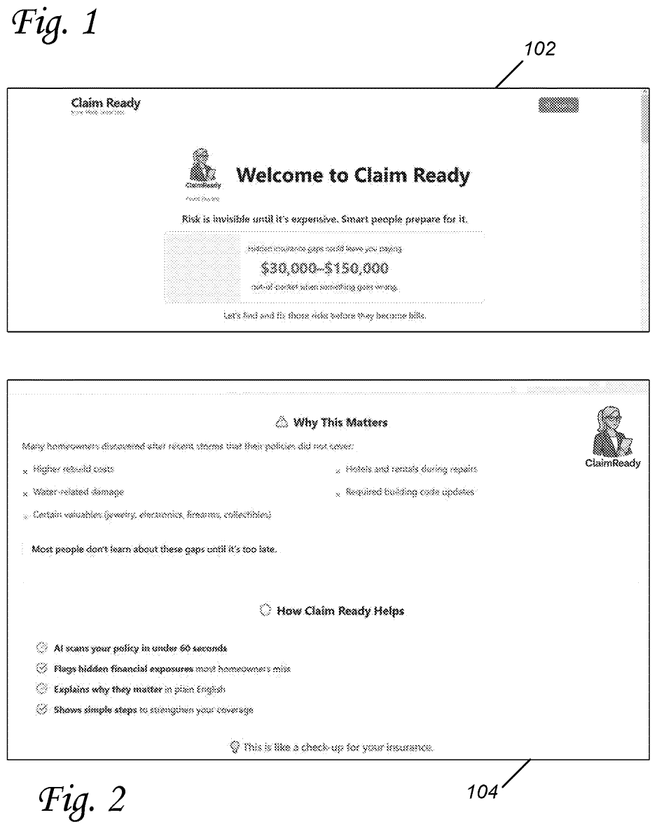

Turning now to the drawings in greater detail, it will be seen that in FIG. 1 there is illustrated one example of a public-facing landing page of the insurance policy-and-claim document normalization and event-driven claims readiness automation system, including a user interface 102 presenting an introductory overview of automated policy analysis functionality and one or more user-selectable interface elements configured to initiate a user session in which policy documents can be ingested and analyzed.

In an exemplary embodiment, a landing-page user interface 102 can be rendered on a client computing device, such as a browser executing on a desktop or mobile platform. The user interface 102 can present a welcome screen and an overview message that communicates a computed exposure range and associated risk framing for homeowners. While this content can be informational, the user interface 102 can be technically configured as an entry point into a controlled document-processing session, in which subsequent actions by the user cause the system to initialize a processing pipeline that converts unstructured policy documents into machine-usable data structures used for downstream computation and automation.

In an exemplary embodiment, selection of a session initiation control within the user interface 102 can cause the system to establish an authenticated or otherwise validated user session, such as by creating a session token, associating the session token with a user profile record, and allocating storage and processing resources for the session. In this state, the user interface 102 can be configured to guide the user to provide one or more policy document files and optionally claim-related document files, and to transmit those files to a document ingestion interface. The document ingestion interface can include client-side upload logic that packages file content and metadata, such as timestamps and file hashes, and securely transmits the file content to a processing core. The processing core can then perform text extraction and clause segmentation, generate a canonical coverage data structure, generate an evidence index mapping canonical entries to source spans in the segmented clause data, and generate a coverage-gap vector that includes gap signals with computed severity and confidence values that remain traceable to corresponding source spans. In this manner, the user interface 102 can be more than a static informational page because it can be integrated with the system's technical architecture to initiate the ingestion and transformation processes that enable reproducible, evidence-anchored outputs.

In an exemplary embodiment, the user interface 102 can also capture or request homeowner context that improves computational accuracy and reduces user burden, including an address, property configuration details, and other coverage-relevant fields. When one or more such fields are missing or incomplete, the system can be configured to initiate staged enrichment in which an AI web retrieval agent retrieves property attribute data, and then uses one or more values from that property attribute data to retrieve hazard classification data, such as FEMA flood zone data. These staged enrichments can then be inserted into an enriched coverage data structure that drives exposure modeling formulas, severity scaling, and risk percentile computations presented in later report interfaces, while preserving evidence-anchored explainability for policy-derived fields.

Advantageously, the landing-page user interface 102 can serve as a controlled initiation point for a technical workflow that improves computer processing of heterogeneous insurance policy documents by transforming unstructured text into standardized, machine-usable representations with traceable evidence mappings, rather than relying on prior approaches that present generic checklists or require manual reading and interpretation of complex policy language. The resulting architecture can provide a practical application that produces concrete machine outputs, including structured gap vectors, enriched exposure values, and workflow automation artifacts, thereby grounding the disclosed functionality in specific data transformations and system-controlled operations that are suited for implementation in computing systems rather than being limited to abstract advice or generalized policy interpretation Referring to FIG. 2, there is illustrated an informational interface section 104 of the insurance policy-and-claim document normalization and event-driven claims readiness automation system. The interface section 104 can be presented as a scrollable region of a landing page or as a guided onboarding panel and can be configured to communicate coverage risk categories and homeowner exposure areas that the system is configured to detect and quantify. In the illustrated example, the interface section 104 can present representative risk themes that commonly correspond to machine-detectable coverage gaps in homeowners' policies, including coverage insufficiency for rebuild costs, water-related exclusions or limitations, temporary housing costs during repairs, and required building code updates.

In an exemplary embodiment, the interface section 104 can operate as a structured intake and guidance layer that pre-configures the downstream analysis workflow. For example, when the user interacts with the interface section 104, the system can capture a selection or preference signal corresponding to one or more exposure categories, and the preference signal can be stored in association with a user session. The preference signal can then be used by a processing core to tune subsequent clause segmentation, normalization, and gap detection operations by adjusting a priority ordering or selection of gap detection patterns, weightings for severity scaling, and presentation ordering for the resulting gap signals. In this manner, the interface section 104 can be technically integrated with the analysis pipeline by controlling how machine-usable intermediate representations are evaluated and how outputs are ranked and surfaced, rather than merely presenting static educational content.

In an exemplary embodiment, the interface section 104 can also initiate a time-bounded scan workflow in which the system receives one or more policy document files, performs text extraction, and segments extracted policy text into clause units suitable for canonicalization. The system can normalize heterogeneous insurer language into a canonical coverage data structure and generate an evidence index that maps each canonical entry to a corresponding source span within the segmented clause data. The evidence index can allow the system to present evidence-anchored explainability later, including highlighting the specific policy clause that triggered a gap signal. The system can then generate a coverage-gap vector comprising gap signals that each include a gap type, a computed severity value, a computed confidence value, and an evidence reference. In some embodiments, the system can compute an exposure estimate by combining policy-derived limits and conditions with homeowner context, including property attributes obtained from user input or staged enrichment, such as property configuration and valuation data, and hazard classifications such as flood zone indicators. The computed exposure estimate can then be used to produce a quantified exposure range and to generate a prioritized action recommendation section in a report interface.

Advantageously, the interface section 104 can establish a practical application context that directly maps to structured computations performed by the system, including conversion of unstructured policy text into canonical coverage entries, generation of evidence-linked gap signals, and computation of exposure estimates and action sequences. This technical coupling can improve reproducibility and reduce user error relative to prior approaches that rely on generic checklists, static summaries, or manual interpretation. The resulting system behavior is grounded in specific computer operations, including text segmentation, normalization into standardized data structures, evidence-index mapping, and computed scoring and ranking, which together provide concrete machine outputs suitable for automated policy review and claim readiness workflows rather than abstract policy advice.

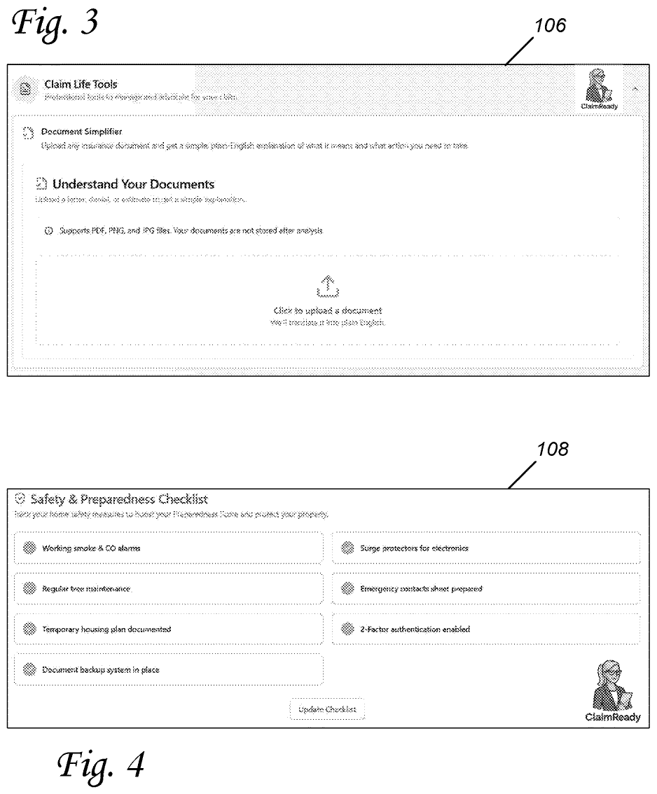

Referring to FIG. 3, there is illustrated a document simplification interface 106 of the insurance policy-and-claim document normalization and event-driven claims readiness automation system. The document simplification interface 106 can be presented within a claim-management context and can be configured to receive one or more uploaded insurance-related documents, such as policy forms, endorsements, denial letters, reservation-of-rights letters, estimates, scope sheets, requests for information, and other claim correspondence. In the illustrated example, the document simplification interface 106 can include an upload region that supports common document formats and can display a notice indicating that uploaded documents are not retained after analysis or are retained in accordance with a specified retention policy.

In an exemplary embodiment, the document simplification interface 106 can act as a front-end component of a document ingestion interface that initiates a controlled analysis pipeline. Upon receipt of an uploaded document file, the system can generate a document identifier and optionally compute a document hash, and can associate the document identifier with a user session and a claim record. The system can then perform text extraction to produce document text data. Where the document is image-based or scanned, the system can apply optical character recognition, page decomposition, and layout reconstruction to recover textual content and structural features such as headings, tables, clause blocks, and form fields. The system can segment the document text data into clause units or section units, and can store the segmented clause data in association with source spans that identify where each clause occurs within the original document, such as by page index, line offsets, bounding-box coordinates, or combinations thereof.

In an exemplary embodiment, the system can classify the uploaded document into a document event type, such as a denial event type, an information request event type, a reservation-of-rights event type, or an estimate event type. The classification can be performed using one or more of keyword-based pattern matching, a trained classifier model, or a hybrid approach. The resulting document event type can be stored in a document event stream that is used by downstream workflow automation components. For example, a denial event type can trigger creation or reprioritization of tasks associated with coverage review, dispute package preparation, or deadline tracking, while an information request event type can trigger tasks associated with collecting and submitting requested documentation.

In an exemplary embodiment, the document simplification interface 106 can present a plain-language explanation of the uploaded document that is generated from machine-usable intermediate representations rather than from a generic template. For instance, the system can identify structured “action items” within the document by extracting required artifacts, response deadlines, referenced policy provisions, and requested data fields, and can map those extracted items into a task graph and deadline timer subsystem. The system can also generate evidence-anchored summaries by coupling a simplified statement to an evidence reference that points back to the underlying source span in the segmented clause data. In this way, the system can enable explainable simplification in which each summarized outcome remains traceable to the original document content.

Advantageously, the document simplification interface 106 can reduce the cognitive and time burden on homeowners by converting heterogeneous insurer communications into structured, computable representations that drive automated workflow sequencing and deadline control. Prior approaches often provide static guidance or require manual reading, whereas the present system can perform technical operations, including text extraction, segmentation into source-referenced clause units, document event classification, and generation of structured action outputs. These operations produce concrete machine outputs, including document event types, task nodes, deadline timers, and evidence-referenced summaries, which are suitable for automated claim readiness and documentation management and are not limited to abstract advice or generalized interpretation.

Referring to FIG. 4, there is illustrated a safety and preparedness checklist interface 108 of the insurance policy-and-claim document normalization and event-driven claims readiness automation system. The checklist interface 108 can be presented as part of a preparedness workflow and can be configured to receive user inputs corresponding to property protection measures and readiness actions. In the illustrated example, the checklist interface 108 can present multiple selectable checklist items, such as working smoke and carbon monoxide alarms, surge protectors for electronics, regular tree maintenance, an emergency contacts sheet, a temporary housing plan, two-factor authentication, and a document backup system. The checklist interface 108 can also include a submission control configured to store checklist state updates.

In an exemplary embodiment, each checklist item displayed in the checklist interface 108 can correspond to a structured preparedness attribute stored in a preparedness data structure associated with a user profile and, where applicable, with a specific insured property record. Selection of a checklist item can cause the system to generate or update a checklist record that includes an item identifier, a completion state value, and a timestamp. In some embodiments, the system can also store supporting metadata, such as a user-provided note, a document attachment identifier, or a verification signal indicating that a supporting document was uploaded through a document ingestion interface. The structured preparedness data structure can then be used as machine-usable input to one or more computation modules that generate preparedness outputs, including a preparedness score and prioritized recommendations.

In an exemplary embodiment, the checklist interface 108 can be technically linked to the canonical coverage data structure produced from policy document ingestion. For example, the system can compute a preparedness score using both coverage-derived fields and readiness-derived fields. Coverage-derived fields can include policy limits, sublimits, exclusions, and conditions extracted from a homeowner's policy and normalized into canonical entries with evidence references. Readiness-derived fields can include completion states for checklist items. The system can combine these inputs to compute a score that reflects both the adequacy of coverage and the readiness of documentation and risk mitigation measures. In some implementations, the system can weight particular checklist items based on policy-derived risk factors, such as applying higher weighting to a document backup measure when a policy includes strict proof-of-loss timing requirements, or applying higher weighting to surge protection where electronics sublimits and valuation requirements can increase claim friction.

In an exemplary embodiment, the checklist interface 108 can also interact with staged enrichment and hazard classification outputs. For instance, when staged enrichment determines that a property is located in a higher flood risk zone, the system can dynamically adjust checklist ordering, add or highlight checklist items related to water damage preparedness, or generate a recommendation to verify flood coverage availability. Likewise, when enrichment identifies property configuration attributes, such as an older construction year, certain checklist items can be prioritized to reduce code upgrade exposure or to encourage documentation of renovations, which can assist with replacement cost valuation. In this manner, the checklist interface 108 can be part of an event-driven system in which computed risk signals and structured user actions influence one another.

Advantageously, the checklist interface 108 enables transformation of subjective readiness activities into structured, time-stamped machine data that can be combined with evidence-anchored policy representations and external enrichment outputs to drive reproducible scoring, prioritization, and workflow automation. Prior approaches typically provide static checklists that are not integrated with policy-specific coverage conditions or hazard context. The present system can provide a practical application by generating specific computed outputs, including readiness scores, prioritized checklists, and downstream task or deadline triggers, based on structured data capture and computation rather than generalized advice.

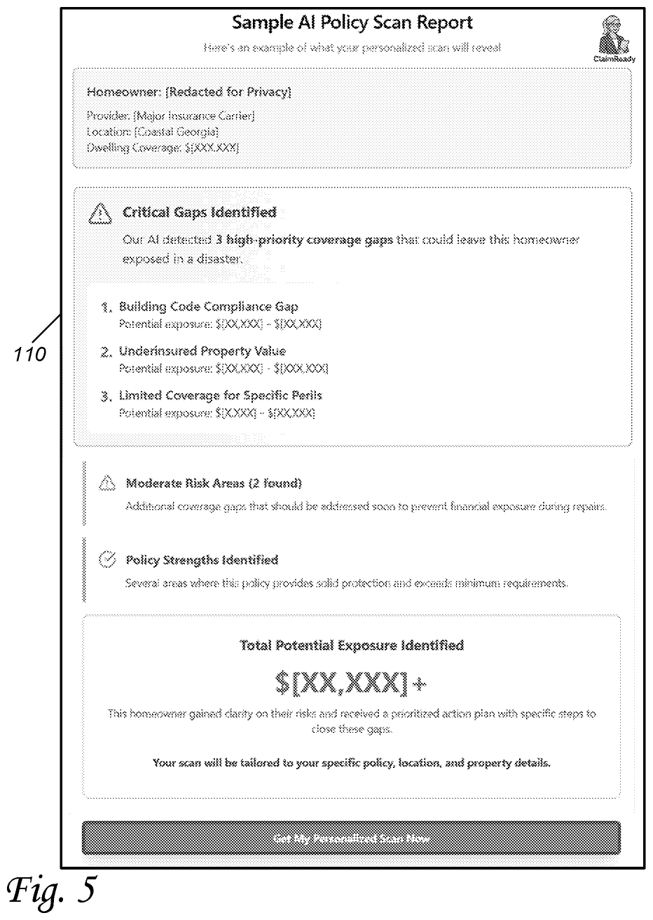

Referring to FIG. 5, there is illustrated a generated AI policy scan report interface 110 of the insurance policy-and-claim document normalization and event-driven claims readiness automation system. The report interface 110 can present structured output derived from automated analysis of a homeowner's policy, including identified critical coverage gaps, moderate risk areas, policy strengths, computed potential exposure values, dynamically generated recommendations, and other information. In the illustrated example, the report interface 110 can display an overall exposure indication and can provide one or more user-selectable controls that enable a user to initiate remediation steps, store the report, or generate a shareable output.

In an exemplary embodiment, the report interface 110 can be rendered from a machine-readable export record generated by a processing core. The processing core can ingest one or more policy document files, extract text, segment policy text into clause units, and generate a canonical coverage data structure. Each entry in the canonical coverage data structure can include standardized fields such as a coverage type field, limit field, sublimit field, exclusion field, and condition field. The processing core can generate an evidence index that maps canonical entries to corresponding source spans within segmented clause data. The processing core can then generate a coverage-gap vector comprising a plurality of gap signals, each gap signal including a gap type, severity, confidence, and evidence reference. The report interface 110 can be populated using the coverage-gap vector and associated evidence references so that a displayed coverage gap can remain traceable to a specific clause within the policy.

In an exemplary embodiment, the report interface 110 can include an exposure computation section in which computed potential exposure values are generated using staged enrichment and modeling. When the policy document omits coverage-relevant home details, the system can detect missing fields and initiate a first AI enrichment operation to retrieve property attributes such as home size, configuration, construction attributes, and valuation inputs. The retrieved property attributes can be inserted into an enriched coverage data structure. The system can then initiate a second AI enrichment operation that uses one or more values from the property attributes to retrieve hazard classification data, such as FEMA flood zone information, and insert that hazard data into the enriched coverage data structure. The system can then apply one or more statistical or formula-based computations, including replacement cost estimation, hazard modifier scaling, and modeled coverage shortfall estimation, to compute adjusted exposure values. In this way, the report interface 110 can present quantified exposure outputs that are derived from a reproducible computational pipeline rather than from subjective interpretation.

In an exemplary embodiment, the report interface 110 can present coverage gaps in a ranked order determined by computed severity and confidence values, and can optionally incorporate a risk percentile ranking derived by comparing a computed exposure value against a reference distribution dataset. The report interface 110 can further include evidence-anchored explainability by enabling a user to select a coverage gap and view the corresponding source span, such as a highlighted clause excerpt linked by an evidence reference. This linkage can help users understand precisely which policy language triggered the detected gap and can reduce misunderstandings that could arise from generic summaries.

Advantageously, the report interface 110 can provide a practical application that produces concrete outputs, including a canonical coverage representation, evidence-indexed gap signals, and computed exposure values derived from staged enrichment and formula-based modeling. Prior approaches often present static policy summaries or generic recommendations without reproducible computation or traceable evidence mapping. The present system can improve computer processing of heterogeneous policy documents by generating standardized intermediate data structures, computing confidence metrics and exposure values, and rendering a machine-generated report that supports downstream automation and remediation workflows rather than merely providing abstract advice.

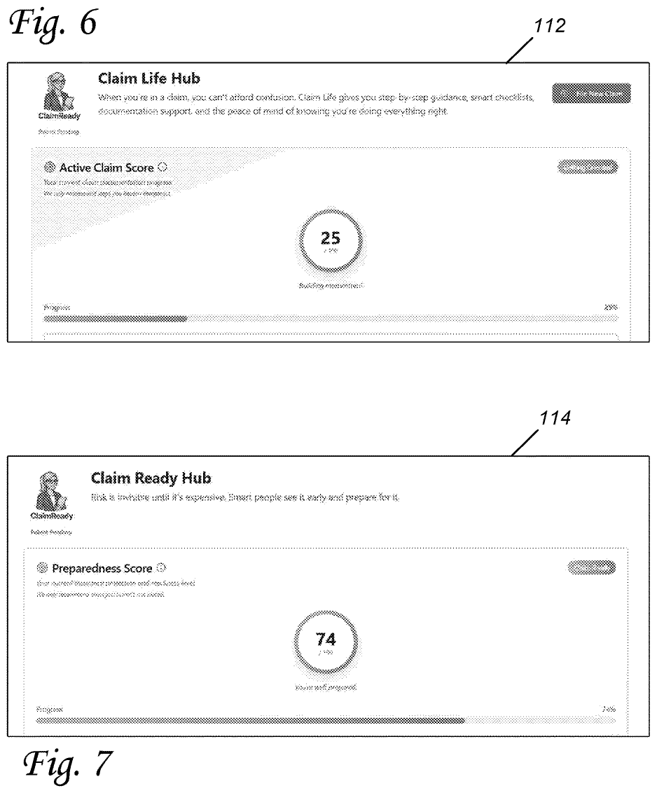

Referring to FIG. 6, there is illustrated a claim lifecycle dashboard interface 112 of the insurance policy-and-claim document normalization and event-driven claims readiness automation system. The claim lifecycle dashboard interface 112 can be configured to present an active claim score and claim status indicators derived from structured workflow data maintained by the system during a claim process. In the illustrated example, the claim lifecycle dashboard interface 112 can include a progress indicator and a mode activation control that transitions the user interface from a preparedness context into a claim-management context.

In an exemplary embodiment, the claim lifecycle dashboard interface 112 can be generated from a task graph data structure maintained by a processing core. The processing core can receive a plurality of claim-related document files associated with a claim record and can classify each claim-related document file into a corresponding document event type, such as a denial event type, an information request event type, a reservation-of-rights event type, or an estimate event type. The resulting document event types can be stored as a document event stream. The processing core can then generate and maintain the task graph data structure based on the document event stream and coverage-derived conditions. The task graph data structure can include a plurality of task nodes and dependency edges, and each task node can include a task identifier field, a required artifact field, a deadline field, and a completion state field. A deadline timer subsystem can maintain deadline timers associated with task nodes and compute time-to-deadline values for evaluation against thresholds.

In an exemplary embodiment, the active claim score presented in the claim lifecycle dashboard interface 112 can be computed from the task graph data structure by applying a scoring function to completion state values across a set of claim tasks. The scoring function can weight tasks differently based on time-to-deadline values, event type priorities, and task dependencies, such that completion of higher priority tasks contributes more to the score than completion of lower priority tasks. The score can be recomputed when the task graph is updated, such as when the document event stream changes due to ingestion of a new claim document or when an artifact is detected that satisfies a required artifact field. For example, uploading photos, an estimate, or a proof-of-loss document can automatically transition corresponding tasks to a completed state, update dependent tasks, and update the active claim score displayed in the claim lifecycle dashboard interface 112.

In an exemplary embodiment, the claim lifecycle dashboard interface 112 can also be driven by enriched coverage data obtained through staged enrichment. For instance, if the system detects missing property attributes or hazard classification data relevant to claim prioritization, the system can initiate a first AI enrichment operation to retrieve property attribute data, and a second AI enrichment operation to retrieve FEMA flood zone data based on those property attributes. The hazard classification data can be used to scale task priorities or to adjust threshold evaluations within the deadline timer subsystem. As one example, when flood risk is elevated, and flood exclusions or limitations are detected, the system can automatically prioritize tasks associated with documenting water intrusion source, preserving mitigation receipts, or verifying coverage applicability, and can surface those tasks more prominently in the claim lifecycle dashboard interface 112.

Advantageously, the claim lifecycle dashboard interface 112 can provide a practical application that translates heterogeneous claim documents and policy conditions into a structured, machine-driven workflow with computed scores, controlled task sequencing, and deadline management. Prior approaches often rely on manual tracking and informal checklists that do not update dynamically with incoming documents or computed policy conditions. The present system can improve computer processing by generating and updating task graphs and deadline timers based on a document event stream and enriched coverage representations, producing concrete workflow outputs suitable for automated claim readiness management rather than abstract guidance.

Referring to FIG. 7, there is illustrated a preparedness dashboard interface 114 of the insurance policy-and-claim document normalization and event-driven claims readiness automation system. The preparedness dashboard interface 114 can be configured to present a preparedness score and readiness indicators generated from structured preparedness data and policy-derived coverage data, and can visually represent progress toward improved coverage adequacy and documentation completeness. In the illustrated example, the preparedness dashboard interface 114 can include a computed readiness percentage and a progress visualization that reflects completion of recommended actions.

In an exemplary embodiment, the preparedness score displayed in the preparedness dashboard interface 114 can be computed using a scoring engine that operates on a machine-usable set of intermediate representations generated by the system. The scoring engine can receive, as inputs, structured preparedness attributes captured through a checklist interface and canonical policy attributes produced through document ingestion and canonicalization. Canonical policy attributes can be derived by extracting policy text, segmenting the policy into clause units, normalizing insurer-specific terminology into standardized coverage tokens, and generating a canonical coverage data structure comprising coverage entries with standardized fields, including limits, sublimits, exclusions, and conditions. The system can generate an evidence index mapping canonical entries to source spans within the policy text, enabling evidence-anchored validation and user-facing explainability for elements that affect the preparedness score.

In an exemplary embodiment, the preparedness score can incorporate severity-weighted gap signals generated in a coverage-gap vector. Each gap signal can include a gap type, severity, confidence, and evidence reference. The scoring engine can convert gap signals into score contributions by applying weighting functions that penalize high-severity, high-confidence gaps more strongly than low-severity or low-confidence gaps. In addition, the scoring engine can incorporate completion state values from preparedness tasks, such as whether key documents have been backed up, whether emergency contacts have been stored, or whether protective measures have been documented. The score can be recomputed as new documents are ingested, as user checklist items are completed, or as enriched coverage data updates are obtained.

In an exemplary embodiment, the preparedness dashboard interface 114 can also reflect staged enrichment outcomes when policy documents omit coverage-relevant home details. The system can detect missing fields and initiate a first AI enrichment operation to retrieve property attributes such as home size, configuration, construction details, and valuation-related data. Based on at least one retrieved property attribute, the system can initiate a second AI enrichment operation to retrieve hazard classification data such as FEMA flood zone information. The retrieved data can populate an enriched coverage data structure used to compute adjusted exposure values and to scale risk weights within the preparedness score. For example, a water-related exclusion gap can be weighted more heavily when the hazard classification indicates elevated flood risk, and a dwelling limit adequacy assessment can be adjusted using replacement cost estimates derived from property attributes and construction cost indices.

In an exemplary embodiment, an insurance policy-and-claim document normalization and event-driven claims readiness automation system can include a document ingestion interface, one or more processors, and a non-transitory memory storing instructions for executing a document-to-data transformation pipeline that produces standardized intermediate representations and evidence-anchored outputs. The document ingestion interface can be configured to receive a policy document file and a claim-related document file associated with the policy document file. The policy document file can include a homeowner's declarations page, forms, endorsements, and other attachments, and the claim-related document file can include correspondence such as a denial letter, reservation-of-rights letter, estimate, or request for information. Upon ingestion, the system can associate each file with a session identifier and can generate persistent document identifiers, optionally computing content fingerprints such as hashes, so that subsequent computations can be reproduced for the same document content.

In an exemplary embodiment, the system can perform text extraction on the policy document file to generate policy text data. Text extraction can include parsing machine-readable text layers when available and applying optical character recognition and layout reconstruction when the policy document file is scanned or image-based. The system can preserve location metadata in association with extracted text such that later operations can identify source spans for specific policy phrases. The policy text data can be normalized into a consistent internal encoding to support deterministic downstream processing. This extraction stage can be executed by the one or more processors as a computer-implemented transformation that converts heterogeneous file formats into a uniform representation suitable for algorithmic processing.

In an exemplary embodiment, the system can segment the policy text data into a plurality of policy clauses to generate segmented clause data. Clause segmentation can be performed using a combination of structural and semantic techniques. Structural techniques can include detecting headings, numbering patterns, page section boundaries, and known policy form structures. Semantic techniques can include classifying text spans into functional categories such as grants of coverage, definitions, exclusions, special limits, and conditions. Each segmented clause can be stored with a clause identifier and a source span descriptor, such as a page index and offset range, enabling precise location and later evidence anchoring. By segmenting the policy into discrete clause units, the system can create addressable, machine-usable data blocks that improve repeatability and consistency relative to approaches that rely on narrative summarization.

In an exemplary embodiment, the system can generate, from the segmented clause data, a canonical coverage data structure comprising a standardized set of coverage fields. The canonical coverage data structure can include coverage entry objects representing coverage concepts extracted from the policy and normalized into fixed fields, including at least a coverage type field, a limit field, a sublimit field, an exclusion field, and a condition field. The coverage type field can store a standardized token corresponding to a coverage category, such as dwelling, personal property, or loss of use, enabling consistent evaluation across carriers even when the policy uses different terminology. The limit field can store normalized numeric values and units. The sublimit field can store category-specific limits such as jewelry, electronics, or water backup. The exclusion field can store normalized exclusion descriptors or standardized exclusion tokens. The condition field can store normalized condition descriptors, including time-based requirements and other duties after loss. The canonical coverage data structure can be stored as a machine-usable intermediate representation that is separable from user interface outputs and is suitable for deterministic evaluation by downstream computational modules.

In an exemplary embodiment, the system can generate an evidence index that maps each of a plurality of entries in the canonical coverage data structure to a corresponding source span in the segmented clause data. The evidence index can store evidence references that associate coverage entry identifiers with one or more clause identifiers and source span descriptors. In some implementations, evidence references can be generated for individual standardized field values as well as for entire coverage entries. This mapping can enable a reproducible and auditable link between computed outputs and supporting policy text, allowing later interfaces to display the exact policy language supporting an extracted limit, exclusion, or condition. The evidence index can be implemented as a machine-readable linkage layer that can be queried by identifier, thereby enabling deterministic evidence retrieval rather than manual searching.

In an exemplary embodiment, the system can detect, based on the canonical coverage data structure, a missing coverage-relevant field. Missing-field detection can be performed by executing completeness rules and validation logic over standardized fields. A missing field can include at least one of a property value field, a property attribute field, or a property configuration field. For example, a homeowner's policy may not explicitly state square footage, construction type, or replacement-cost drivers, even though such values can materially affect severity scaling and exposure modeling. Missing-field detection can include checking for null or default values, invalid formats, out-of-range values, or logical inconsistencies across fields. By performing missing-field detection over a structured canonical representation, the system can programmatically determine whether downstream computations can be executed reliably and can initiate controlled enrichment operations when required.

In an exemplary embodiment, responsive to detecting the missing coverage-relevant field, the system can initiate a first artificial intelligence web enrichment operation using an AI web retrieval agent to retrieve first supplemental property data from one or more external data sources. The first supplemental property data can include at least one of a home size value, a home configuration value, a home construction attribute value, or a home valuation value. The AI web retrieval agent can be configured to execute a retrieval plan that includes selecting one or more sources, generating a query, retrieving candidate results, extracting relevant values, and transforming the values into standardized internal representations. External sources can include property records repositories, assessor or parcel databases, listing-derived public records, and construction cost index repositories. The system can store provenance metadata for retrieved property values, such as source identifiers, retrieval timestamps, and an authority score. The retrieval operation can be structured to reduce variability by using controlled query templates and standardized parsing rules, thereby producing machine-usable values suitable for subsequent computations.

In an exemplary embodiment, the system can generate an enriched coverage data structure by inserting the first supplemental property data into the canonical coverage data structure to populate the missing coverage-relevant field. The enriched coverage data structure can preserve the policy-derived standardized coverage fields and add or populate property attribute fields used for modeling and prioritization. In some implementations, the enriched coverage data structure can be stored as a separate object from the canonical coverage data structure to preserve a baseline policy-only representation for audit, while enabling computations to operate on enriched values when present. The system can also reconcile conflicting values by applying a precedence rule set, such as preferring authoritative sources, preferring more recent retrievals, or prompting user confirmation through an interface.

In an exemplary embodiment, after generating the enriched coverage data structure, the system can detect a missing hazard classification field and can initiate a second AI web enrichment operation using the AI web retrieval agent to retrieve second supplemental hazard data. The second supplemental hazard data can be retrieved from one or more external data sources based on at least one of the home size value, the home configuration value, the home construction attribute value, or the home valuation value produced by the first enrichment operation. In this staged arrangement, the outputs of the first enrichment operation can provide inputs required to retrieve hazard classification data with higher precision, such as using a normalized address, parcel identifier, or configuration attributes to select the appropriate hazard dataset and query parameters. In an exemplary embodiment, the second supplemental hazard data can comprise FEMA flood zone data, such as a flood zone designation and related metadata. The system can insert the second supplemental hazard data into the enriched coverage data structure to populate the missing hazard classification field and can store provenance metadata indicating the retrieval source and retrieval timing.

In an exemplary embodiment, the system can generate, based on the enriched coverage data structure, a coverage-gap vector data structure comprising a plurality of gap signals. Each gap signal can include a gap type field, a severity field, a confidence field, and an evidence reference that references the evidence index. Gap types can include hazard exclusions, underinsured limits, restrictive sublimits, coverage endorsements or policy riders not present in the policy document file, duration limitations, and deadline-based risks. Severity can be computed as a quantified magnitude, such as a modeled shortfall between a computed requirement and a policy limit, or as a scaled risk indicator derived from hazard modifiers. Confidence can be computed as a reproducible metric derived from multiple factors, including a clause match score computed from segmented clause data and a coverage-field completeness score computed from the enriched coverage data structure. The clause match score can represent the degree of alignment between a detected clause and a detection pattern or normalized rule, while the completeness score can represent whether required standardized fields and enrichment fields are present and validated. The evidence reference can provide a resolvable pointer to the supporting clause source span, enabling explainable outputs tied to policy evidence.

In an exemplary embodiment, at least one gap signal can be generated responsive to detecting, in the canonical coverage data structure, an exclusion field that matches an exclusion pattern stored in non-transitory memory. Exclusion patterns can be stored in a pattern library or rule set and can be expressed as standardized token patterns, phrase templates, or other machine-readable representations applied to normalized fields and evidence-linked clause spans. For example, an exclusion pattern can detect flood or surface water exclusions and can generate a hazard exclusion gap signal. When hazard enrichment indicates elevated flood risk, the system can scale severity or modeled exposure accordingly while preserving evidence anchoring to the policy clause that established the exclusion. This combination of deterministic pattern detection with context-aware severity computation can reduce false positives and provide actionable outputs grounded in both policy text and property context.

In an exemplary embodiment, the condition field of the canonical coverage data structure can include a deadline parameter extracted from the policy document file. Deadline parameters can be identified during clause segmentation and canonicalization by detecting temporal phrases and normalizing them into a canonical time representation. The system can compute a time-to-deadline value by comparing the deadline parameter to a current time value and can generate a gap signal indicating a deadline-based risk condition responsive to the time-to-deadline value satisfying a threshold. The system can surface such deadline-based risk conditions in reports and can also use them to drive workflow automation, such as generating tasks, deadline timers, and notifications. This provides a technical mechanism for integrating policy conditions into computer-controlled timing logic rather than relying on users to manually interpret and track time requirements.

In an exemplary embodiment, generating the canonical coverage data structure can include normalizing an endorsement identifier, an exclusion descriptor, or a limit qualifier into a standardized vocabulary stored in a normalization table. The normalization table can map carrier-specific terms, form identifiers, and phrasing variations into standardized tokens used by the canonical schema. For instance, “Loss of Use,” “Additional Living Expense,” and “Coverage D” can be mapped into a single standardized coverage type token, while different expressions of sublimit clauses can be mapped into standardized sublimit category tokens. This normalization provides a technical improvement by constraining interpretation into deterministic mappings that can be applied consistently across heterogeneous documents, enabling reproducible evaluation and reducing ambiguity inherent in free-form text.

In an exemplary embodiment, the system can output, via a user interface, a gap signal from the plurality of gap signals and a corresponding source span identified by the evidence reference. The user interface can render the gap type, severity, and confidence and can display a highlighted excerpt of the policy clause corresponding to the source span, thereby providing evidence-anchored explainability. The user interface can also allow a user to confirm enrichment-derived values, override values, or provide missing values manually, and the system can update the enriched coverage data structure and recompute affected severity, confidence, and exposure outputs in response. The user interface can thus operate as part of a closed-loop computation pipeline in which user inputs and enrichment outputs update machine-usable intermediate representations and drive recalculation, rather than presenting static advice.

In an exemplary embodiment, the described architecture provides a technical improvement in computer processing of heterogeneous insurance policy documents by automatically augmenting a machine-usable standardized coverage representation with externally retrieved property data and staged hazard data to enable reproducible generation of evidence-anchored gap signals even when the policy document files omit coverage-relevant fields. Prior approaches often require manual gathering of home attributes and hazard classifications and manual interpretation of policy clauses, producing results that vary by reviewer and that lack a deterministic evidence path. In contrast, the described system executes a sequence of computer-implemented transformations including text extraction, clause segmentation, canonicalization into fixed fields, evidence indexing, missing-field detection, staged AI enrichment to populate property and hazard fields, deterministic scoring of confidence and severity, and structured output generation in a coverage-gap vector. These operations produce concrete, machine-usable outputs including canonical and enriched coverage data structures, evidence references to policy source spans, and a coverage-gap vector of gap signals with computed severity and confidence, thereby providing practical application grounded in data transformation and automated control logic rather than abstract policy interpretation.

In an exemplary embodiment, a method of using the system can include receiving, via the document ingestion interface, the policy document file and the claim-related document file, extracting policy text data, segmenting the policy text data into segmented clause data, generating the canonical coverage data structure, generating the evidence index mapping canonical entries to source spans, detecting missing coverage-relevant fields, retrieving first supplemental property data using an AI web retrieval agent, generating the enriched coverage data structure by inserting the first supplemental property data, and generating the coverage-gap vector data structure based on the enriched coverage data structure. In some implementations, the method can further include retrieving FEMA flood zone data as a staged hazard enrichment using one or more values from the first supplemental property data, and inserting that hazard data into the enriched coverage data structure before computing severity scaling, exposure modeling, and prioritization. The method can thereby produce repeatable and explainable machine outputs suitable for homeowners' preparedness assessment and claim readiness workflows using structured intermediate representations, evidence anchoring, and deterministic computation.

Advantageously, the preparedness dashboard interface 114 can provide a practical application that converts unstructured policy documents and subjective readiness actions into reproducible computed outputs, including standardized coverage representations, evidence-linked gap signals, and a preparedness score that is dynamically updated using structured data and staged enrichment. Prior approaches often rely on static checklists or generalized guidance that is not integrated with the user's specific policy language, coverage conditions, and hazard context. The present system can improve computer processing of heterogeneous policy documents by generating canonical and enriched coverage data structures, computing confidence and exposure metrics, and rendering a dynamically updated preparedness dashboard that supports automated decisioning and downstream workflows rather than abstract recommendations.

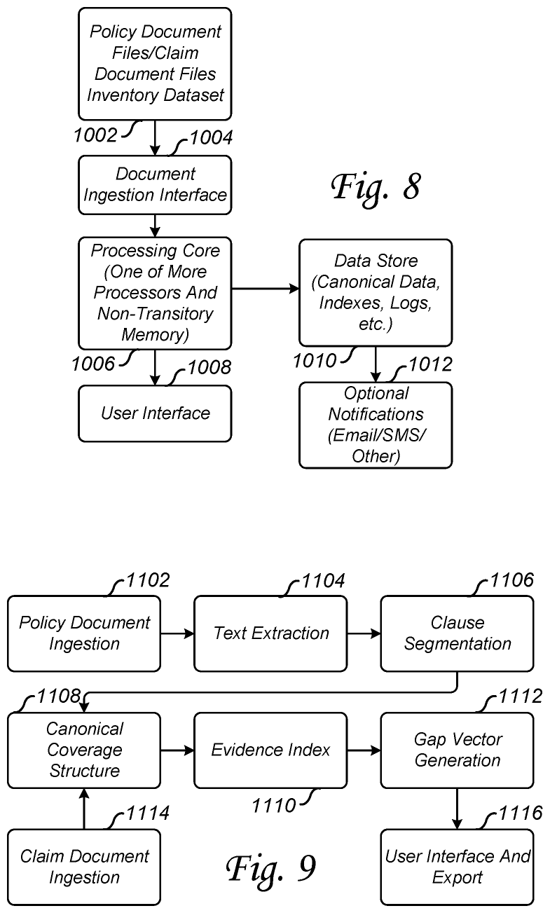

Referring to FIG. 8, there is illustrated a system-level architecture and workflow in which homeowners' insurance policy document files, claim document files, and an inventory dataset can be ingested through a document ingestion interface, processed by a processing core, and stored in a data store to generate evidence-anchored, machine-usable outputs that can be presented via a user interface and optionally used to trigger notifications. The illustrated steps 1002-1012 can represent an overall end-to-end processing path that supports later canonicalization, evidence indexing, gap vector generation, enrichment, scoring, and workflow automation.

In step 1002, the system can receive one or more input datasets comprising policy document files, claim document files, and/or an inventory dataset. In an exemplary embodiment, the policy document files can include declarations pages, forms, and endorsements, the claim document files can include denial letters, reservation-of-rights letters, estimates, and requests for information, and the inventory dataset can include structured item entries or source documents used to create such entries. The inputs can be associated with a user session and, where applicable, a claim record, so the system can later maintain traceability between computed outputs and the originating files.

In step 1004, the system can route the received policy document files, claim document files, and/or inventory dataset to a document ingestion interface. In an exemplary embodiment, the document ingestion interface can manage upload handling, file-type detection, metadata capture, and secure transfer of file content to the processing core, while generating or assigning identifiers that can be used to reference the ingested inputs during subsequent processing. This structured ingestion step can improve reliability relative to prior approaches that rely on ad hoc email forwarding or manual copy/paste workflows because the system can preserve consistent identifiers and metadata for downstream automation.

In step 1006, the system can process the ingested inputs using a processing core comprising one or more processors and non-transitory memory. In an exemplary embodiment, the processing core can execute computer-implemented operations that include text extraction, clause segmentation, canonical coverage data structure generation, evidence index generation, staged enrichment, and coverage-gap vector generation with computed severity and confidence fields. The processing core can thereby transform heterogeneous, unstructured policy language and claim correspondence into standardized, machine-usable intermediate representations that are suitable for deterministic computation and repeatable evaluation across different carriers and document formats, which supports practical application and reinforces that the disclosed functionality is rooted in specific computer processing improvements rather than abstract advice.

In step 1008, the system can provide one or more outputs to a user interface. In an exemplary embodiment, the user interface can present computed results, including evidence-anchored gap signals, exposure outputs, readiness scores, and workflow states, and can further enable user actions such as uploading additional documents, confirming or correcting enriched values, and initiating remediation or claim-mode workflows. The user interface can also support evidence-anchored explainability by displaying, for a selected gap signal or recommendation, the underlying policy source span that supports the computed output, thereby reducing ambiguity and improving user trust relative to prior approaches that provide non-traceable summaries.

In step 1010, the system can store intermediate representations and computed outputs in a data store. In an exemplary embodiment, the data store can store canonical data, evidence indexes, logs, and other structures, including a canonical coverage data structure, an enriched coverage data structure populated by staged AI enrichment, a coverage-gap vector data structure, a document event stream, a task graph, deadline timers, and a provenance log. By storing these machine-usable structures, the system can support reproducibility, auditing, and downstream automation, such as re-ranking gaps when enrichment values change or re-generating a report without re-ingesting the original files.

In step 1012, the system can generate optional notifications, such as email, SMS, push notifications, or other notification formats. In an exemplary embodiment, notifications can be triggered by computed control signals generated by the processing core, such as detecting a high-severity, high-confidence gap signal, detecting a deadline condition extracted from a policy or claim correspondence, detecting that time-to-deadline satisfies a threshold, or detecting that a required artifact remains incomplete. This step can provide a practical application that goes beyond static reporting by enabling event-driven communication grounded in computed timing state and structured workflow data, thereby improving automated claim readiness and preparedness management relative to manual reminder approaches.

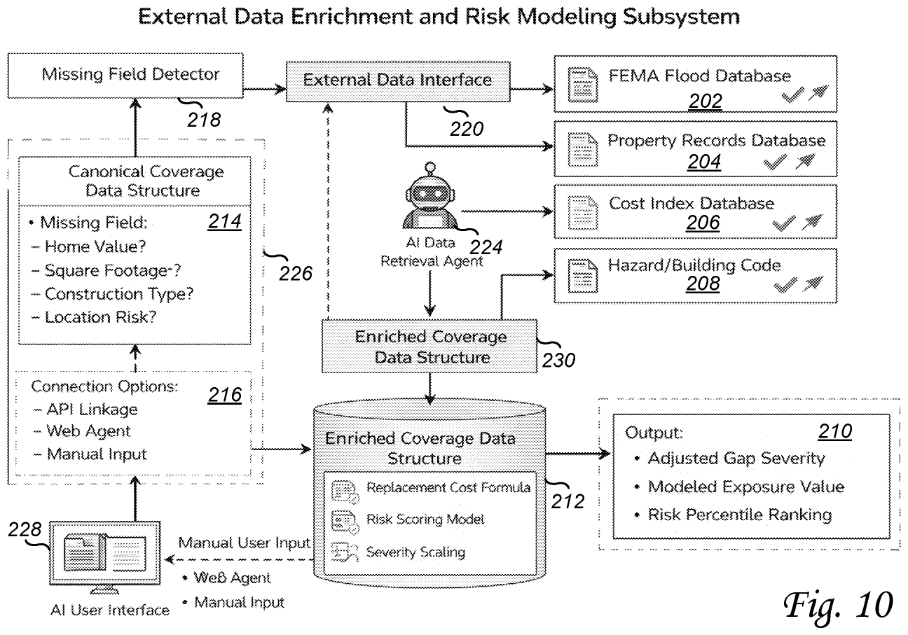

Referring to FIG. 9, there is illustrated a system-level workflow that can be executed by a document ingestion interface and a processing core to convert unstructured homeowners' policy forms, endorsements, declarations pages, and insurer correspondence into machine-usable intermediate representations and to generate evidence-anchored outputs suitable for automated risk scoring, gap detection, and downstream exports. In the illustrated embodiment, the workflow includes a series of processing steps 1102-1116 that can be performed under control of one or more processors and non-transitory memory, with intermediate results optionally stored in a data store and surfaced through a user interface and/or exported.

In step 1102 (Policy Document Ingestion), one or more policy document files can be received by the system. In an exemplary embodiment, the policy document files can include declarations pages, forms, endorsements, and other homeowners' policy attachments. The policy document ingestion can include associating the received policy document files with a user session and generating persistent identifiers and metadata (such as file type, timestamp, and optional document hash) to support reproducibility and auditability of later computations.

In step 1104 (Text Extraction), policy text data can be generated from the ingested policy document files. In an exemplary embodiment, text extraction can include parsing machine-readable PDF text when available and applying optical character recognition and layout reconstruction when the policy document files include scanned images. The resulting policy text data can be normalized into a consistent internal encoding and can preserve location information needed to identify source spans.

In step 1106 (Clause Segmentation), the extracted policy text data can be segmented into a plurality of policy clauses to generate segmented clause data. In an exemplary embodiment, the segmentation can be performed using structural cues such as headings, numbering patterns, and form identifiers, and can further include semantic segmentation to separate exclusions, special limits, and conditions. Each clause in the segmented clause data can be associated with a source span that identifies where the clause occurs in the policy document files, enabling later evidence anchoring.

In step 1108 (Canonical Coverage Structure), a canonical coverage data structure can be generated from the segmented clause data. In an exemplary embodiment, the canonical coverage data structure can include standardized coverage fields such as coverage type, limits, sublimits, exclusions, and conditions, and can normalize insurer-specific terminology into standardized tokens using a normalization table or mapping logic. This step can provide a technical improvement by transforming heterogeneous, unstructured policy text into a machine-usable representation suitable for deterministic computation and consistent evaluation across policy document formats.

In step 1114 (Claim Document Ingestion), one or more claim-related document files can be received and associated with a claim record. In an exemplary embodiment, the claim-related document files can include denial letters, reservation-of-rights letters, estimates, requests for information, and other claim correspondence. This step can populate a document event stream used by the system to create or update workflow tasks and deadlines, and can further enable claim-mode outputs to be generated using the same canonical coverage structure derived from the policy document files.

In step 1110 (Evidence Index), an evidence index can be generated that maps entries of the canonical coverage data structure to corresponding source spans in the segmented clause data. In an exemplary embodiment, the evidence index can store mappings between canonical coverage entries and clause identifiers, page indices, line offsets, or other location descriptors, thereby enabling evidence-anchored explainability. This mapping can improve computer operation by allowing downstream outputs to reference precise portions of the policy text rather than relying on generic summaries.

In step 1112 (Gap Vector Generation), a coverage-gap vector data structure can be generated based on the canonical coverage data structure and, where applicable, enriched data incorporated into an enriched coverage data structure. In an exemplary embodiment, gap vector generation can include generating a plurality of gap signals, each with a gap type, severity, confidence, and evidence reference pointing into the evidence index. The confidence can be computed using at least a clause alignment metric and a field completeness metric, and the severity can be scaled using enrichment outputs, such as property attributes and hazard classification data obtained via staged AI web retrieval. This step can provide a technical improvement by producing reproducible, machine-generated risk signals from structured intermediate representations and computed metrics rather than from subjective interpretation.

In step 1116 (User Interface and Export), outputs of the workflow can be presented and/or exported. In an exemplary embodiment, the system can render a report interface that displays the gap signals with evidence-anchored source spans, computed exposure values, and prioritized recommendations. The system can also generate a machine-readable export record that includes the canonical coverage data structure, the evidence index, and the coverage-gap vector data structure, enabling downstream automated processing such as workflow task generation, dispute package preparation, and audit logging. This step grounds the disclosed functionality in a practical application by producing concrete computer-generated outputs that can drive subsequent automated actions, rather than providing only abstract advice.

In an exemplary embodiment, an insurance policy-and-claim document normalization and event-driven claims readiness automation system can include a document ingestion interface, one or more processors, and a non-transitory memory storing instructions for executing a computer-controlled workflow that converts heterogeneous claim-related document files into a standardized document event stream and uses that event stream, together with policy-derived conditions, to generate and maintain an event-driven task graph and a deadline timer data structure. The system can be configured to support homeowners' claim readiness by automatically sequencing tasks, tracking time-sensitive obligations, and generating evidence-anchored and time-aware outputs that reduce missed deadlines and incomplete submissions.

In an exemplary embodiment, the document ingestion interface can be configured to receive a policy document file and a plurality of claim-related document files associated with a claim record. The policy document file can include declarations pages, forms, and endorsements, and the claim-related document files can include denial letters, reservation-of-rights letters, information requests, estimates, scope sheets, invoices, and other correspondence. The ingestion interface can associate the policy document file and each claim-related document file with the claim record, can generate document identifiers, and can store metadata such as timestamps and optional content fingerprints. This association enables the system to maintain a deterministic linkage between inputs and downstream task generation and prioritization outcomes.

In an exemplary embodiment, the system can generate, from the policy document file, a canonical coverage data structure comprising a standardized set of coverage fields including at least a condition field. The canonical coverage data structure can be created by text extraction, clause segmentation, and normalization operations. The condition field can store policy-derived conditions relevant to claim behavior, such as duties after loss, response obligations, proof-of-loss requirements, and other time-based or action-based conditions. The condition field can be normalized into machine-usable parameters, such as deadline parameters or rule triggers, enabling subsequent computations to operate on standardized values rather than on free-form policy text.

In an exemplary embodiment, the system can generate an evidence index that maps an entry in the canonical coverage data structure to a corresponding source span in extracted policy text. The evidence index can store evidence references that enable deterministic retrieval of the policy clause supporting a condition parameter or other normalized value. This mapping enables the system to provide evidence-anchored explainability for time-sensitive tasks, such as displaying the clause excerpt that establishes a proof-of-loss deadline, thereby reducing ambiguity and improving trust in automated task generation.

In an exemplary embodiment, the system can classify each claim-related document file of the plurality of claim-related document files into a corresponding document event type to generate a document event stream. Classification can be performed by a document classifier operating on extracted text and document structure. The document event stream can include a time-ordered list of event entries, each entry including a document identifier, an event type label, and a timestamp. Example event types can include a denial event type, an information request event type, a reservation-of-rights event type, and an estimate event type. By converting heterogeneous claim correspondence into standardized event entries, the system can provide a technical improvement over manual email tracking by creating a machine-usable input stream that can drive workflow generation and adaptation.

In an exemplary embodiment, the system can generate and maintain, based on the document event stream and the condition field, a task graph data structure comprising a plurality of task nodes and a plurality of dependency edges between task nodes. Each task node can correspond to a claim readiness action and can be created by applying event-to-task mapping logic that considers the event type and policy-derived condition parameters. Dependency edges can enforce sequencing constraints, such as requiring that a documentation-gathering task be completed before a submission task is marked complete. This task graph storage can be implemented as machine-readable node and edge records, enabling programmatic evaluation and updates as new claim documents arrive and as deadlines approach.

In an exemplary embodiment, each task node can include a task identifier field, a required artifact field, and a completion state field. The task identifier field can uniquely identify the task within the task graph. The required artifact field can specify a document or artifact required for completion, such as a proof-of-loss form, photographs, receipts, estimates, invoices, or correspondence responses. The completion state field can store whether the task is incomplete, complete, pending review, or otherwise in a defined state. The system can automatically set the completion state field based on detecting, within the plurality of claim-related document files, an artifact corresponding to the required artifact field. Artifact detection can be performed by evaluating ingested files and attachments for content signatures or classification labels indicating that the required artifact has been provided. This automatic completion update can provide a technical improvement by reducing manual state management and by allowing dependent tasks to be updated deterministically.

In an exemplary embodiment, the system can maintain a deadline timer data structure comprising a plurality of deadline timers, each deadline timer being associated with a corresponding task node of the plurality of task nodes. Each deadline timer record can store a deadline value, a current timing state, and a reference to the task identifier. At least one deadline timer can be generated based on a deadline parameter stored in the condition field of the canonical coverage data structure. For example, a proof-of-loss deadline derived from policy conditions can be normalized into a deadline parameter and then instantiated as a deadline timer associated with a proof-of-loss task node. Other deadlines can be derived from claim correspondence, such as an insurer's information request response deadline, and can be stored as timers for the corresponding tasks.

In an exemplary embodiment, the system can generate a notification signal responsive to determining, from the deadline timer data structure, that a deadline timer satisfies a time-to-deadline threshold. The notification signal can be generated as a machine-usable output that triggers one or more notification channels, such as an in-application alert, email, or push notification. The notification signal can include task identifiers, deadline values, and optionally evidence references to policy conditions or claim correspondence establishing the deadline. This configuration supports practical application by producing time-aware outputs that improve compliance and reduce missed deadlines through deterministic threshold evaluation rather than user guesswork.

In an exemplary embodiment, the system can update the task graph data structure by adding, removing, or re-ranking at least one task node responsive to detecting a change in the document event stream. A change in the document event stream can occur when a new claim-related document file is ingested, when an event type classification changes due to additional evidence, or when a corrected version of a document is received. Task addition can occur when an information request event is detected, creating new tasks to gather and submit requested artifacts. Task removal can occur when a task becomes inapplicable, such as when an insurer rescinds a request or when a task is superseded by a newer request. Re-ranking can occur when time-to-deadline values change, when high-priority event types are detected, or when hazard context indicates elevated urgency for certain documentation categories. This automatic update mechanism provides a technical improvement by maintaining task ordering and sequencing state as a function of machine-readable event inputs and computed timing state.

In an exemplary embodiment, the system can further detect a missing coverage-relevant field in a coverage record associated with the claim record and can initiate staged enrichment that updates workflow behavior. The system can initiate a first AI web enrichment operation using an AI web retrieval agent to retrieve first supplemental property data comprising at least one of a home size value, a home configuration value, a home construction attribute value, or a home valuation value. After retrieving the first supplemental property data, the system can initiate a second AI web enrichment operation using the AI web retrieval agent to retrieve second supplemental hazard data comprising FEMA flood zone data based on at least one value of the first supplemental property data. The system can then update at least one of the task graph data structure or the deadline timer data structure based on the second supplemental hazard data. For example, where FEMA flood zone data indicates elevated flood exposure and the policy includes a water-related exclusion or limitation, the system can elevate priority of tasks that substantiate the source of water intrusion, preserve mitigation receipts, and document damage conditions within required time windows, thereby adapting workflow sequencing based on objective hazard context rather than generic checklists.

In an exemplary embodiment, a method of using the system can include receiving the policy document file and the plurality of claim-related document files associated with the claim record; generating the canonical coverage data structure from the policy document file; generating the evidence index that maps an entry in the canonical coverage data structure to the corresponding source span in extracted policy text; classifying each claim-related document file into the corresponding document event type to generate the document event stream; generating the task graph data structure and the deadline timer data structure based on the document event stream and the condition field; and updating the task graph data structure responsive to detecting the change in the document event stream. In some embodiments, the method can further include generating notification signals when computed time-to-deadline values satisfy thresholds and updating task completion states automatically when required artifacts are detected in ingested claim documents.

In an exemplary embodiment, the described workflow provides a technical improvement in computer processing by converting heterogeneous claim correspondence into a standardized document event stream, converting policy-derived conditions into machine-usable condition parameters, and automatically controlling task sequencing and timer state through stored task graphs and deadline timer data structures. Prior approaches often rely on manual interpretation of letters and manual calendar entry, which is error-prone and difficult to keep synchronized as new documents arrive. In contrast, the described system produces concrete digital outputs including event stream entries, task node records, dependency edges, deadline timer records, completion state updates, and notification signals, all grounded in evidence-indexed policy clauses and structured classification outputs. These computer-executed transformations and control mechanisms provide practical application through automated claim readiness management and emphasize technical implementation and reproducible operation rather than abstract claim advice.

Referring to FIG. 10, there is illustrated an external data enrichment and risk modeling subsystem 200 that can be configured to augment a canonical coverage representation with property-specific and hazard-specific supplemental data and to generate computed outputs used for coverage-gap severity scaling, exposure modeling, and percentile ranking. The subsystem 200 can be particularly useful for homeowners' policies in which policy PDFs and endorsements often omit coverage-relevant values such as dwelling characteristics, replacement cost drivers, and hazard classifications, while the policy language nonetheless includes exclusions, sublimits, and conditions that become more or less consequential depending on the specific property context.

In an exemplary embodiment, the subsystem 200 can include a missing field detector 218 configured to evaluate a canonical coverage data structure 214 to determine whether one or more coverage-relevant fields are missing, incomplete, or inconsistent. The missing field detector 218 can be executed by one or more processors using validation rules stored in non-transitory memory and can determine that a field is “missing” when a standardized coverage field fails a completeness test, when a numeric value falls outside a permitted range, when a required attribute for a downstream computation is not present, or when a conflict exists between extracted values. In this way, missing field detection can be performed as a machine-executed validation step that operates on structured fields rather than as a subjective review of policy text.

In an exemplary embodiment, the canonical coverage data structure 214 can represent the output of earlier canonicalization steps and can include standardized coverage entry objects with standardized fields such as coverage type, limits, sublimits, exclusions, and conditions, while also reserving normalized field slots for property and hazard fields that may not be explicitly stated in the policy document. The canonical coverage data structure 214 is illustrated within a region 226, indicating that it can be an input to the enrichment workflow as well as a baseline data structure that can be preserved for auditability and explainability. In the illustrated example, the canonical coverage data structure 214 can explicitly identify missing fields, including a home value field, a square footage field, a construction type field, and a location risk field, while acknowledging that additional fields can also be evaluated depending on a configured modeling profile.

In an exemplary embodiment, the subsystem 200 can include connection options 216 that define one or more pathways by which missing fields can be populated. The connection options 216 can include an API linkage option, a web agent option, and a manual input option. The API linkage option can be configured to query structured external services or databases through one or more application programming interfaces. The web agent option can be implemented by an AI web retrieval agent that performs guided retrieval of authoritative data from web sources and transforms retrieved results into structured values. The manual input option can be implemented by receiving user-provided data through an interface, such as an AI user interface 228, and validating that user-provided data against format and plausibility rules. By including multiple connection options 216, the subsystem 200 can remain robust across differing availability of structured interfaces and can provide a controlled fallback path when external sources are unavailable or when the user prefers to supply known property details.

In an exemplary embodiment, the AI user interface 228 can be configured to accept manual user input and to coordinate staged enrichment operations. The AI user interface 228 can present field prompts for missing values, can display confidence or source indicators for retrieved values, and can allow a user to confirm, override, or supplement data values. The AI user interface 228 can also serve as the entry point for initiating enrichment when a user requests a policy scan or when an analysis session identifies incomplete data required for a computation. Importantly, the AI user interface 228 can operate as part of a computer-controlled pipeline that produces structured outputs, rather than merely providing advice, by receiving missing-field inputs and injecting them into structured data objects that are used in later computations.

In an exemplary embodiment, the subsystem 200 can include an external data interface 220 that can coordinate access to one or more external data sources and can normalize the returned results into a consistent internal format. The external data interface 220 can be coupled to, or can access, one or more external sources, including a FEMA flood database 202, a property records database 204, a cost index database 206, and a hazard and building code repository 208. The external data interface 220 can maintain connectors, query templates, or source-specific parsing logic that maps disparate external schemas into standardized internal field names. The external data interface 220 can also store provenance metadata, such as source identifiers, retrieval timestamps, and source confidence indicators, enabling later audit and reproducibility.

In an exemplary embodiment, the subsystem 200 can include an AI data retrieval agent 224 that can retrieve, extract, and structure supplemental data. The AI data retrieval agent 224 can operate in cooperation with the external data interface 220, such that the agent 224 can determine which source to query, generate a query plan, retrieve a result set, and parse the result set into standardized field values. The AI data retrieval agent 224 can also perform staged enrichment in which a first enrichment stage populates property attributes such as home size, configuration, construction attributes, and valuation inputs from the property records database 204 and cost index database 206, and then a second enrichment stage uses one or more outputs of the first enrichment stage, such as location or configuration values, to retrieve FEMA flood zone data from the FEMA flood database 202 and/or hazard classification from the hazard and building code repository 208. This staged approach can build a complete picture from partial inputs and can reduce the need for the user to manually supply each data point.

In an exemplary embodiment, the subsystem 200 can generate an enriched coverage data structure 230 by inserting retrieved property and hazard values into the canonical coverage data structure 214. The enriched coverage data structure 230 can preserve canonical entries derived from policy text while augmenting those entries with coverage-relevant supplemental data, thereby creating a machine-usable representation that supports downstream computations that are not reliably possible using policy text alone. The enriched coverage data structure 230 can be stored as a separate structure from the canonical coverage data structure 214 to preserve baseline policy-derived extraction while enabling subsequent calculations to be performed using enriched values.

In an exemplary embodiment, the enriched coverage data structure 230 can feed a modeling and scoring layer 212 that performs structured computations such as a replacement cost formula computation, a risk scoring model computation, and severity scaling. The replacement cost formula computation can combine property attributes such as square footage, construction type, and valuation indicators with regional cost indices sourced from the cost index database 206 to compute replacement cost estimates used to evaluate dwelling coverage adequacy. The risk scoring model computation can incorporate hazard indicators such as FEMA flood zone classifications from the FEMA flood database 202 and location risk modifiers from the hazard and building code repository 208 to compute risk measures used for ranking and prioritization. The severity scaling computation can adjust a gap severity value for a gap signal based on property-specific context, such as scaling a water-related exclusion gap more heavily when the property is in a higher flood-risk zone or scaling ordinance-and-law exposure when building code factors indicate heightened upgrade costs.

In an exemplary embodiment, the subsystem 200 can generate an output 210 that includes adjusted gap severity values, modeled exposure values, and risk percentile ranking values. Adjusted gap severity values can represent gap signal severity values that have been scaled using enriched property and hazard attributes, rather than being based solely on policy text patterns. Modeled exposure values can represent computed financial exposure derived from coverage shortfalls, replacement cost estimates, and hazard modifiers. Risk percentile ranking values can represent a computed percentile position of a modeled exposure value relative to a reference distribution dataset, thereby enabling comparative risk ranking across a population of properties or policies.

Advantageously, the subsystem 200 provides a practical application that transforms unstructured homeowners' policy documents into structured intermediate representations and then augments those representations through staged, computer-controlled enrichment operations to enable repeatable computational outputs. Prior approaches commonly rely on manual data gathering, generalized checklists, or narrative summaries that do not generate machine-usable intermediate representations and that cannot be reproduced or audited with evidence anchoring and provenance. In contrast, the subsystem 200 supports eligibility-focused technical improvements by performing specific computer operations including missing-field detection over a structured canonical coverage data structure 214, controlled retrieval through multiple pathways 216, structured external source interfacing 220, AI-driven retrieval and parsing 224, creation of an enriched coverage data structure 230, and deterministic formula and model computations 212 that yield concrete outputs 210 suitable for automated ranking, workflow control, and report generation.

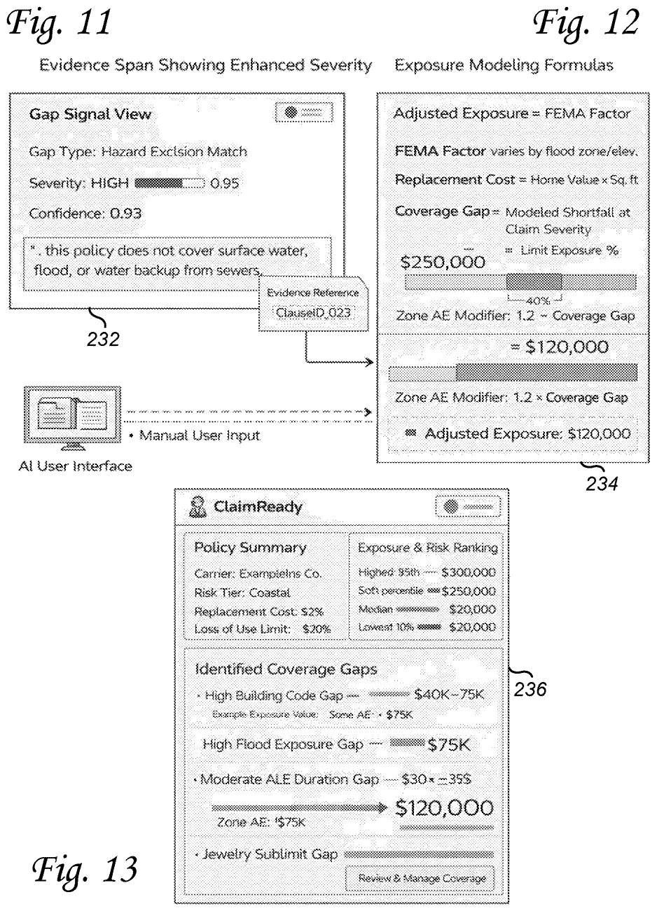

Referring to FIGS. 11, 12, and 13, there is illustrated an integrated sequence in which the system can (i) present an evidence-anchored gap signal view with an enhanced severity value, (ii) compute an adjusted exposure value using one or more exposure modeling formulas, and (iii) render a homeowner-facing dashboard that surfaces enriched exposure outputs and comparative risk ranking. In this illustrated embodiment, FIG. 11 shows an evidence span presentation 232, FIG. 12 shows an exposure modeling subsystem 234, and FIG. 13 shows an example dashboard user interface 236 that integrates the computed outputs.

In an exemplary embodiment, the gap signal view 232 can be generated from a coverage-gap vector data structure in which each gap signal includes a gap type field, a severity field, a confidence field, and an evidence reference field. The gap signal view 232 can present a gap type such as “hazard exclusion match,” and can present computed severity and confidence values that were produced by a gap detector engine operating on a canonical coverage data structure and an evidence index. In the illustrated example, the gap signal view 232 presents an enhanced severity indication and a confidence value, and it further includes an evidence span region that reproduces text from the underlying policy clause, such as language indicating that the policy does not cover surface water, flood, or water backup from sewers. The evidence span can be highlighted or otherwise emphasized to indicate the clause portion that aligned with a detection pattern, and the gap signal view 232 can include an evidence reference element identifying a clause identifier, shown as an evidence reference to “ClauseID_023.” This evidence reference can be a pointer into an evidence index that maps a canonical entry or a gap signal to a specific source span in segmented clause data, thereby enabling a deterministic retrieval path from the computed output back to the precise policy text supporting the output.

In an exemplary embodiment, the gap signal view 232 can also be linked to user-supplied and externally retrieved enrichment inputs. As illustrated, an AI user interface can accept manual user input and can coordinate staged enrichment for missing fields. When a homeowners' policy document does not explicitly include coverage-relevant property values, the system can detect missing fields in a canonical coverage data structure, initiate a first enrichment operation to retrieve property attributes such as size, configuration, construction attributes, and valuation signals, and then initiate a second enrichment operation using one or more values obtained in the first enrichment operation to retrieve hazard classification data such as FEMA flood zone data. The resulting enriched coverage data structure can then be used to scale severity, compute adjusted exposure values, and influence prioritization and ranking, while preserving evidence anchoring for policy-derived clauses and fields.

In an exemplary embodiment, the exposure modeling subsystem 234 of FIG. 12 can compute an adjusted exposure value using formula-based computation that combines enrichment-derived hazard modifiers with policy-derived coverage constraints and property-derived valuation estimates. The illustrated formula region 234 shows that an adjusted exposure value can be computed as a FEMA factor applied to a modeled shortfall, where the FEMA factor can vary by flood zone and elevation, and where replacement cost can be derived from property valuation inputs and property attributes such as square footage. The illustrated computation indicates that the system can compute a coverage gap as a modeled shortfall representing a difference between a required or modeled cost value and an applicable policy limit or sublimit value, and can then apply a flood zone modifier, such as a Zone AE modifier, to scale the gap into an adjusted exposure output. The example illustrates a scaled output value of $120,000 produced by applying a flood zone modifier (shown as 1.2) to a coverage gap value. In an exemplary embodiment, these computations can be executed by one or more processors using stored formula definitions and stored hazard modifier tables, and the computed outputs can be stored in association with corresponding gap signals as modeled exposure fields or as severity scaling factors.

In an exemplary embodiment, the dashboard user interface 236 of FIG. 13 can present the enriched results in an operationally useful form that enables a homeowner to understand quantified exposure and relative risk while retaining traceability to the underlying structured data. The dashboard user interface 236 can present a policy summary section including policy-specific and property-specific values, and it can present an exposure and risk ranking section that compares a computed exposure value against a reference distribution dataset to generate a percentile ranking. In the illustrated example, the dashboard user interface 236 includes an exposure ranking pane with distribution reference values and an identified coverage gaps pane that lists multiple gap types and corresponding exposure values, including a building code gap, a flood exposure gap, an additional living expense duration-related gap, and a jewelry sublimit gap. The dashboard user interface 236 further illustrates an aggregated or selected exposure value, shown as $120,000, consistent with the adjusted exposure computation illustrated in the exposure modeling subsystem 234. In an exemplary embodiment, each listed gap in the dashboard user interface 236 can be selectable to open an evidence-anchored gap view, such as the gap signal view 232, which preserves an evidence reference path back to the underlying clause text that triggered the gap signal.

Advantageously, FIGS. 11-13 illustrate a practical application in which the system transforms unstructured homeowners' policy documents into canonical coverage entries, links those entries to specific policy clause spans via an evidence index, enriches missing coverage-relevant fields through staged retrieval operations, and performs formula-based exposure modeling to generate concrete, machine-usable outputs that can be displayed and exported. Prior approaches typically provide narrative summaries or generic advice without reproducible intermediate representations, evidence anchoring, or deterministic computations. In contrast, the illustrated sequence produces structured outputs including evidence-referenced gap signals, computed severity and confidence values, enrichment-derived hazard modifiers, and adjusted exposure values that can drive automated prioritization, risk ranking, and downstream claim readiness workflows, thereby emphasizing technical improvements in computer processing and automated control over heterogeneous document inputs rather than abstract policy interpretation.

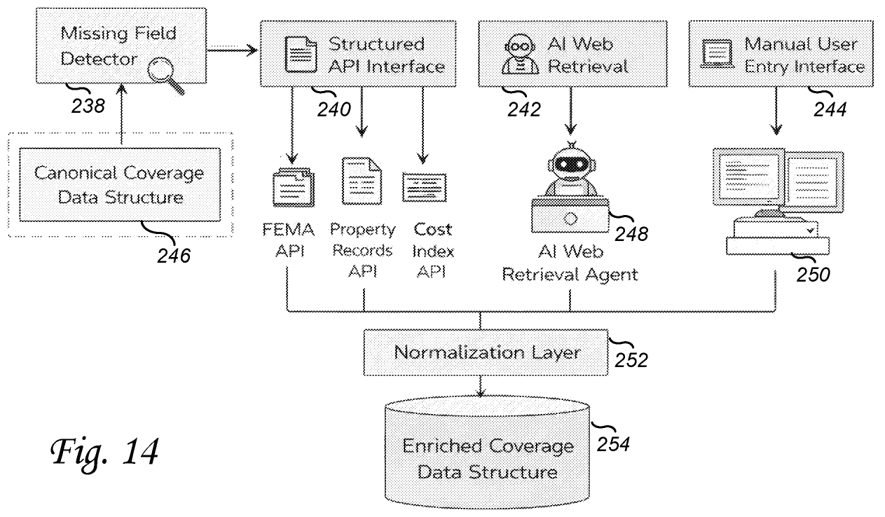

Referring to FIG. 14, there is illustrated a hybrid external data retrieval and normalization architecture that can be used by the insurance policy-and-claim document normalization and event-driven claims readiness automation system to populate missing coverage-relevant fields and generate an enriched coverage data structure 254 suitable for downstream gap detection, severity scaling, exposure modeling, and workflow automation.

In an exemplary embodiment, a canonical coverage data structure 246 can be generated from one or more homeowners' policy document files after text extraction and clause segmentation. The canonical coverage data structure 246 can include standardized coverage fields for coverage entry objects, such as coverage type, limits, sublimits, exclusions, and conditions, and can additionally include reserved or optional field slots for coverage-relevant values that are frequently absent from policy PDFs, such as property attributes and hazard classifications. The canonical coverage data structure 246 can be maintained as a machine-usable intermediate representation that enables deterministic evaluation and downstream computation.

In an exemplary embodiment, a missing field detector 238 can be configured to evaluate the canonical coverage data structure 246 to identify missing or incomplete fields required for one or more computations performed by the system. The missing field detector 238 can execute completeness rules stored in non-transitory memory and can flag missing fields based on the absence of required values, invalid formats, value-range failures, or logical inconsistencies between extracted fields. For example, the missing field detector 238 can determine that a replacement-cost modeling workflow cannot be executed until property size, construction attributes, or valuation parameters are populated, or that a hazard-modifier workflow cannot be executed until a flood zone classification field is populated. By programmatically detecting missing fields over a structured data object rather than relying on manual inspection, the missing field detector 238 can improve the reliability and repeatability of the overall computation pipeline.

In an exemplary embodiment, responsive to the missing field detector 238 identifying one or more missing fields, the system can select one or more retrieval pathways for populating the missing fields. FIG. 14 illustrates three alternative or complementary pathways that can be selected dynamically based on availability, user permissions, confidence thresholds, and the type of field to be populated. A first pathway can be a structured API interface 240, a second pathway can be an AI web retrieval pathway 242, and a third pathway can be a manual user entry interface 244. These pathways can be used individually or in combination, and the system can implement a hierarchy or fallback sequence, such as attempting structured API retrieval first and using AI web retrieval or manual entry when structured retrieval is unavailable or incomplete.

In an exemplary embodiment, the structured API interface 240 can be configured to query one or more external structured data services to retrieve coverage-relevant data in standardized formats. As illustrated, the structured API interface 240 can access a FEMA API, a property records API, and a cost index API. The FEMA API can return hazard classification fields such as flood zone designations and related metadata. The property records API can return property attribute fields such as square footage, year built, construction descriptors, parcel identifiers, and assessed values or other valuation signals. The cost index API can return regional construction cost factors or indices used to compute replacement cost estimates. The structured API interface 240 can include connectors, authentication logic, query templates, and response parsers that transform returned payloads into standardized internal fields.

In an exemplary embodiment, the AI web retrieval pathway 242 can be implemented using an AI web retrieval agent 248. The AI web retrieval agent 248 can be configured to retrieve and structure data from web resources when structured APIs are unavailable, when a field requires synthesis across multiple sources, or when the system is operating under a constrained environment that benefits from agentic retrieval. The AI web retrieval agent 248 can execute a controlled retrieval plan that can include generating a query, selecting a source, retrieving results, extracting candidate values, and transforming those values into standardized fields compatible with the canonical coverage data structure 246. The AI web retrieval agent 248 can also generate or store provenance metadata associated with a retrieved value, such as a source identifier, retrieval timestamp, and an authority score used for confidence computation. In this manner, the AI web retrieval agent 248 can function as a structured data acquisition module that produces machine-usable values rather than a free-form summarizer.

In an exemplary embodiment, the manual user entry interface 244 can enable a user to provide one or more missing values directly, such as home configuration values, valuation values, or address corrections. The manual user entry interface 244 can be presented via a client device 250. The client device 250 can be a mobile device, tablet, or desktop device, and can transmit user-entered values to the processing core. The manual user entry interface 244 can also support user confirmation of retrieved values, user overrides of retrieved values, and user addition of supporting evidence attachments. In some embodiments, user-provided values can be subjected to validation logic and can be tagged with a provenance indicator reflecting that the value originated from manual entry rather than from an external database.

In an exemplary embodiment, values produced by the structured API interface 240, the AI web retrieval agent 248, and the manual user entry interface 244 can be provided to a normalization layer 252. The normalization layer 252 can be configured to transform heterogeneous external data values into standardized tokens, standardized units, and standardized field formats compatible with the system's internal canonical schema. For example, the normalization layer 252 can reconcile different address formats, normalize construction type descriptors, map flood zone labels into canonical flood zone tokens, and normalize cost index values into a consistent representation suitable for formula-based computations. The normalization layer 252 can also resolve conflicts among multiple sources by applying precedence rules, confidence rules, or user confirmation rules, and can store resolution outcomes as part of a provenance record.

In an exemplary embodiment, the normalization layer 252 can populate an enriched coverage data structure 254 by inserting normalized values into the canonical coverage data structure 246. The enriched coverage data structure 254 can preserve policy-derived normalized coverage entries while augmenting the coverage data structure with property attributes and hazard classifications required for severity scaling and exposure modeling. The enriched coverage data structure 254 can therefore function as a machine-usable input to later modules, including generation of a coverage-gap vector with gap signals that reflect both policy text and property context, computation of replacement cost estimates using cost indices, computation of hazard modifiers using flood zone outputs, and generation of risk percentile rankings based on modeled exposure.

Advantageously, the architecture shown in FIG. 14 provides a practical application and technical improvement by enabling the system to programmatically populate missing coverage-relevant fields and to generate a standardized enriched representation that supports reproducible computation across incomplete and heterogeneous policy documents. Prior approaches commonly require manual data gathering and manual interpretation, or they provide static summaries that cannot be reliably recomputed when new data is obtained. In contrast, the disclosed architecture uses structured intermediate representations, a missing-field detection mechanism, multiple controlled retrieval pathways, and a normalization layer to produce concrete machine outputs in the form of an enriched coverage data structure 254 that can drive subsequent automated operations. This grounding in specific data structures, controlled data acquisition, normalization logic, and computer-executed transformation supports eligibility by emphasizing improvements in computer processing and automated workflow control rather than abstract policy advice.

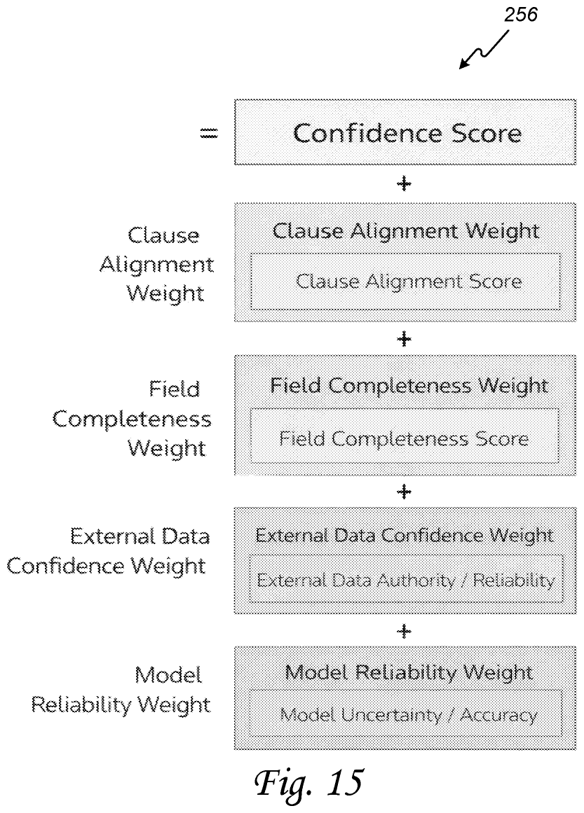

Referring to FIG. 15, there is illustrated a confidence composition subsystem 256 configured to compute a composite confidence score for a detected coverage gap by combining multiple contributing confidence factors using a weighted scoring function. The confidence composition subsystem 256 can provide a technical mechanism for quantifying reliability of gap detections in a reproducible manner, particularly in homeowners' policies where policy language varies widely by carrier, where endorsements introduce exceptions, and where certain coverage-relevant fields may be absent until populated through staged enrichment.

In an exemplary embodiment, the confidence composition subsystem 256 can receive one or more input confidence factors derived from earlier stages of the processing pipeline. A first confidence factor can include a clause alignment score that quantifies how strongly one or more segmented policy clauses align with a gap detection pattern or normalized rule applied by a gap detector engine. The clause alignment score can be computed from evidence-indexed clause spans and can reflect lexical similarity, semantic similarity, classifier probability, or other match metrics. This factor can reduce false positives by requiring strong textual support in the underlying policy clause for the detected gap type.

In an exemplary embodiment, the confidence composition subsystem 256 can receive a second confidence factor comprising a field completeness score that quantifies completeness of coverage-relevant fields in the canonical or enriched coverage data structure. The field completeness score can reflect whether key standardized coverage fields are populated, whether numeric values are present and validated, and whether required property attributes and hazard classifications have been successfully retrieved or confirmed. For example, a gap detection that depends on a replacement cost estimate can have reduced confidence when square footage or construction type fields are missing, and can have increased confidence when those fields are present through enrichment or user confirmation.

In an exemplary embodiment, the confidence composition subsystem 256 can receive a third confidence factor comprising an external data authority score that quantifies reliability of one or more externally retrieved values used in enrichment or severity scaling. The external data authority score can be derived from a source identifier associated with a retrieved value and can be based on whether the value originated from a structured API, an authoritative public record repository, a FEMA flood classification source, or a user-entered override. In some embodiments, the external data authority score can incorporate retrieval recency, source consistency across multiple sources, and whether the user confirmed the value through an interface. This factor can provide a technical safeguard by reducing confidence when enrichment inputs are uncertain or when the external source is weak.

In an exemplary embodiment, the confidence composition subsystem 256 can receive a fourth confidence factor comprising a model reliability score that quantifies reliability of the model components used in the detection pipeline. The model reliability score can represent a performance indicator for a classifier model used for clause classification or document event classification, can represent a rule set maturity indicator for a rule-based detector, or can represent an ensemble agreement score when multiple evaluators are used. In some embodiments, the model reliability score can be version-specific and can be stored in association with a rule set version identifier or a model version identifier, enabling reproducible confidence computation across system updates.

In an exemplary embodiment, the confidence composition subsystem 256 can apply a weighting function that assigns weights to each input factor and computes a composite confidence score. The weights can be stored in non-transitory memory and can be configurable by detection type. For example, an exclusion-pattern gap signal can weight clause alignment higher than field completeness, while a replacement-cost adequacy gap signal can weight field completeness and external data authority higher. The weighting function can be implemented as a linear combination, a bounded normalization function, a logistic transform, or another deterministic computation. The resulting composite confidence score can be stored as a confidence field within a gap signal record in a coverage-gap vector data structure and can be used to rank or filter gap signals, to trigger user confirmation when confidence is below a threshold, or to control downstream automation such as task generation and notification urgency.

In an exemplary embodiment, the confidence composition subsystem 256 can also output supporting metadata that enables evidence-anchored explainability. For example, the subsystem can store the individual component scores and the applied weights in association with a gap signal so that, when a user selects a gap signal in a user interface, the system can explain that confidence is high because a strong clause match was found and because authoritative FEMA hazard data was retrieved, or that confidence is moderate due to incomplete property attributes. This improves transparency and can reduce user error relative to systems that present unqualified warnings without a computable confidence basis.

Advantageously, the confidence composition subsystem 256 provides a practical application by producing a concrete numeric confidence output derived from structured intermediate representations and deterministic computations. Prior approaches often provide unqualified summaries or subjective confidence statements that cannot be reproduced. The present subsystem improves computer processing by quantifying reliability using multiple independent factors tied to evidence-indexed policy clauses, structured field completeness checks, external data provenance, and model reliability indicators, thereby yielding a machine-usable confidence score that can drive automated prioritization, filtering, and workflow control. This grounding in data structures and computation supports eligibility by emphasizing technical improvements in computer processing and automated decision control rather than abstract policy interpretation.

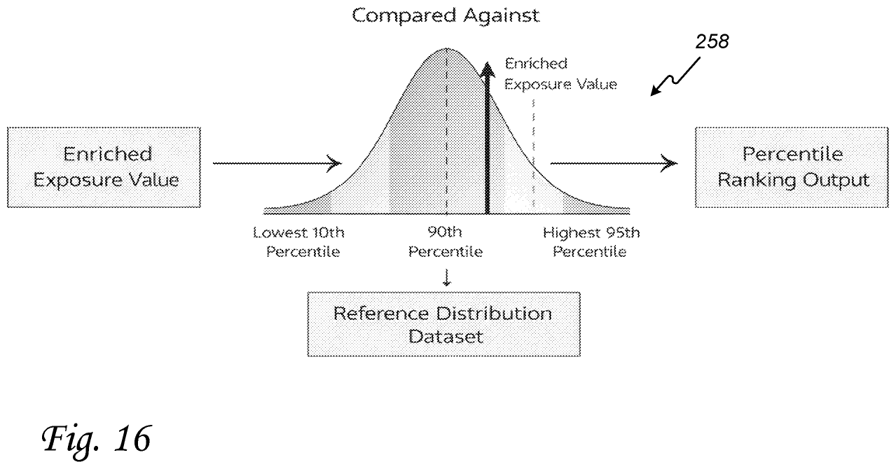

Referring to FIG. 16, there is illustrated a risk percentile computation subsystem 258 configured to convert an enriched exposure value into a comparative percentile ranking by evaluating the enriched exposure value against a reference distribution dataset. The subsystem 258 can be used to provide a homeowner-facing risk position that is computed from structured policy-derived fields, enrichment-derived property and hazard fields, and formula-based exposure modeling outputs, thereby enabling a consistent and reproducible ranking method across different homeowners' policies and property profiles.

In an exemplary embodiment, the subsystem 258 can receive an enriched exposure value as an input. The enriched exposure value can be a computed output produced by an exposure modeling subsystem and can represent a modeled financial exposure associated with one or more coverage gaps. For example, the enriched exposure value can be computed from a modeled coverage shortfall, replacement cost estimation, hazard modifier scaling, and other structured calculations derived from an enriched coverage data structure. The enriched exposure value can be stored as a machine-usable numeric field associated with a gap signal record or a report record so that it can be reused without re-running full document parsing.

In an exemplary embodiment, the subsystem 258 can access a reference distribution dataset that includes a population-level distribution of exposure values or exposure proxies. The reference distribution dataset can be stored in non-transitory memory and can be periodically updated. The dataset can be segmented into one or more strata to improve fairness and relevance, such as segmenting by geographic region, building type, construction year ranges, dwelling value bands, or hazard categories. In some embodiments, the subsystem 258 can select an appropriate distribution slice using enrichment-derived property attributes and hazard classifications. For example, an address-derived hazard classification can be used to select a distribution corresponding to a coastal zone or an inland flood zone, while construction type can be used to select a distribution corresponding to a particular replacement cost regime.

In an exemplary embodiment, the subsystem 258 can compute a percentile ranking output by locating the enriched exposure value within the selected distribution. The percentile can be computed using an empirical cumulative distribution function, a binned histogram approximation, or a parametric fit applied to the distribution dataset. In one implementation, the subsystem 258 can compute the proportion of distribution values that are less than or equal to the enriched exposure value and can output that proportion as the percentile ranking. In another implementation, the subsystem 258 can compute a percentile band classification, such as “top 10% exposure,” “top 25% exposure,” or “median exposure,” and can store both the numeric percentile and the band label.

In an exemplary embodiment, the subsystem 258 can output the percentile ranking as a machine-usable record that is associated with a report interface and, where applicable, with individual gap signals. The output can include a percentile value field and can optionally include a distribution identifier, a segmentation identifier, and a computation timestamp. This metadata can support auditability and reproducibility by enabling the system to later explain which distribution slice was used and how the percentile was computed. In some embodiments, the subsystem 258 can also store a confidence indicator associated with the percentile computation, which can be derived from confidence values of the underlying gap signals, from completeness of enrichment fields, and from the authority level of external data sources.

In an exemplary embodiment, the percentile ranking output can be used to control prioritization of gaps and recommendations. For example, a gap signal having a moderate severity but a very high percentile ranking can be elevated in the user interface due to comparative risk position, while a low percentile ranking can de-emphasize otherwise minor gaps to reduce user overwhelm. The percentile output can also be used as an input to workflow automation, such as creating tasks to gather supporting documentation or to request specific endorsements when percentile thresholds are exceeded.

Advantageously, the risk percentile computation subsystem 258 provides a practical application by transforming computed exposure values into comparative rankings using structured statistical evaluation over a reference distribution dataset. Prior approaches commonly provide qualitative risk labels that are not reproducible or are not grounded in structured computations derived from policy text and property context. The present subsystem improves computer processing by operating on machine-usable intermediate representations, applying deterministic percentile computation logic, and producing a concrete percentile output record that can be displayed, exported, and used to drive further automated actions, thereby emphasizing technical implementation and reproducible computation rather than abstract policy advice.

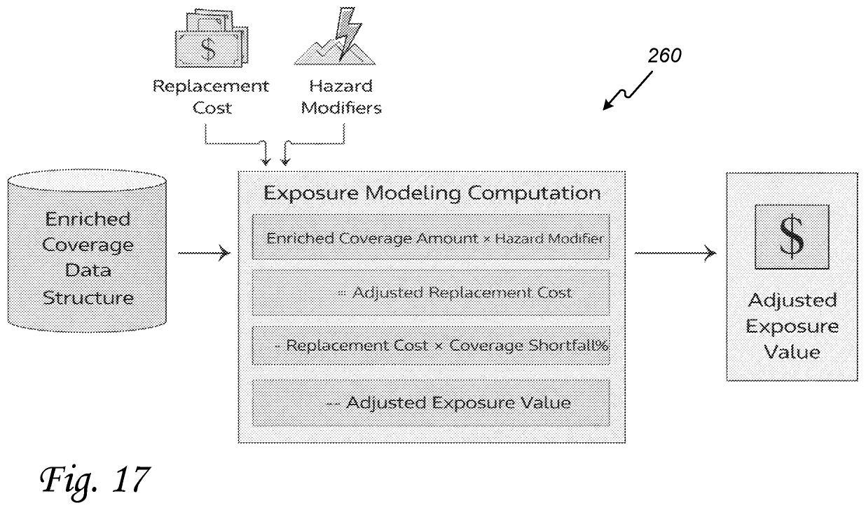

Referring to FIG. 17, there is illustrated an exposure modeling computation subsystem 260 configured to generate an adjusted exposure value using enriched coverage data, including computation of replacement cost values and application of hazard modifier values to determine an adjusted replacement cost and a modeled coverage shortfall used to output an adjusted exposure value. The subsystem 260 can operate after canonicalization and staged enrichment so that policy-derived limits and exclusions can be evaluated in view of property-specific attributes and hazard classifications that are frequently absent from homeowners' policy PDFs.

In an exemplary embodiment, the exposure modeling computation subsystem 260 can receive, as an input, an enriched coverage data structure that includes both policy-derived standardized coverage fields and enrichment-derived property and hazard fields. The policy-derived fields can include at least a coverage type field, a limit field, a sublimit field, an exclusion field, and a condition field, while the enrichment-derived fields can include one or more property attributes such as square footage, construction descriptors, and valuation signals, and one or more hazard classification fields such as FEMA flood zone values. By operating on a structured, enriched coverage representation rather than raw policy text, the subsystem 260 can provide a technical improvement in reproducibility and consistency across differing policy formats and incomplete documents.

In an exemplary embodiment, the subsystem 260 can compute a replacement cost value by applying one or more formula-based computations to enrichment-derived property attributes. For example, the subsystem 260 can compute an estimated replacement cost using square footage, construction type, and regional cost index values, where the regional cost index values can be obtained from an external cost index repository and normalized into standardized units by a normalization layer. The computed replacement cost can be stored as a computed field within the enriched coverage data structure and can be used as a baseline for evaluating dwelling coverage adequacy or code upgrade exposure. This replacement cost computation can be performed deterministically using stored formulas and coefficients so that results can be reproduced, audited, and recomputed when updated input data is retrieved.

In an exemplary embodiment, the subsystem 260 can compute or retrieve a hazard modifier value based on hazard classification fields present in the enriched coverage data structure. For instance, when the hazard classification field indicates a particular FEMA flood zone designation, the subsystem 260 can retrieve a corresponding hazard multiplier from a hazard modifier table stored in non-transitory memory or derived from an external hazard repository. The hazard modifier value can represent a scaling factor that increases or decreases modeled exposure as a function of hazard context, thereby enabling the same policy exclusion or limitation to have different computed consequences depending on the property's hazard environment.

In an exemplary embodiment, the subsystem 260 can generate an adjusted replacement cost by combining the replacement cost computation with the hazard modifier value. In one implementation, an adjusted replacement cost can be computed by multiplying a base replacement cost estimate by a hazard multiplier and optionally applying additional adjustment terms associated with building code or geographic factors. In another implementation, the hazard modifier can be applied later in the computation chain, such as scaling a shortfall value rather than scaling a replacement cost value. The particular ordering can be configurable, and the subsystem 260 can store configuration and version identifiers for the applied formula set to support provenance and repeatability.

In an exemplary embodiment, the subsystem 260 can compute a modeled coverage shortfall by comparing a modeled requirement value to a policy-derived limit or sublimit value stored in the enriched coverage data structure. For example, a dwelling coverage shortfall can be computed as the difference between an adjusted replacement cost and a dwelling coverage limit, while a category shortfall can be computed as the difference between a category subtotal derived from an inventory item data structure and a corresponding policy sublimit. The modeled coverage shortfall can be expressed as an absolute value, as a percentage shortfall, or as a normalized magnitude suitable for later risk ranking and score computation.

In an exemplary embodiment, the subsystem 260 can output an adjusted exposure value based on the modeled coverage shortfall and one or more scaling factors. The adjusted exposure value can represent an estimated financial exposure that can be associated with a particular gap signal in a coverage-gap vector, can be used to compute a severity field, and can be used as an input to a risk percentile computation subsystem. The adjusted exposure value can be stored as a machine-usable output record and can be rendered in a report interface, such as a homeowner dashboard showing quantified gap impacts and ranked priorities.

Advantageously, the exposure modeling computation subsystem 260 provides a practical application by converting policy limits, property attributes, and hazard classification fields into computed exposure values using deterministic, computer-executed formulas and structured intermediate representations. Prior approaches often provide generalized warnings about being underinsured or about flood risk without a reproducible computational basis, especially when key home attributes are missing from the policy document. The present subsystem 260 improves computer processing by using staged enrichment to populate missing property and hazard fields, by performing formula-based replacement cost computation and hazard scaling, and by producing concrete machine outputs such as modeled shortfalls and adjusted exposure values that can drive automated prioritization, evidence-anchored reporting, and downstream workflow automation, rather than abstract policy interpretation.

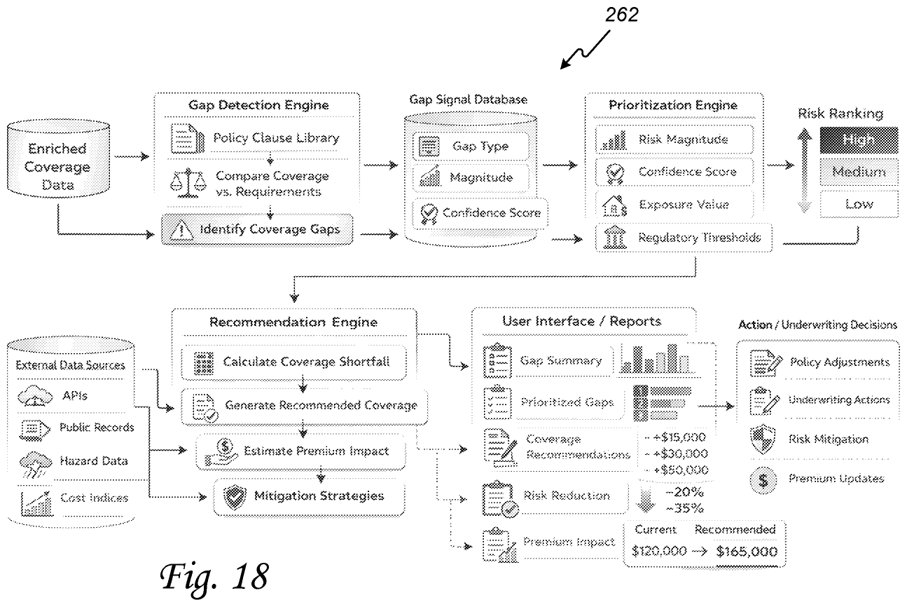

Referring to FIG. 18, there is illustrated an end-to-end gap detection and prioritization workflow 262 in which enriched coverage data is transformed into structured gap signals, ranked outputs, and actionable recommendations through a sequence of computer-executed detection, scoring, and reporting operations. The workflow 262 can represent a practical application of the system in which homeowners' policy documents and enrichment-derived data are converted into machine-usable intermediate representations that enable reproducible computations, explainable outputs, and automated prioritization, rather than relying on manual review or narrative-only summaries.

In an exemplary embodiment, the workflow 262 can begin with enriched coverage data shown as enriched coverage data 264. The enriched coverage data 264 can include a canonical coverage representation derived from policy ingestion, text extraction, clause segmentation, and canonicalization, and can be augmented through staged enrichment to populate missing property fields and hazard fields. For example, enriched coverage data 264 can include standardized coverage fields such as coverage type, limit, sublimit, exclusion, and condition fields, and can further include property attributes and hazard classifications obtained through external retrieval operations. The enriched coverage data 264 can be stored as a machine-usable data structure that is suitable for deterministic evaluation and repeated processing across sessions.

In an exemplary embodiment, the workflow 262 can process enriched coverage data 264 with a gap detection engine 266. The gap detection engine 266 can include a policy clause library 268, a compare coverage vs. requirements operation 270, and an identify coverage gaps operation 272. The policy clause library 268 can store normalized clause tokens, clause categories, and detection patterns, which can be applied to canonical entries and evidence-mapped clause spans to identify gaps consistently across insurer-specific phrasing. The compare operation 270 can compute whether extracted and enriched values satisfy coverage expectations, rule thresholds, or modeled requirements, such as whether a dwelling limit is likely insufficient given a computed replacement cost, whether a water-related exclusion creates risk in a flood-prone zone, or whether a sublimit conflicts with inventory categories. The identify operation 272 can produce candidate gap determinations in a machine-readable form rather than as free-form commentary.

In an exemplary embodiment, outputs of the gap detection engine 266 can be stored in a gap signal database 274. The gap signal database 274 can store structured gap signal records including, as illustrated, a gap type field 276, a magnitude field 278, and a confidence score field 280. The gap type field 276 can represent a normalized classification, such as hazard exclusion, sublimit restriction, duration limit, underinsured dwelling, or code upgrade limitation. The magnitude field 278 can represent a quantified measure of severity or shortfall, such as a difference between a modeled requirement and a policy limit, or a scaled exposure value based on hazard factors. The confidence score field 280 can represent a computed confidence derived from clause alignment, field completeness, external data authority scoring, and model reliability factors. This structured storage can allow later re-ranking, filtering, and export of gap signals without re-running full document parsing each time.

In an exemplary embodiment, the workflow 262 can feed gap signals from the gap signal database 274 into a prioritization engine 282. The prioritization engine 282 can be configured to compute a ranking order using multiple computed dimensions, including risk magnitude 284, confidence score 286, exposure value 288, and regulatory thresholds 290. Risk magnitude 284 can correspond to the magnitude field 278 or to a derived metric that emphasizes certain classes of gaps. Confidence score 286 can correspond to the confidence score field 280 and can be used to avoid over-weighting uncertain detections. Exposure value 288 can reflect a modeled financial exposure computed using enrichment-driven hazard modifiers and replacement cost estimates. Regulatory thresholds 290 can represent policy condition triggers, statutory or contractual deadlines, or other thresholds that increase urgency or priority. The prioritization engine 282 can output a risk ranking 292 that can be represented using levels such as high, medium, and low, enabling fast triage while preserving the underlying computed values for auditability.

In an exemplary embodiment, the workflow 262 can incorporate a recommendation engine 294 configured to convert prioritized gaps into specific computed recommendations that can be surfaced to a homeowner and optionally exported for follow-on action. The recommendation engine 294 can include a calculate coverage shortfall operation 296, a generate recommended coverage operation 298, an estimate premium impact operation 300, and mitigation strategies 302. The calculate operation 296 can compute a shortfall amount by comparing current limits and conditions against modeled requirements derived from enriched property attributes and cost indices. The generate operation 298 can produce a recommended coverage target or adjustment value, which can be expressed as a recommended limit, endorsement addition, or coverage configuration change. The estimate operation 300 can compute an estimated premium impact based on a stored pricing curve, a carrier-neutral estimator, or other actuarial approximations. The mitigation strategies 302 can propose non-coverage actions that reduce risk and can be stored as structured suggestions tied to gap categories, such as flood mitigation steps when flood exposure is elevated.

In an exemplary embodiment, the recommendation engine 294 can consume external data sources 304 shown with example categories including APIs 306, public records 308, hazard data 310, and cost indices 312. The external data sources 304 can support staged enrichment in which property attributes obtained from public records 308 and cost indices 312 can be used to retrieve and interpret hazard data 310, such as FEMA flood information. These external source inputs can provide objective context for scaling exposure values, computing replacement cost estimates, and improving recommendation accuracy when policy documents do not explicitly state relevant property details.

In an exemplary embodiment, the workflow 262 can output results to a user interface/reports module 314. The user interface/reports module 314 can render a summary 316, prioritized gaps 318, coverage recommendations 320, risk reduction 322, and premium impact 324 in a structured way. In the illustrated example, the user interface/reports module 314 can present ranked gap items and associated quantified adjustments, and can present comparative outputs such as a current value 326 and a recommended value 328, illustrated as a change from $120,000 to $165,000. In an exemplary embodiment, these values can correspond to a modeled exposure reduction or a recommended coverage limit adjustment derived from the recommendation engine 294 and prioritization engine 282. The user interface/reports module 314 can also maintain evidence-anchored explainability by providing linkages from each gap to an evidence reference that points to the supporting policy clause spans stored in an evidence index, thereby enabling a user to review the exact policy language underlying each computed gap.

In an exemplary embodiment, outputs of the user interface/reports module 314 can be consumed by an action/underwriting decisions module 330, which can include categories such as policy adjustments 332, underwriting actions 334, risk mitigation 336, and premium updates 338. While the system can be homeowner-facing, these outputs can also support downstream actions such as generating structured request lists, producing standardized summaries for an agent, or creating documentation packages for policy updates. The action/underwriting decisions module 330 can be implemented as one or more automated workflows that take structured recommendations as inputs and produce configurable outputs, while preserving provenance and confidence values to avoid over-automation.

In an exemplary embodiment, an insurance policy-and-claim document normalization and event-driven claims readiness automation system can include a document ingestion interface, one or more processors, and a non-transitory memory storing instructions for executing an integrated policy-and-inventory pipeline that generates an enriched coverage representation, computes inventory-related discrepancies against policy constraints, and produces a template-ready claim artifact output with evidence-anchored traceability. The document ingestion interface can be configured to receive a policy document file, an inventory dataset, and a claim-related document file associated with a claim record. The policy document file can include homeowners' declarations pages, forms, and endorsements, the inventory dataset can include structured item entries or source documents from which item entries are derived, and the claim-related document file can include claim correspondence or claim artifacts relevant to a proof-of-loss submission or dispute package.

In an exemplary embodiment, the system can generate, from the policy document file, a canonical coverage data structure comprising a standardized set of coverage fields including at least a sublimit field and a deductible field. The canonical coverage data structure can be produced by text extraction, clause segmentation, and normalization logic that maps heterogeneous insurer terminology into standardized vocabulary tokens and standardized field formats. The sublimit field can store category-based special limits commonly present in homeowners' policies, such as jewelry, firearms, electronics, collectibles, business property, water backup, or other categories. The deductible field can store deductible values, deductible types, and optionally condition parameters that affect applicability. By structuring these constraints in fixed fields, the system can enable deterministic comparisons against inventory values without requiring a user to manually search policy PDFs.

In an exemplary embodiment, the system can generate an evidence index that maps an entry in the canonical coverage data structure to a corresponding source span in extracted policy text. The evidence index can store evidence references that associate a policy-derived constraint, such as a particular sublimit, with the precise clause source span in the policy document file. This enables later explainability and auditing for discrepancy outputs, such that when the system asserts that a category is underinsured relative to a special limit, the system can retrieve and display the exact policy language that establishes the limit and can attach that evidence to a generated claim artifact.

In an exemplary embodiment, the system can generate, from the inventory dataset, an inventory item data structure comprising a plurality of inventory item entries. Each inventory item entry can include at least an item category field and an item value field. The item category field can store a normalized category token that allows cross-referencing to policy special limit categories, and the item value field can store a monetary value, optionally with currency, valuation source type, and date. In some implementations, inventory item entries can also include an item description field, a quantity field, and supporting documentation identifiers such as receipt, appraisal, photo, or invoice attachment identifiers. Structuring inventory content into machine-readable entries enables programmatic aggregation, category subtotal computation, and deterministic discrepancy detection.

In an exemplary embodiment, the system can detect, based on the canonical coverage data structure, a missing coverage-relevant field comprising at least one of a property value field, a property attribute field, or a property configuration field. Missing-field detection can be performed by applying validation and completeness rules to standardized fields and reserved modeling fields. For example, the system can determine that an exposure or severity model for inventory discrepancies may require property context such as home valuation, home size, building type, or location to scale certain categories, to determine materiality thresholds, or to apply hazard-sensitive weighting. The system can detect missing fields as nulls, invalid formats, or fields required by a configured modeling profile.

In an exemplary embodiment, responsive to detecting the missing coverage-relevant field, the system can initiate a first AI web enrichment operation using an AI web retrieval agent to retrieve first supplemental property data. The first supplemental property data can include at least one of a home size value, a home configuration value, a home construction attribute value, or a home valuation value. The AI web retrieval agent can execute a controlled retrieval plan that queries one or more external sources and transforms retrieved values into standardized internal fields. Retrieved values can be tagged with source identifiers and timestamps to support provenance and later audit. The system can then initiate, after retrieving the first supplemental property data, a second AI web enrichment operation using the AI web retrieval agent to retrieve second supplemental hazard data comprising FEMA flood zone data based on at least one value of the first supplemental property data. In this staged approach, the first enrichment stage provides inputs required to accurately retrieve hazard classification data, such as a normalized address, parcel indicator, or configuration-derived geolocation, and the second stage retrieves FEMA flood zone classification and related hazard modifiers that can be used to scale severity and exposure.

In an exemplary embodiment, the system can generate an enriched coverage data structure by inserting at least the first supplemental property data and the second supplemental hazard data into the canonical coverage data structure. The enriched coverage data structure can preserve policy-derived sublimit and deductible constraints while augmenting the coverage representation with enrichment-derived property attributes and hazard classification fields. The enriched coverage data structure can be stored as a machine-usable intermediate representation that supports subsequent deterministic computation, including severity scaling and context-aware prioritization of discrepancies, while maintaining the ability to trace policy-derived constraints back to evidence through the evidence index.

In an exemplary embodiment, the system can generate a discrepancy data structure by comparing a sublimit field of the enriched coverage data structure to an item value field of at least one inventory item entry having a corresponding item category field. The comparison can be performed by matching a normalized inventory category token to a normalized policy special limit category token and then evaluating whether the item value exceeds the corresponding sublimit value. In some implementations, the system can aggregate item values across multiple inventory item entries within the same category and compare the category subtotal to the sublimit, thereby detecting discrepancies that are not visible when evaluating items individually. The discrepancy data structure can include an evidence citation field that references the evidence index, enabling any discrepancy to be directly supported by the policy clause source span that established the sublimit.

In an exemplary embodiment, the discrepancy data structure can further include a discrepancy type field and a discrepancy severity field. The discrepancy type field can classify the discrepancy, such as “category sublimit shortfall,” “documentation missing,” or “policy exclusion conflict.” The discrepancy severity field can be generated based on a difference between a sublimit value stored in the sublimit field and an item value stored in the item value field, such as computing a dollar shortfall or a percentage shortfall. In some embodiments, the discrepancy severity field can be further generated based on FEMA flood zone data, such as scaling severity for certain categories or claim conditions when hazard classification indicates elevated risk or heightened likelihood of loss scenarios that affect certain categories. The FEMA-derived scaling can be implemented as a deterministic multiplier or weighting applied to a computed shortfall, and the applied multiplier can be stored for reproducibility and audit.

In an exemplary embodiment, the system can generate, based on the discrepancy data structure, a claim artifact data structure comprising an artifact output field configured to populate a claim-ready document template using at least the discrepancy data structure and the inventory item data structure. The claim-ready document template can be a proof-of-loss template, an inventory schedule template, a discrepancy report template, or another structured claim submission document. In generating the claim artifact data structure, the system can select a list of inventory item entries satisfying an inclusion rule stored in non-transitory memory and compute a subtotal value derived from the item value field for the selected list. The inclusion rule can require supporting documentation, such as a receipt identifier or appraisal identifier, and can be applied deterministically to select items for inclusion in the claim-ready output. The claim artifact data structure can also embed evidence citations that reference the evidence index, such as inserting a citation to the policy clause establishing a special limit that is implicated by the discrepancy. This enables the resulting artifact to be both claim-ready and evidence-supported.

In an exemplary embodiment, the system can store the claim artifact data structure in a dispute package data structure that comprises a document list field identifying the policy document file and the claim-related document file and a timestamp field. The dispute package data structure can act as a machine-readable container that packages inputs and outputs relevant to a claim submission or dispute, including the specific documents relied upon and the generated artifact output. The timestamp field can record creation or export timing for audit and deadline compliance. The dispute package can optionally include provenance metadata such as enrichment source identifiers, retrieval timestamps, and formula or rule version identifiers used to compute severity and output values.

In an exemplary embodiment, a method of using the system can include receiving the policy document file, the inventory dataset, and the claim-related document file; generating the canonical coverage data structure from the policy document file; generating the evidence index mapping canonical entries to source spans in extracted policy text; retrieving first supplemental property data using the AI web retrieval agent; retrieving second supplemental hazard data comprising FEMA flood zone data based on at least one value of the first supplemental property data; generating the enriched coverage data structure by inserting the property and hazard data into the canonical coverage data structure; generating the inventory item data structure from the inventory dataset; generating the discrepancy data structure by comparing the sublimit field to the item value field of at least one inventory item entry having a corresponding item category field; and generating the claim artifact data structure comprising the artifact output field configured to populate the claim-ready document template. In some implementations, the method can include automatically updating the artifact output when inventory entries change, when enrichment values are refreshed, or when policy endorsements introduce updated sublimits.

In an exemplary embodiment, the described pipeline provides a technical improvement in computer processing by converting unstructured coverage constraints and inventory inputs into a template-ready artifact output using structured intermediate representations, staged external enrichment, deterministic comparison logic, and evidence anchoring through an evidence index. Prior approaches often require manual extraction of special limits from policy PDFs and manual cross-checking against inventories in spreadsheets, producing results that vary by reviewer and are difficult to audit. In contrast, the described system produces concrete machine outputs, including a canonical coverage data structure, an enriched coverage data structure augmented by staged enrichment, an inventory item data structure of normalized entries, a discrepancy data structure with computed severity and evidence citations, and a claim artifact data structure suitable for template population. These computer-executed transformations and structured outputs provide practical application for claim documentation preparation and dispute packaging while emphasizing technical implementation and reproducible automation rather than abstract claim advice.

Advantageously, the end-to-end workflow 262 of FIG. 18 illustrates a practical application that is rooted in specific computing operations and data transformations. Prior approaches often stop at providing narrative explanations or static checklists, which can be difficult to reproduce and audit. In contrast, the illustrated system can generate and maintain structured intermediate representations such as enriched coverage data 264, structured gap signals in the gap signal database 274, computed prioritization outputs from the prioritization engine 282, and quantified recommendations from the recommendation engine 294. These outputs can be rendered and exported through the user interface/reports module 314 and can drive downstream actions through the action/underwriting decisions module 330. This architecture emphasizes technical improvements in computer processing of heterogeneous policy documents by enabling deterministic, evidence-anchored, and enrichment-informed computation, and by producing concrete machine outputs that support automated prioritization and report generation rather than abstract policy interpretation.

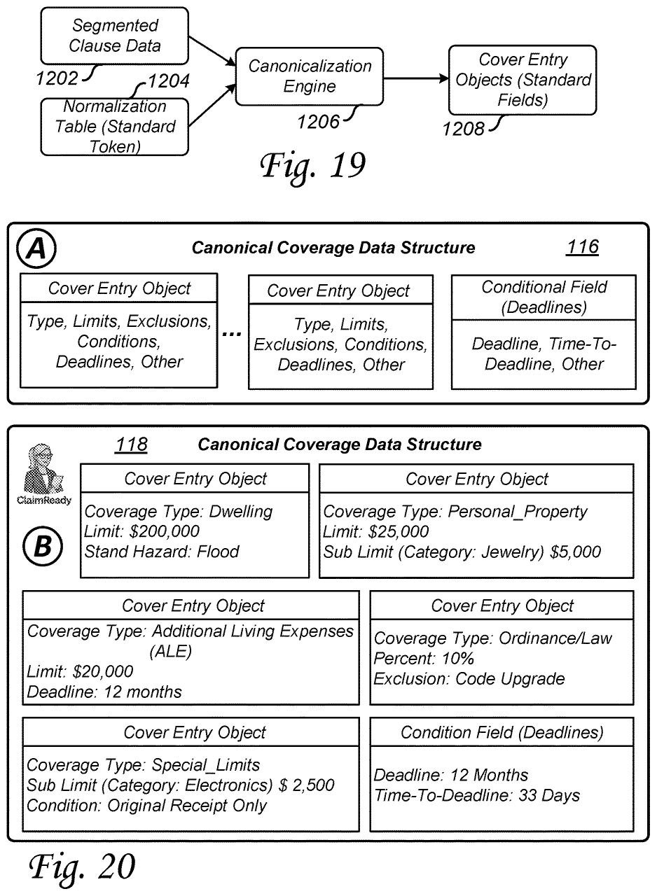

Referring to FIG. 19, there is illustrated a canonicalization workflow in which segmented clause data 1202 and a normalization table 1204 are processed by a canonicalization engine 1206 to generate cover entry objects 1208 having standardized fields suitable for downstream machine processing, including evidence-anchored gap detection, enrichment, exposure modeling, and workflow automation.

In step 1202, the system can generate and/or access segmented clause data 1202 derived from homeowners' policy text that has been extracted and segmented into clause units. In an exemplary embodiment, the segmented clause data 1202 can include clause identifiers and source span descriptors (for example, page/line offsets or bounding box coordinates), enabling later evidence anchoring so that any normalized coverage output can be traced back to a specific portion of the policy document. This step can improve computer operation by structuring unstructured policy text into discrete, addressable units that can be evaluated consistently across heterogeneous policy formats.

In step 1204, the system can generate and/or access a normalization table 1204 storing standardized tokens and mapping rules used to normalize insurer-specific language into canonical terms. In an exemplary embodiment, the normalization table 1204 can include mapping entries that associate multiple semantically equivalent phrases found in policy documents to a single standardized token, such as mapping “Loss of Use,” “Additional Living Expense,” and “Coverage D” into a standardized coverage type token. The normalization table 1204 can also include mappings for limits, sublimits, exclusions, and condition phrases (including deadlines), enabling reproducible extraction even when different carriers express the same concept differently. This step provides a technical improvement by constraining interpretation to deterministic, machine-applied mappings rather than subjective human judgment.

In step 1206, the canonicalization engine 1206 can process the segmented clause data 1202 using the normalization table 1204 to generate a canonical coverage representation. In an exemplary embodiment, the canonicalization engine 1206 can apply one or more parsing operations that identify candidate coverage fields within a clause, normalize candidate fields into standardized tokens, and populate structured fields while recording internal provenance, such as a mapping identifier or rule version. The canonicalization engine 1206 can also enforce field completeness logic, including detection of missing coverage-relevant fields that may later trigger staged enrichment. This step can be implemented as a computer-executed transformation pipeline that converts heterogeneous text data into machine-usable objects that can be stored, queried, compared, and computed upon.

In step 1208, the canonicalization engine 1206 can output cover entry objects 1208 that each contain standardized fields corresponding to coverage elements extracted from the policy document. In an exemplary embodiment, a cover entry object 1208 can include a coverage type field, limit field, sublimit field, exclusion field, and condition field, and can be stored within a canonical coverage data structure for downstream operations. The resulting cover entry objects 1208 can serve as concrete machine-readable inputs for generating evidence-linked gap signals, performing staged AI web enrichment to populate missing property and hazard fields, computing exposure values using formula-based modeling, and driving event-driven task graph automation. This step supports practical application by producing structured digital outputs that enable subsequent automated processing and are not limited to an abstract review of policy language.

Referring to FIG. 20, there is illustrated an internal structure of a canonical coverage data structure in a technical view 116 and an exemplary embodiment 118 populated with example homeowners' policy data. The canonical coverage data structure can be generated by the system after text extraction and clause segmentation of a policy document file, and can be configured to store standardized coverage entries in a machine-usable format that enables deterministic gap detection, evidence indexing, staged enrichment, and downstream workflow automation.

In an exemplary embodiment, the technical view 116 can depict the canonical coverage data structure as a container that includes multiple coverage entry objects. Each coverage entry object can correspond to a distinct coverage concept extracted from the policy, such as dwelling coverage, personal property coverage, loss of use (ALE) coverage, ordinance or law coverage, water damage limitations, special limits, and other coverages or limitations. The coverage entry objects can be stored as structured records, each record comprising a standardized set of coverage fields that the system can populate by applying a normalization table to heterogeneous insurer terms. This standardized representation can provide a technical improvement over prior approaches that rely on free-form summaries, because downstream modules can operate on fixed fields rather than on ambiguous natural language.

In an exemplary embodiment, each coverage entry object in the technical view 116 can include at least a coverage type field, a limit field, a sublimit field, an exclusion field, and a condition field. The coverage type field can store a standardized token identifying the coverage entry, such as “DWELLING,” “PERSONAL_PROPERTY,” or “LOSS_OF_USE.” The limit field can store a normalized numeric value and units. The sublimit field can store special limits for subcategories, such as jewelry, electronics, water backup, or other categories. The exclusion field can store a normalized exclusion descriptor or an exclusion token that can be evaluated by a gap detector engine. The condition field can store time-based or action-based conditions, such as duties after loss, notice requirements, proof-of-loss timing, repair documentation requirements, and other conditions that can affect claim readiness and can be used to drive deadline timers and task generation.

In an exemplary embodiment, the technical view 116 can depict a condition field region that is emphasized as storing deadlines or time-based requirements. This condition field can be populated from clause segmentation outputs by identifying temporal phrases, extracting deadline values, and normalizing those values into a canonical time representation. The condition field can be used by downstream modules to compute time-to-deadline values, to generate notification triggers, and to re-rank claim tasks within an event-driven task graph. The condition field, therefore can act as a coupling point between policy analysis mode outputs and claim mode workflows, enabling the system to reuse the same canonical coverage data structure across both operational contexts.

In an exemplary embodiment, the exemplary embodiment 118 can populate the canonical coverage data structure with example data values representative of a homeowners' policy. For example, a dwelling coverage entry can include a limit value, a personal property entry can include a category sublimit such as a jewelry limit, and a loss of use (ALE) entry can include a duration condition such as a maximum number of months. The exemplary embodiment 118 can further include an exclusion concept such as “surface water excluded” or “flood excluded,” and can associate time-based conditions such as a proof-of-loss time limit. While the displayed example values are illustrative, the exemplary embodiment demonstrates how the system's canonical coverage data structure stores policy-derived values in standardized fields that can be consistently processed across different carriers and different document formats.

In an exemplary embodiment, the canonical coverage data structure shown in FIG. 20 can be linked to an evidence index that maps each standardized field value, or each coverage entry object, to one or more source spans in segmented clause data derived from the policy document file. This linkage can allow the system to maintain evidence-anchored explainability in subsequent user interfaces, such that when a coverage gap is detected or a workflow task is generated, the system can retrieve and display the exact policy clause supporting the underlying determination. This evidence anchoring can also support auditability and reproducibility because the system can preserve a deterministic reference path from a computed gap signal or deadline to the policy text that triggered the outcome.

Advantageously, the canonical coverage data structure of FIG. 20 provides a practical application by producing a concrete machine-usable intermediate representation that enables downstream computation, enrichment, and automation. Prior approaches commonly present generalized coverage summaries or require manual extraction and interpretation of policy terms. The present system improves computer processing of heterogeneous policy documents by structuring extracted policy content into standardized coverage entry objects with fixed fields, enabling deterministic rule evaluation, computed severity and confidence scoring, staged enrichment of missing property and hazard values, and generation of time-based workflows that are grounded in extracted condition fields. This architecture emphasizes technical data transformation and automated control logic rather than abstract policy interpretation, thereby supporting eligibility and providing multiple implementation pathways for robust, explainable homeowners' coverage analysis.

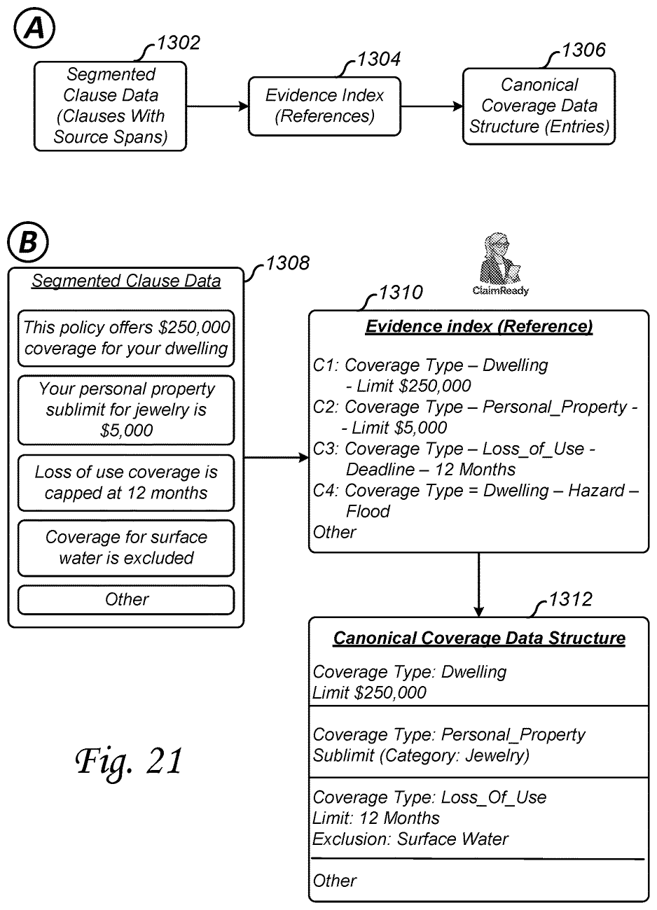

Referring to FIG. 21, there is illustrated an evidence index mapping mechanism that can associate segmented clause data to entries in a canonical coverage data structure using evidence references, thereby enabling evidence-anchored explainability and reproducible downstream computations. FIG. 21 includes a technical workflow labeled reference ‘A’ and a corresponding exemplary embodiment labeled reference ‘B’, where the exemplary embodiment illustrates example data that can populate the technical steps. In the illustrated arrangement, technical step 1302 corresponds to exemplary step 1308, technical step 1304 corresponds to exemplary step 1310, and technical step 1306 corresponds to exemplary step 1312.

In step 1302, the system can generate and/or access segmented clause data 1302 comprising clause units derived from extracted homeowners' policy text and associated source spans indicating where each clause appears in the policy document file. In an exemplary embodiment, each clause can be stored with an identifier and a source span descriptor, such as a page number and offset range, or other locational metadata. This segmentation can improve computer operation by converting unstructured policy text into discrete, addressable units that can be programmatically mapped to normalized coverage entries and later retrieved for evidence display.

In step 1304, the system can generate an evidence index 1304 that stores one or more references linking normalized coverage concepts to the source spans of the segmented clause data. In an exemplary embodiment, the evidence index 1304 can include reference records that associate a coverage entry identifier with one or more clause identifiers and corresponding source spans. This evidence indexing can serve as a persistent linkage layer that allows subsequent modules, such as gap detection and user interface rendering, to reference the precise policy language supporting a computed output, thereby improving traceability and reducing ambiguity relative to approaches that rely on generalized summaries.

In step 1306, the system can generate and/or access a canonical coverage data structure 1306 comprising normalized coverage entries. In an exemplary embodiment, the canonical coverage data structure 1306 can include standardized fields, such as a coverage type field, limit field, sublimit field, exclusion field, and condition field, and can store values normalized from insurer-specific terminology into standardized tokens. The canonical coverage data structure 1306 can be linked to the evidence index 1304 such that each canonical entry can be associated with the specific clause source span that supports it. This linkage can provide a technical improvement by enabling reproducible machine processing in which normalized entries are both computable and evidence-addressable.

In an exemplary embodiment, in reference ‘B’, beginning in steps 1308, the segmented clause data 1308 can be populated with example clause text strings that correspond to homeowners' policy concepts. In the illustrated example, the clause list includes representative statements such as “This policy offers $250,000 coverage for your dwelling,” “Your personal property sublimit for jewelry is $5,000,” “Loss of use coverage is capped at 12 months,” and “Coverage for surface water is excluded,” along with other clauses. In an exemplary embodiment, each clause shown in segmented clause data 1308 can correspond to a clause unit that includes an associated source span that points to the location of the clause in the policy document.

In step 1310 of the exemplary embodiment, the evidence index 1310 can be populated with example evidence references C1-C4 that map the clause concepts to normalized coverage entries. In the illustrated example, reference C1 can correspond to a dwelling coverage type with a limit of $250,000, reference C2 can correspond to a personal property coverage type with a jewelry sublimit of $5,000, reference C3 can correspond to a loss of use coverage type with a deadline of 12 months, and reference C 4 can correspond to a hazard-related concept such as flood or surface water. In an exemplary embodiment, each evidence reference (such as C1-C4) can store or point to one or more clause identifiers and source spans from the segmented clause data 1308, thereby enabling a user interface to retrieve and display the underlying clause text as evidence when presenting computed outputs.

In step 1312 of the exemplary embodiment, the canonical coverage data structure 1312 can be populated with standardized coverage entries derived from the segmented clause data 1308 and linked via the evidence index 1310. In the illustrated example, canonical entries include a dwelling coverage entry with a limit of $250,000, a personal property entry with a jewelry sublimit, and a loss of use entry including a time-based limit and an exclusion concept. In an exemplary embodiment, these canonical entries can be stored as structured objects within the canonical coverage data structure 1312 and can be used by downstream modules to generate gap signals with computed severity and confidence values, to trigger staged enrichment where fields are missing, and to populate reports and workflows with evidence-anchored explainability.

Advantageously, the mapping mechanism shown in FIG. 21 can provide a practical application that produces concrete machine-usable outputs, including an evidence index and a canonical coverage data structure that jointly enable traceable and reproducible computations. Prior approaches commonly require a user to manually interpret policy language or rely on non-traceable summaries, whereas the present system can compute coverage gap signals and exposure values while preserving a reference path to the supporting policy text. This evidence-anchored linkage can strengthen reliability and auditability of the automated analysis and provides a technical foundation for implementing coverage gap detection, staged enrichment, and event-driven claim readiness workflows in a manner that is rooted in specific data transformations and computer-controlled operations rather than abstract policy interpretation.

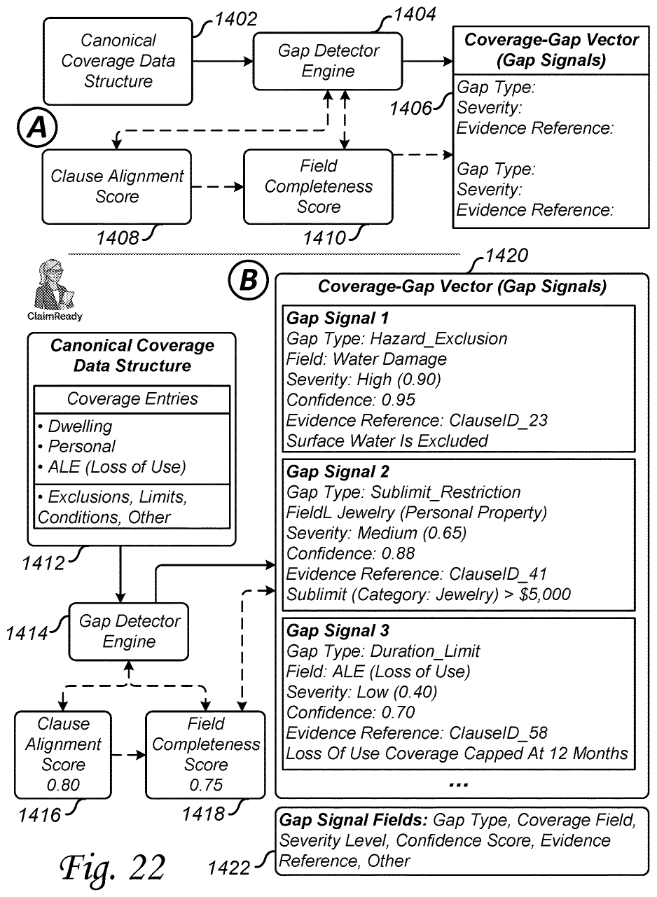

Referring to FIG. 22, there is illustrated a coverage-gap vector generation workflow that can convert a canonical coverage representation into a structured coverage-gap vector comprising gap signals, with computed severity and confidence values, and evidence references suitable for downstream automated processing and evidence-anchored explainability. FIG. 22 includes a technical workflow designated by reference ‘A’ and a corresponding exemplary embodiment designated by reference ‘B’, where the exemplary embodiment illustrates example data populating the technical steps. In the illustrated arrangement, technical step 1402 corresponds to exemplary step 1412, technical step 1404 corresponds to exemplary step 1414, technical step 1406 corresponds to exemplary step 1420, technical step 1408 corresponds to exemplary step 1416, and technical step 1410 corresponds to exemplary step 1418. Reference 1422 provides informational context regarding example fields of a gap signal.

In step 1402, the system can generate, store, and/or access a canonical coverage data structure 1402 representing normalized coverage entries extracted from homeowners' policy documents. In an exemplary embodiment, the canonical coverage data structure 1402 can include standardized coverage entry objects and standardized fields, such as coverage type, limits, sublimits, exclusions, and conditions, which can be produced through text extraction, clause segmentation, and canonicalization. This step can provide a technical improvement over manual review by transforming heterogeneous, carrier-specific policy language into a machine-usable representation that can be deterministically evaluated by downstream computational modules.

In step 1404, the system can execute a gap detector engine 1404 configured to evaluate the canonical coverage data structure 1402 against one or more gap detection patterns, rules, and/or evaluators. In an exemplary embodiment, the gap detector engine 1404 can operate on normalized tokens and standardized fields rather than raw policy text, which can improve consistency across policy formats. The gap detector engine 1404 can further be configured to identify one or more gap conditions, such as a hazard exclusion condition, a sublimit restriction condition, or a duration limitation condition, and to generate intermediate determinations used to populate structured gap signals.

In step 1406, the system can generate a coverage-gap vector 1406 (gap signals) that can include a plurality of structured gap signal records. In an exemplary embodiment, each gap signal record can include at least a gap type field, a severity field, and an evidence reference field, and can optionally include additional fields as described by the informational field set shown at reference 1422. The coverage-gap vector 1406 can be stored as a machine-readable data structure that is suitable for downstream automated operations, including user interface rendering with evidence anchoring, task graph prioritization, exposure modeling, and export into a machine-readable record for subsequent automated processing.

In step 1408, the system can compute a clause alignment score 1408 that quantifies how strongly one or more detected policy clauses align with one or more gap detection patterns used by the gap detector engine 1404. In an exemplary embodiment, clause alignment scoring can be computed using token-based matching, semantic similarity scoring, classifier probability outputs, and/or weighted rule matches, and can be used to reduce false positives by distinguishing strong textual support from weak or ambiguous support. The clause alignment score 1408 can be persisted as a computed metric associated with a gap signal record to support reproducibility and explainability.

In step 1410, the system can compute a field completeness score 1410 that quantifies completeness of coverage-relevant fields in the canonical coverage data structure 1402. In an exemplary embodiment, the field completeness score 1410 can be computed based on whether required standardized fields are populated, whether extracted numeric values satisfy validation rules, and whether enrichment-populated fields are present where expected. The field completeness score 1410 can be used as an additional technical control metric to influence confidence scoring and prioritization, particularly in situations where policy documents omit details or where certain values are implied by forms and endorsements rather than explicitly stated.

In an exemplary embodiment, in reference ‘B’, beginning in step 1412, the canonical coverage data structure 1412 can be populated with example homeowners' coverage entries, including entries labeled “Dwelling,” “Personal,” and “ALE (Loss of Use),” along with exclusions, limits, and conditions. In an exemplary embodiment, these entries can correspond to standardized coverage entry objects produced by a canonicalization subsystem, enabling the system to evaluate coverage gaps consistently without requiring manual interpretation of disparate policy formatting.

In step 1414 of the exemplary embodiment, the gap detector engine 1414 can operate on the canonical coverage data structure 1412 to identify specific gap types and affected fields. In the illustrated example, the gap detector engine 1414 can detect gap types corresponding to hazard exclusion, sublimit restriction, and duration limit conditions. In an exemplary embodiment, the gap detector engine 1414 can also select or generate evidence references that correspond to supporting policy clause identifiers, enabling evidence anchoring of the outputs.

In step 1416 of the exemplary embodiment, the system can compute a clause alignment score 1416 with an example value (e.g., 0.80) indicating strength of alignment between detected clauses and gap detection patterns. In an exemplary embodiment, this score can represent a normalized confidence component derived from clause matching operations and can be used as an input to a composite confidence computation for the gap signal.

In step 1418 of the exemplary embodiment, the system can compute a field completeness score 1418 with an example value (e.g., 0.75) indicating completeness of standardized fields relevant to the detected gaps. In an exemplary embodiment, completeness can reflect whether key policy values are present, whether enrichment has populated missing property or hazard fields, and whether validation checks have succeeded, thereby influencing the reliability of the resulting gap signal.

In step 1420 of the exemplary embodiment, the system can generate the coverage-gap vector 1420 populated with example gap signals. In the illustrated example, a first gap signal can indicate a hazard exclusion affecting “Water Damage” with a high severity and an evidence reference tied to a clause identifier (e.g., “ClauseID_23”); a second gap signal can indicate a sublimit restriction for jewelry with a medium severity and an evidence reference (e.g., “ClauseID_41”); and a third gap signal can indicate a duration limit for ALE (Loss of Use) with a low severity and an evidence reference (e.g., “ClauseID 58”). In an exemplary embodiment, each evidence reference can enable the system to retrieve and display the corresponding source span from segmented clause data, enabling evidence-anchored explainability and auditability.

In step 1422, gap signal fields are presented as informational content indicating example data fields that can be included in a gap signal record, such as gap type, coverage field, severity level, confidence score, evidence reference, and other fields. In an exemplary embodiment, these additional fields can include hazard classification fields, enrichment provenance fields, modeled exposure values, and priority ranking fields, enabling downstream workflow automation and reporting features.

Advantageously, the workflow of FIG. 22 can ground the system's outputs in concrete machine operations, including canonicalization, computed scoring metrics, and structured data generation with evidence references. Prior approaches often produce narrative summaries that are difficult to reproduce and verify. The present system can instead generate a machine-usable coverage-gap vector with computed severity and confidence values derived from traceable input structures, enabling practical application through automated ranking, report generation, and integration with event-driven workflows, while preserving evidence-anchored explainability suitable for user review and downstream automation.

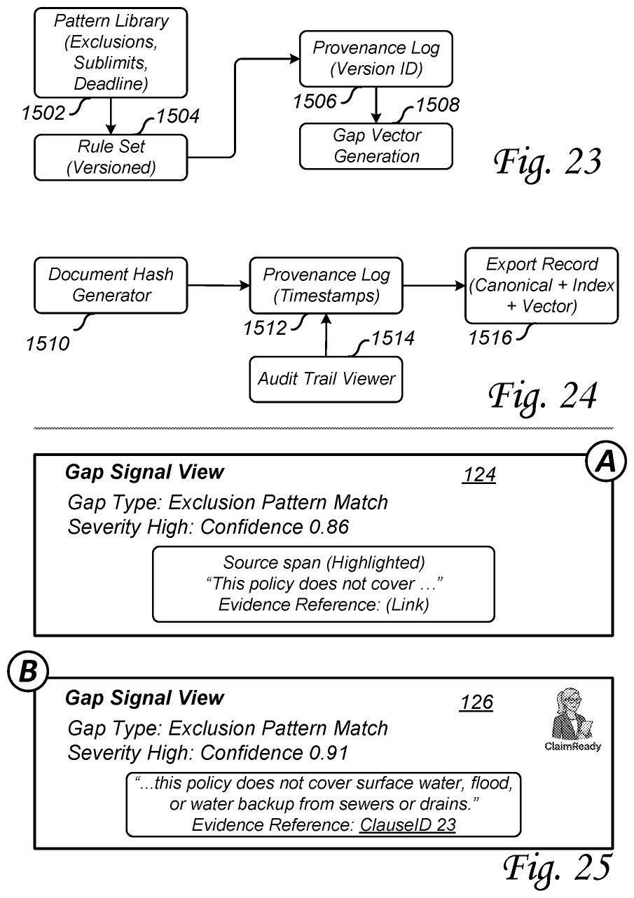

Referring to FIG. 23, there is illustrated a versioned gap-detection configuration workflow that can control how the system generates coverage-gap vectors in a reproducible, auditable, and evidence-anchored manner. In the illustrated embodiment, the workflow shows technical steps 1502-1508 in which a pattern library and a versioned rule set can be curated and applied to gap vector generation, while a provenance log stores a version identifier to preserve repeatability of computed results across time, across users, and across heterogeneous homeowners' policy documents.

In step 1502, the system can generate and/or access a pattern library 1502 that can include machine-readable detection patterns for homeowners' policy analysis. In an exemplary embodiment, the pattern library 1502 can include exclusion patterns, sublimit patterns, and condition or deadline patterns expressed in one or more formats, such as token patterns, regular expressions, semantic templates, or classifier prompts. The patterns can be written against standardized tokens produced by canonicalization so that the same pattern can operate consistently across different insurers' phrasing. This step can provide a technical improvement by enabling deterministic, computer-executable detection logic that operates on normalized policy representations rather than relying on free-form human interpretation.

In step 1504, the system can generate a rule set 1504 that can be versioned and that can be derived from, or can reference, the pattern library 1502. In an exemplary embodiment, the rule set 1504 can define which patterns are active for a given deployment, how multiple patterns are prioritized, and what parameter thresholds are applied for severity scaling, confidence computation, or missing-field detection. The rule set 1504 can also define how gap types are classified, such as mapping a detected “surface water” exclusion pattern to a hazard exclusion gap type. By constructing the rule set 1504 as an explicit, versionable configuration artifact, the system can enable consistent behavior when processing the same policy document at different times or in different system instances.

In step 1506, the system can write a provenance log 1506 that stores at least a version identifier associated with the rule set 1504 that is used for a given analysis run. In an exemplary embodiment, the provenance log 1506 can store the version identifier alongside a timestamp and a processing session identifier so that the system can later reproduce, explain, or audit how a particular gap signal was generated. The provenance log 1506 can be stored as a machine-readable record that is associated with an export record and can be retrieved for audit trail viewing. This step can provide a technical improvement by ensuring traceability of the computational configuration that produced a set of outputs, which is particularly important when enrichment data and exposure modeling formulas are also being applied.

In step 1508, the system can perform gap vector generation 1508 using the rule set 1504 corresponding to the version identifier stored in the provenance log 1506. In an exemplary embodiment, gap vector generation 1508 can include evaluating a canonical coverage data structure and, where applicable, an enriched coverage data structure populated through staged AI enrichment. The system can generate a coverage-gap vector comprising gap signals that include a gap type, severity, confidence, and an evidence reference linking back to an evidence index and corresponding source spans in segmented clause data. Because the rule set version is logged, the resulting gap signals can be reproducible and can remain explainable by referencing both the policy evidence and the rule set configuration used to compute the output.

Advantageously, the workflow of FIG. 23 supports a practical application in which the system produces concrete, machine-generated outputs that are controlled by explicit, versioned computational artifacts rather than by subjective review. Prior approaches often provide non-repeatable summaries that change based on the reviewer, while the present system can produce consistent coverage-gap vectors using a versioned rule set and a provenance log that enables auditing, reproducibility, and controlled evolution of detection logic. This architecture anchors the disclosed functionality in specific computer operations involving structured configuration management, deterministic evaluation over normalized data structures, and version-linked output generation, thereby strengthening technical character and supporting eligibility by emphasizing technical improvements in computer processing and traceable automation.

Referring to FIG. 24, there is illustrated a provenance and auditability workflow that can generate verifiable metadata for a policy analysis session and can package machine-usable intermediate representations into an exportable record suitable for downstream automated processing and review. In the illustrated embodiment, the workflow includes technical steps 1510-1516 that can be executed under control of one or more processors and non-transitory memory to improve repeatability, traceability, and integrity of the computed outputs produced by the system.

In step 1510, a document hash generator 1510 can generate a document hash for at least one ingested document file. In an exemplary embodiment, the document hash generator 1510 can compute a cryptographic hash value over the content of a policy document file and/or a claim-related document file, and can optionally compute separate hash values for each file and/or for a concatenated bundle. The document hash can provide a stable content fingerprint that enables later verification that a downstream computation, report, or export corresponds to a specific document version, which reduces ambiguity in environments where policy PDFs can be reissued or modified by endorsements.

In step 1512, a provenance log 1512 can be generated or updated to store timestamped metadata associated with processing events. In an exemplary embodiment, the provenance log 1512 can record one or more timestamps corresponding to document ingestion, text extraction, clause segmentation, canonical coverage data structure generation, evidence index creation, staged enrichment operations, gap vector generation, and export record creation. The provenance log 1512 can also store identifiers such as the document hash generated in step 1510 and, where applicable, a rule set version identifier and/or model version identifier used to compute confidence values and severity scaling. This timestamped provenance improves computer processing reliability by enabling reproducible replay, audit reconstruction, and deterministic correlation of outputs to specific processing configurations and input documents.

In step 1514, an audit trail viewer 1514 can access the provenance log 1512 and render an audit view of the stored metadata. In an exemplary embodiment, the audit trail viewer 1514 can be implemented as a user interface module that displays provenance entries, such as document identifiers, hash values, timestamps, rule set versions, enrichment source identifiers, and export record identifiers. The audit trail viewer 1514 can also support drill-down into evidence references by linking to the evidence index, and source spans stored for canonical coverage entries and gap signals. This step can provide a practical application by enabling a user, administrator, or downstream system to verify what data was processed, when it was processed, and which computational configurations were used, rather than relying on non-verifiable narrative explanations.

In step 1516, an export record 1516 can be generated that packages one or more machine-usable intermediate representations and computed outputs into an exportable structure. In an exemplary embodiment, the export record 1516 can include at least a canonical coverage representation, an evidence index, and a coverage-gap vector, and can optionally include enriched property attributes and hazard classification fields derived through staged AI enrichment and any computed exposure values derived from formula-based modeling. The export record 1516 can be stored in a machine-readable format suitable for downstream automated processing, such as driving task graph generation, deadline timers, claim artifact preparation, or integration with external systems, while maintaining linkage to evidence references and provenance metadata.

Advantageously, the workflow of FIG. 24 improves the technical character of the system by grounding outputs in concrete integrity checks, timestamped provenance, and exportable machine-readable data structures. Prior approaches often provide static summaries without verifiable linkage to the source documents or the computational configuration used to produce the results. The present system instead enables reproducible, evidence-anchored, and auditable automation by generating document hashes, maintaining provenance logs, enabling audit viewing, and packaging structured outputs into an export record. These operations provide a practical application and technical improvement in how computing systems process and manage heterogeneous insurance documents (such as policy forms, endorsements, declarations pages, insurer correspondence, and other) and derived outputs, supporting consistent downstream automation rather than abstract analysis.

Referring to FIG. 25, there is illustrated a user interface presentation of a gap signal with evidence-anchored explainability, including a technical view designated by reference A and an exemplary embodiment designated by reference B. In the illustrated embodiment, the technical view 124 shows a generalized gap signal view format with an evidence reference link to a highlighted source span, and the exemplary embodiment 126 shows an example populated gap signal view corresponding to a homeowners' policy exclusion clause, as can be used by the ClaimReady workflow to make computed gap outputs auditable and reproducible.

In an exemplary embodiment, the technical view A (gap signal view 124) can be generated by rendering a gap signal record from a coverage-gap vector data structure that is produced by a gap detector engine operating over a canonical coverage data structure and an evidence index. The gap signal view 124 illustrates a gap type field displayed as “Exclusion Pattern Match,” a severity indicator displayed as “Severity High,” and a confidence value displayed as “Confidence 0.86.” The gap signal view 124 further illustrates a “Source span (Highlighted)” region that can display policy text associated with the gap signal, and an “Evidence Reference: (Link)” that can be selected to retrieve the corresponding source span from segmented clause data. The evidence reference can be a pointer to an evidence index record that maps a normalized coverage entry or gap signal to a specific clause identifier and corresponding source span descriptor, such as a page index and offset range, enabling deterministic retrieval of supporting policy language rather than relying on narrative summarization.

In an exemplary embodiment, the evidence reference link shown in the technical view 124 can be implemented as a machine-resolvable identifier that the user interface can pass to a retrieval function. The retrieval function can query a data store for the evidence index entry associated with the evidence reference and return a source span descriptor identifying a precise location in the segmented clause data. The system can then render the corresponding clause excerpt into the “Source span (Highlighted)” region, optionally applying highlighting to the specific token sequence or clause portion that aligned with an exclusion pattern used by the gap detector engine. This linkage can allow the system to preserve explainability while maintaining the underlying detection as a structured computation over standardized intermediate representations.

In an exemplary embodiment, the confidence value shown in the technical view 124 can be computed and stored as part of the gap signal record prior to rendering the user interface. For example, the confidence value can be derived from a clause alignment score that quantifies match strength between a detection pattern and the clause text, a field completeness score reflecting whether required standardized fields were populated in the canonical or enriched coverage representation, and optionally an external data authority score when enrichment-derived property or hazard values are used to scale severity. The confidence value can therefore represent a computed, reproducible reliability measure that can be used to rank or filter gap signals and can reduce false positives relative to prior approaches that provide unqualified warnings.

In an exemplary embodiment, the exemplary embodiment B (gap signal view 126) can illustrate how the same technical gap signal view can be populated with example data relevant to homeowners' policies. The gap signal view 126 again displays a gap type field as “Exclusion Pattern Match,” and displays “Severity High” with a higher confidence value, “Confidence 0.91.” The source span shown in the exemplary embodiment includes an example exclusion clause excerpt stating that the policy does not cover “surface water, flood, or water backup from sewers or drains,” and the evidence reference is shown as “Evidence Reference: ClauseID 23.” The “ClauseID 23” evidence reference can correspond to a clause identifier in segmented clause data and can be mapped through the evidence index to a specific source span in the policy document file, enabling the system to retrieve and display the exact policy clause that triggered the exclusion-pattern gap signal.

In an exemplary embodiment, the gap signal view 126 can be generated by a report-rendering module that consumes the coverage-gap vector and evidence index, and it can be updated when enrichment values change. For example, if staged enrichment populates property attributes and then populates a hazard classification field such as FEMA flood zone data, the system can scale the severity of a flood-related exclusion gap based on the hazard classification. In that case, the severity presented in the gap signal view 126 can reflect an enriched severity computation, while the evidence reference remains anchored to the original policy clause that established the exclusion. This separation of “policy-evidence anchoring” from “context-aware severity scaling” can provide a technical advantage over prior approaches by enabling the system to adjust risk quantification without losing traceability to the underlying policy language.

Advantageously, FIG. 25 illustrates a practical application in which the system produces concrete, machine-generated outputs that are evidence-addressable and reproducible. Prior approaches often provide plain-language summaries without a deterministic evidence path back to the policy clause and without computed confidence fields that can be operationalized. In contrast, the disclosed gap signal view 124/126 is rooted in specific computer operations, including canonicalization of policy text into standardized fields, generation of an evidence index mapping to segmented clause source spans, creation of structured gap signals with computed severity and confidence values, and user interface rendering that resolves evidence references to display precise policy excerpts. This grounding in structured data transformations, computed metrics, and evidence-linked retrieval supports eligibility by emphasizing improvements in computer processing and explainable automation rather than abstract policy interpretation.

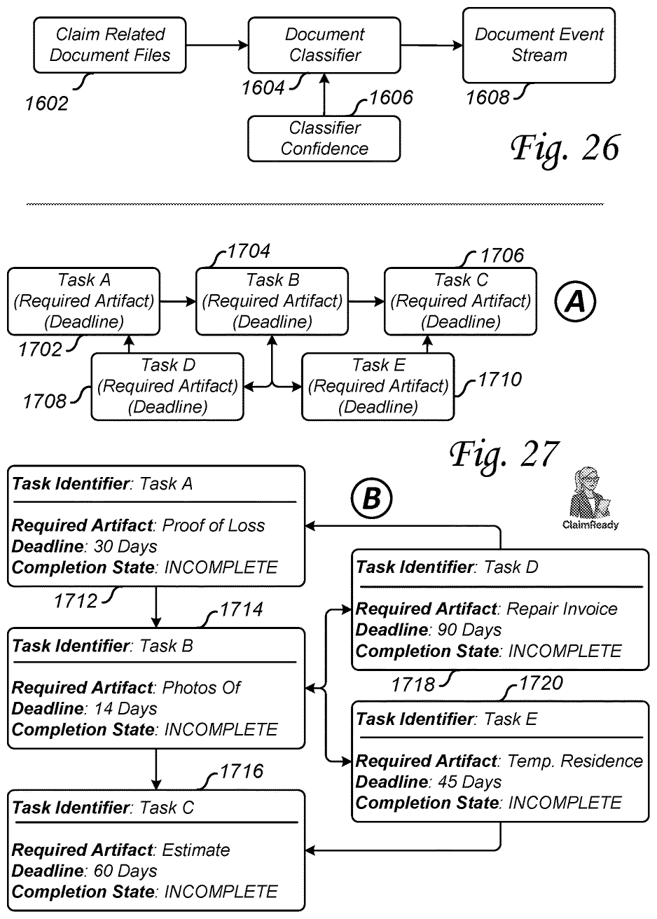

Referring to FIG. 26, there is illustrated a document event stream generation workflow in which ingested claim-related document files 1602 are processed by a document classifier 1604 to generate a document event stream 1608, with a classifier confidence output 1606 associated with the classification.

In step 1602, the system can receive and/or access claim-related document files 1602 associated with a claim record for a homeowner. In an exemplary embodiment, the claim-related document files 1602 can include denial letters, reservation-of-rights letters, insurer requests for information, estimates, scope documents, invoices, photographs, and other claim correspondence. The system can store each claim-related document file 1602 with a document identifier and metadata, such as a timestamp and optional content hash, so subsequent workflow automation remains traceable to specific inputs rather than being dependent on subjective user recollection or manual email tracking.

In step 1604, the system can process the claim-related document files 1602 using a document classifier 1604 to determine a document event type for each file. In an exemplary embodiment, the document classifier 1604 can include one or more computer-executed classification mechanisms, such as a rules-based detector, a trained machine learning classifier, or a hybrid approach that combines carrier-form recognition with semantic pattern matching. The document classifier 1604 can operate on extracted document text and structural cues, and can output a normalized event label, such as denial, information request, reservation-of-rights, estimate update, or other event classes used by downstream automation modules. This classification step can improve computer operation by converting heterogeneous, unstructured claim documents into a standardized event representation that can be programmatically consumed by task graph generation and deadline timer logic.

In step 1606, the system can generate and/or store a classifier confidence 1606 corresponding to a classification output produced by the document classifier 1604. In an exemplary embodiment, the classifier confidence 1606 can be represented as a probability score, margin score, ensemble agreement score, or other quantitative metric indicating reliability of the assigned document event type. The classifier confidence 1606 can be used as a control signal for downstream processing, such as triggering a secondary verification path when confidence is below a threshold, requesting user confirmation through a user interface, selecting a fallback ruleset, or adjusting task prioritization weights. By storing and using classifier confidence 1606, the system can reduce false triggers and can provide a technically grounded mechanism for balancing automation with robustness.

In step 1608, the system can generate and maintain a document event stream 1608 comprising a time-ordered set of document events derived from the classifications produced in step 1604 and optionally annotated with the classifier confidence 1606. In an exemplary embodiment, the document event stream 1608 can be stored as a machine-usable data structure that includes, for each event, a document identifier, an event type label, a timestamp, and an associated confidence value. The document event stream 1608 can be consumed by an event-driven workflow engine to generate and update a task graph and deadline timers, including adding new tasks, re-ranking tasks based on event priority and time-to-deadline, and associating required artifacts with specific tasks. This event-stream representation provides a practical application because it produces concrete digital outputs that directly drive automated claim readiness operations rather than merely presenting general guidance.

Advantageously, the workflow shown in FIG. 26 replaces prior approaches that rely on manual interpretation of claim correspondence and ad hoc task tracking by producing a structured event stream 1608 derived from computer-executed classification, with an explicit confidence signal 1606 for reliability control. This grounding in concrete data transformations, standardized event representations, and control logic supports eligibility by emphasizing technical improvements in computer processing and automated workflow control over heterogeneous document inputs, rather than abstract claim advice or generalized policy interpretation.

Referring to FIG. 27, there is illustrated an event-driven task graph data structure that can be generated and maintained by the insurance policy-and-claim document normalization and event-driven claims readiness automation system to control claim readiness actions based on ingested claim-related documents, extracted policy conditions, and computed deadlines. FIG. 27 includes a technical representation designated by reference A and a corresponding exemplary embodiment designated by reference B, where the exemplary embodiment illustrates example task-node data populating the technical elements. In the illustrated arrangement, technical step 1702 corresponds to example data step 1712, technical step 1704 corresponds to example data step 1714, technical step 1706 corresponds to example data step 1716, technical step 1708 corresponds to example data step 1718, and technical step 1710 corresponds to example data step 1720.

In step 1702, the system can generate a task node 1702 (Task A) within the task graph data structure. In an exemplary embodiment, the task node 1702 can include a task identifier field, a required artifact field, and a deadline field, thereby representing a concrete machine-usable task object that can be stored and programmatically evaluated. The task node 1702 can be generated responsive to detecting a triggering event in a document event stream, such as ingestion of a claim document indicating that a proof-of-loss or similar claim artifact will be required, or responsive to detecting a policy condition requiring action within a defined time window.

In step 1704, the system can generate a task node 1704 (Task B) and can establish a dependency edge from task node 1702 to task node 1704. In an exemplary embodiment, the dependency edge can be stored as a directed relationship within the task graph data structure that indicates that task node 1704 can be gated, sequenced, or prioritized based on the completion state of task node 1702. This graph-based storage can provide a technical improvement over static checklists by enabling the system to automatically control task sequencing and completion logic using machine-readable dependency edges.

In step 1706, the system can generate a task node 1706 (Task C) and can establish a dependency edge from task node 1704 to task node 1706. In an exemplary embodiment, task node 1706 can correspond to a later-stage claim artifact such as an estimate, scope document, or documentation package. The system can maintain a completion state value for task node 1706 and can re-rank task priorities based on deadline timing, dependency satisfaction, and event-type priority associated with claim document classifications.

In step 1708, the system can generate a task node 1708 (Task D) and can establish one or more dependency edges between task node 1708 and other task nodes in the task graph. In the illustrated example, task node 1708 can be linked to task node 1702 and/or task node 1704, indicating that additional claim actions can be conditionally required based on earlier tasks or based on subsequent document event stream updates. In an exemplary embodiment, task node 1708 can be created responsive to ingestion of an additional claim-related document file, such as a request for repair documentation, and can be automatically introduced into the task graph without requiring manual user creation of the task.

In step 1710, the system can generate a task node 1710 (Task E) and can establish one or more dependency edges between task node 1710 and at least one other task node. In an exemplary embodiment, task node 1710 can correspond to an additional required artifact such as temporary housing documentation, additional living expense substantiation, or other claim support documentation. The system can compute or update the deadline field for task node 1710 based on extracted policy conditions, deadlines in claim correspondence, or calculated time-to-deadline values maintained by a deadline timer subsystem.

In an exemplary embodiment, in reference ‘B’, beginning in 1712, the system can populate an example task node record 1712 corresponding to Task A with concrete data values that illustrate how a task node can be stored and presented. In the illustrated example, task node 1712 includes “Task Identifier: Task A,” a required artifact value “Proof of Loss,” a deadline value “30 Days,” and a completion state value “INCOMPLETE.” In an exemplary embodiment, these fields can be stored as structured entries in a task-node object within the task graph data structure and can be updated automatically when a corresponding artifact is detected by the system.

In step 1714 of the exemplary embodiment B, the system can populate an example task node record 1714 corresponding to Task B. In the illustrated example, task node 1714 includes “Task Identifier: Task B,” a required artifact value “Photos Of,” a deadline value “14 Days,” and a completion state value “INCOMPLETE.” In an exemplary embodiment, the deadline value can be computed from a policy condition field, a claim correspondence deadline, or a system-defined default tied to the document event type, and can be tracked by a timer object associated with the task node.

In step 1716 of the exemplary embodiment B, the system can populate an example task node record 1716 corresponding to Task C. In the illustrated example, task node 1716 includes “Task Identifier: Task C,” a required artifact value “Estimate,” a deadline value “60 Days,” and a completion state value “INCOMPLETE.” In an exemplary embodiment, the task node 1716 can be dependent on completion of one or more earlier tasks, and the system can automatically re-rank the task node 1716 based on time-to-deadline calculations and dependency satisfaction.

In step 1718 of the exemplary embodiment B, the system can populate an example task node record 1718 corresponding to Task D. In the illustrated example, task node 1718 includes “Task Identifier: Task D,” a required artifact value “Repair Invoice,” a deadline value “90 Days,” and a completion state value “INCOMPLETE.” In an exemplary embodiment, this task node can be introduced or escalated based on an insurer request document classification or based on claim status transitions detected from the document event stream, thereby demonstrating automated workflow adaptation based on incoming documents.

In step 1720 of the exemplary embodiment B, the system can populate an example task node record 1720 corresponding to Task E. In the illustrated example, task node 1720 includes “Task Identifier: Task E,” a required artifact value “Temp. Residence,” a deadline value “45 Days,” and a completion state value “INCOMPLETE.” In an exemplary embodiment, the system can associate such a task with policy-derived coverage types such as loss of use and can derive related deadlines from the condition field of a canonical or enriched coverage data structure, thereby tying the workflow to the policy's computable terms rather than to generic guidance.

Advantageously, the task graph architecture shown in FIG. 27 can provide a practical application by producing concrete machine-generated workflow outputs, including structured task nodes, directed dependency edges, deadlines, and completion state values that can be updated in response to document ingestion events and computed policy conditions. Prior approaches typically rely on static checklists or manual tracking across emails and folders. The present system can instead control task sequencing and deadline management using a stored graph structure and computed time-based logic, thereby improving consistency, reducing missed deadlines, and enabling evidence-linked, automatable claim readiness operations that are rooted in specific data structures and computer-executed transformations rather than abstract claim advice.

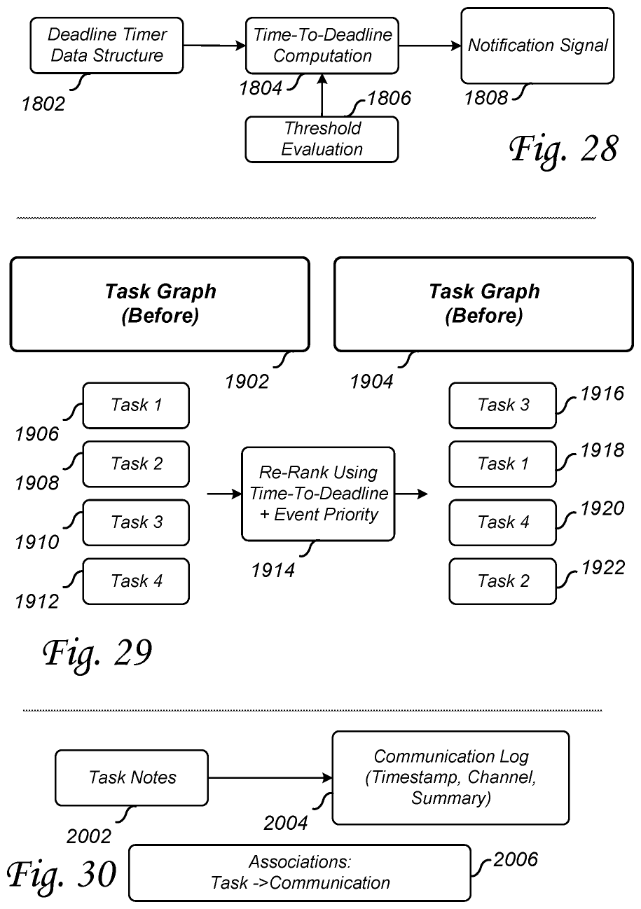

Referring to FIG. 28, there is illustrated a deadline timer subsystem workflow that can be executed by the insurance policy-and-claim document normalization and event-driven claims readiness automation system to compute time-to-deadline values for claim-related tasks and to generate notification outputs when one or more deadline thresholds are satisfied. In the illustrated embodiment, the workflow includes technical steps 1802-1808, which can operate on machine-usable deadline timer data maintained for an event-driven task graph.

In step 1802, the system can generate and/or access a deadline timer data structure 1802. In an exemplary embodiment, the deadline timer data structure 1802 can store a plurality of deadline timer records, each record being associated with a corresponding task node and including at least a deadline field and a timing state. The deadline field can be derived from a condition field in a canonical coverage data structure, from a deadline extracted from a claim-related document file, or from a system-defined deadline rule associated with a document event type. The deadline timer data structure 1802 can be stored as a machine-readable structure that is updated as new claim documents are ingested or as policy-derived conditions are identified, thereby providing a technical improvement over manual deadline tracking.

In step 1804, the system can perform a time-to-deadline computation 1804 using one or more deadline timer records in the deadline timer data structure 1802. In an exemplary embodiment, the time-to-deadline computation 1804 can compute a time-to-deadline value by comparing a current time value to a deadline value stored in a deadline field, producing a computed interval value (for example, days remaining). The computation can be performed periodically, responsive to a document event stream update, or responsive to user activity such as uploading an artifact that changes task state. This computed time-to-deadline value can be used as a control signal for downstream re-ranking of task nodes and for triggering escalations, enabling automated workflow control rather than static checklist behavior.

In step 1806, the system can perform a threshold evaluation 1806 on at least one computed time-to-deadline value. In an exemplary embodiment, the threshold evaluation 1806 can compare the computed time-to-deadline value against one or more thresholds stored in memory, such as a first threshold for generating a reminder and a second threshold for generating an escalation. Threshold values can be selected based on the task type, the event type that created the task, confidence values associated with the triggering document classification, and policy-derived condition strictness. This threshold evaluation provides a technical mechanism for controlling system behavior based on computed timing state, improving reliability and reducing missed deadlines that can occur when users rely on manual calendars or ad hoc reminders.

In step 1808, the system can generate a notification signal 1808 responsive to the threshold evaluation 1806, indicating that a threshold condition is satisfied. In an exemplary embodiment, the notification signal 1808 can be generated as a machine-usable output that drives one or more notification channels, including an in-application alert, an email message, a push notification, or a dashboard indicator. The notification signal 1808 can be associated with the corresponding task node identifier and can include a parameter identifying the applicable deadline and the computed time-to-deadline value. In some embodiments, the notification signal 1808 can also include an evidence-linked context, such as a reference to the policy condition clause or claim correspondence clause that established the deadline, thereby maintaining evidence-anchored explainability for time-sensitive actions.

Advantageously, the workflow of FIG. 28 provides a practical application by producing concrete computer-generated outputs, including computed time-to-deadline values and notification signals, derived from structured deadline timer records. Prior approaches often require manual review of policy conditions and claim letters and manual entry of deadlines into calendars, which is error-prone and difficult to keep synchronized as new documents arrive. The present system improves computer processing and workflow control by maintaining machine-readable deadline timer data, computing timing state, evaluating thresholds, and automatically generating notifications as part of an event-driven claim readiness automation pipeline, thereby grounding functionality in specific data structures and computations rather than abstract guidance.

Referring to FIG. 29, there is illustrated a task graph updating and re-ranking routine that can be executed by the insurance policy-and-claim document normalization and event-driven claims readiness automation system to reorder workflow tasks based on computed priority signals. FIG. 29 is shown in the middle portion of the page and includes technical steps 1902-1922. The other figures on the page, including the deadline timer workflow and the communication log workflow, are not part of FIG. 29 and are not described herein.

In step 1902, the system can generate and/or access a task graph data structure that includes a plurality of task nodes representing claim readiness actions. In an exemplary embodiment, each task node can include at least a task identifier field, a required artifact field, a deadline field, and a completion state field, and dependency edges can define sequencing constraints between tasks. The task graph data structure can be maintained in a data store and can be updated as new claim-related document files are ingested and classified into document event types, or as policy-derived conditions are extracted and normalized into condition fields.

In step 1904, the system can compute one or more task priority inputs used to control ordering of tasks. In an exemplary embodiment, the task priority inputs can include a time-to-deadline value derived from a deadline timer data structure, an event type priority value associated with a document event type that triggered a task, and optionally a confidence value associated with document classification or gap detection. In some embodiments, the system can also incorporate enrichment-derived hazard classification fields, such as FEMA flood zone data, to scale priority of particular task categories when risk context indicates higher urgency. These priority inputs can be computed deterministically from structured records, which improves repeatability relative to manual prioritization.

In step 1906, the system can present or represent an initial ordering of tasks, shown as Task 1 in the example set. In an exemplary embodiment, Task 1 can be a task node record with an associated deadline and required artifact, and can have an initial position based on creation order, default priority, or dependency ordering.

In step 1908, the system can present or represent an initial ordering of tasks, shown as Task 2 in the example set. In an exemplary embodiment, Task 2 can be a different task node record and can be associated with a different document event type, deadline, or dependency edge, which can affect the computed priority inputs used for re-ranking.

In step 1910, the system can present or represent an initial ordering of tasks, shown as Task 3 in the example set. In an exemplary embodiment, Task 3 can be associated with a shorter time-to-deadline value or a higher event type priority value than Task 1 or Task 2, even if Task 3 was created later, which can make Task 3 a candidate to move higher in a ranked list.

In step 1912, the system can present or represent an initial ordering of tasks, shown as Task 4 in the example set. In an exemplary embodiment, Task 4 can include its own deadline field and required artifact field, and can be subject to dependency constraints that may limit re-ranking in some cases. The system can store the initial ordering as a baseline ordering for comparison when computing an updated ordering.

In step 1914, the system can execute a re-ranking routine to compute an updated task ordering based on the task priority inputs computed in step 1904. In an exemplary embodiment, the re-ranking routine can compute, for each task node, a priority score derived from a weighted combination of time-to-deadline and event type priority, optionally adjusted by confidence values and hazard-based scaling. The system can then sort task nodes by the computed priority score, subject to dependency constraints, such that tasks with higher urgency and higher priority appear earlier in the ordered list. This re-ranking can be triggered periodically, triggered in response to detecting a change in a document event stream, triggered in response to ingesting a new claim-related document file, or triggered in response to updating enrichment-derived hazard fields that affect task urgency.

In step 1916, the system can output or render an updated ordering in which Task 3 is shown as the first task in the re-ranked list. In an exemplary embodiment, this can indicate that Task 3 has a higher computed priority score than the other tasks, such as due to a shorter time-to-deadline or a higher event type priority associated with a newly ingested insurer request.

In step 1918, the system can output or render the updated ordering showing Task 1 as the second task in the re-ranked list. In an exemplary embodiment, Task 1 can remain relatively high due to dependency gating, a moderate time-to-deadline, or a required artifact that has not been satisfied.

In step 1920, the system can output or render the updated ordering showing Task 4 as the third task in the re-ranked list. In an exemplary embodiment, Task 4 can be moved upward or downward based on its computed priority score and any dependency constraints, and can be escalated when its deadline approaches or when a relevant document event type is detected.

In step 1922, the system can output or render the updated ordering showing Task 2 as the fourth task in the re-ranked list. In an exemplary embodiment, Task 2 can be deprioritized due to a longer time-to-deadline, a lower event type priority, completion of a required artifact, or reduced urgency determined by the re-ranking routine.

Advantageously, the re-ranking routine of FIG. 29 provides a practical application by producing a concrete, computer-generated ordering of tasks derived from structured timing and event signals. Prior approaches commonly rely on manual prioritization, static checklists, or subjective judgment, which can become inaccurate when new claim correspondence arrives or when deadlines shift. The present system improves computer processing by maintaining machine-readable task nodes and deadlines, computing priority scores using deterministic logic, and automatically re-ranking tasks in response to document event stream updates and computed time-to-deadline values. This grounds the disclosed functionality in specific data structures and computational control logic that enable automated workflow sequencing rather than abstract claim guidance.

Referring to FIG. 30, there is illustrated a communication log workflow that can be executed by the insurance policy-and-claim document normalization and event-driven claims readiness automation system to capture, structure, and associate claim communications with workflow tasks and claim events. In the illustrated embodiment, the workflow includes technical steps 2002-2006 in which communication events are received, stored as structured log entries, and linked to one or more task nodes and/or claim records to support traceable claim readiness automation.

In step 2002, the system can receive and/or access communication input 2002 associated with a claim record. In an exemplary embodiment, the communication input 2002 can include a record of a phone call, an email thread, a portal message, an in-person interaction summary, or other claim-related communications. The communication input 2002 can be provided by the user through a user interface, can be imported from an external messaging source via an integration interface, and/or can be created automatically when the system transmits outbound communications. The communication input 2002 can include one or more of a timestamp, a counterparty identifier, a channel descriptor, and a free-text summary or extracted content.

In step 2004, the system can generate and store a communication log entry 2004 in a communication log data structure. In an exemplary embodiment, the communication log entry 2004 can include a communication timestamp field, a communication channel field, and a communication summary field, and can also include a document reference field identifying an associated claim-related document file when the communication resulted in, or referenced, a document. The communication log data structure can be stored as machine-readable records that can be queried and used by downstream modules, such as task graph creation, deadline timer evaluation, and dispute package generation. This structured storage provides a technical improvement over prior approaches that leave communication history distributed across email clients and notes, which makes automated workflow sequencing unreliable.

In step 2006, the system can associate the communication log entry 2004 with one or more workflow elements, such as a task node in a task graph data structure and/or an event in a document event stream. In an exemplary embodiment, association can be implemented by storing a task identifier field within the communication log entry 2004, storing a communication entry identifier within a task node record, or storing both in a relational association structure. The association can enable the system to update task completion state, generate reminders, or escalate notifications based on communication timing and content. For example, if a communication log entry indicates that requested documentation was sent to an adjuster, the system can automatically set a corresponding task node to a completed state and can start a follow-up timer for response tracking. In this manner, communication logging becomes an input to computer-controlled workflow logic rather than a passive record.

Advantageously, the workflow of FIG. 30 provides a practical application by generating concrete machine-usable communication log records and linking those records to the event-driven workflow structures used to manage claim readiness. Prior approaches typically treat communications as unstructured notes that are difficult to operationalize. The present system improves automated claim readiness by structuring communication history into fields that can drive task sequencing, deadline compliance, and evidence-supported dispute preparation, thereby grounding the disclosed functionality in specific data structures and computer-executed association logic rather than abstract claim advice.

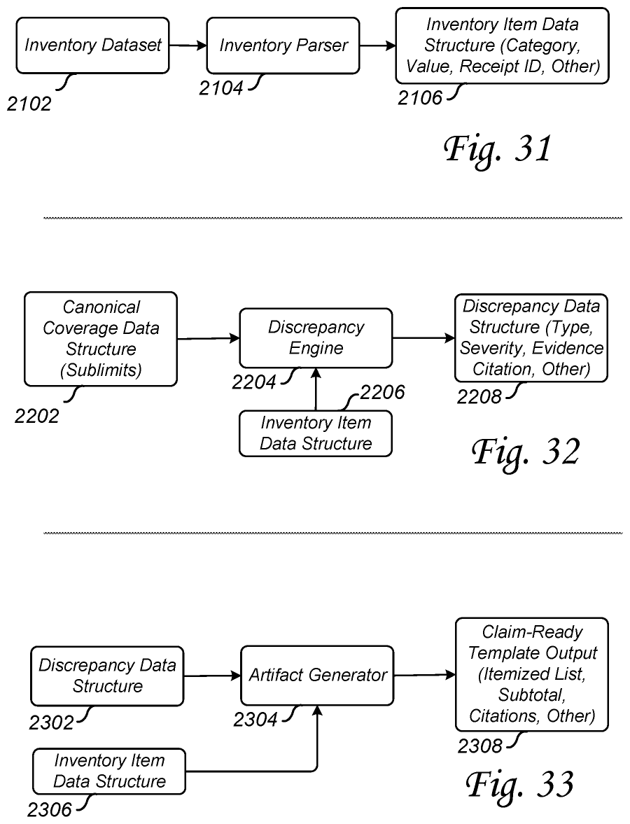

Referring to FIG. 31, there is illustrated an inventory subsystem workflow that can be executed by the insurance policy-and-claim document normalization and event-driven claims readiness automation system to generate and maintain an inventory item data structure used for coverage analysis, discrepancy detection, and claim artifact preparation. In the illustrated embodiment, the workflow includes technical steps 2102-2106 in which inventory inputs are received, structured into inventory item entries, and stored in a machine-usable form suitable for downstream computations and reporting.

In step 2102, the system can receive and/or access inventory input 2102 associated with an insured property and, in some embodiments, associated with a claim record. In an exemplary embodiment, inventory input 2102 can be entered through a user interface, imported from an external source, or derived from documents such as receipts, invoices, appraisal records, or prior inventories. The inventory input 2102 can include item descriptors, categories, estimated or documented values, acquisition dates, and optional supporting documentation identifiers, and can be stored in association with a user session to support both pre-claim preparedness and post-loss claim documentation.

In step 2104, the system can generate an inventory item data structure 2104 comprising a plurality of inventory item entries. In an exemplary embodiment, each inventory item entry can include at least an item category field and an item value field, and can optionally include additional structured fields, such as an item description field, a quantity field, a purchase date field, a depreciation indicator field, and a receipt attachment identifier field. The inventory item data structure 2104 can be implemented as a structured database table, a graph of item records, or another machine-readable representation that supports querying and automated evaluation. This structured representation provides a technical improvement over prior approaches that store inventories as unstructured spreadsheets or notes that are difficult to integrate with policy constraints.

In step 2106, the system can store and maintain the inventory item data structure 2104 in association with one or more downstream automation modules. In an exemplary embodiment, the inventory item data structure 2104 can be linked to a canonical coverage data structure and/or an enriched coverage data structure such that inventory categories and values can be compared against policy sublimits, special limits, and exclusion conditions. The system can also apply validation rules and completeness checks, such as identifying item entries missing a category assignment or missing supporting documentation identifiers, and can generate internal signals that drive follow-on tasks in a task graph, such as requesting receipts for items above a threshold value. The system can further use the inventory item data structure 2104 to populate claim artifact templates, such as proof-of-loss documents, by assembling itemized lists and computed subtotals.

Advantageously, the workflow of FIG. 31 provides a practical application by transforming user-provided and document-derived inventory information into a machine-usable data structure that can drive automated coverage discrepancy detection and claim documentation generation. Prior approaches often treat inventories as separate from policy analysis, requiring manual cross-checking of special limits and valuation rules. The present system improves computer processing by structuring inventory data into standardized fields that can be programmatically compared to canonical and enriched policy representations, enabling automated detection of underinsured categories, generation of evidence-supported discrepancy outputs, and preparation of claim-ready artifacts based on reproducible computations rather than abstract guidance.

Referring to FIG. 32, there is illustrated a discrepancy generation workflow that can be executed by the insurance policy-and-claim document normalization and event-driven claims readiness automation system to detect discrepancies between policy coverage constraints and inventory item values and to generate a discrepancy data structure suitable for downstream claim artifact preparation and dispute packaging. In the illustrated embodiment, the workflow includes technical steps 2202-2208 in which policy-derived sublimit constraints and inventory-derived values are compared, and structured discrepancy outputs are generated with evidence anchoring.

In step 2202, the system can generate and/or access a canonical coverage data structure 2202 derived from a homeowners' policy document file. In an exemplary embodiment, the canonical coverage data structure 2202 can include standardized coverage entry fields, including a sublimit field and a deductible field, and can be linked to an evidence index that maps coverage entries to source spans in segmented clause data. In some embodiments, the canonical coverage data structure 2202 can be augmented into an enriched coverage data structure by staged AI enrichment operations that populate missing property attributes and hazard classification fields, enabling severity scaling and exposure modeling to reflect actual property characteristics and hazard context.

In step 2204, the system can generate and/or access an inventory item data structure 2204 comprising a plurality of inventory item entries. In an exemplary embodiment, each inventory item entry can include at least an item category field and an item value field, and can optionally include supporting evidence fields such as a receipt attachment identifier. The inventory item data structure 2204 can be associated with an insured property and, in a claim context, can also be associated with a claim record and claim-related document identifiers.

In step 2206, the system can perform a comparison operation 2206 between a sublimit value stored in the canonical coverage data structure 2202 and one or more item values stored in the inventory item data structure 2204. In an exemplary embodiment, the comparison operation 2206 can select an inventory item entry having an item category that corresponds to a category addressed by a special limit clause, and can compare the item value of that entry to the applicable sublimit value. The comparison operation 2206 can apply one or more rules, such as selecting the sublimit that corresponds to a category token normalized during canonicalization, applying a threshold for high-value items, and aggregating values across multiple inventory items in the same category. The comparison operation 2206 can output a discrepancy determination when an item value, or an aggregated category subtotal, exceeds a corresponding policy sublimit, thereby identifying a coverage shortfall condition that is not readily apparent from static policy summaries.

In step 2208, the system can generate a discrepancy data structure 2208 that stores the results of the comparison operation 2206 in a machine-usable form. In an exemplary embodiment, the discrepancy data structure 2208 can include a discrepancy type field, a discrepancy severity field, and an evidence citation field referencing the evidence index associated with the canonical coverage data structure 2202. The discrepancy severity field can be computed based on a difference between the sublimit value and the item value, and can be further scaled using enrichment-derived hazard classification data where applicable, such as scaling severity when the item category corresponds to a hazard-sensitive exposure, and the hazard classification indicates elevated risk. The evidence citation field can enable the system to surface the policy clause that established the sublimit as part of a dispute package or claim artifact, thereby preserving evidence-anchored explainability for the discrepancy output.

Advantageously, the workflow of FIG. 32 provides a practical application by producing a concrete discrepancy data structure derived from structured comparisons between machine-readable policy constraints and machine-readable inventory records. Prior approaches often require a homeowner or professional to manually locate special limits in policy documents and manually cross-check inventories and receipts. The present system improves computer processing by normalizing policy constraints into canonical fields, structuring inventory information into standardized entries, performing automated comparisons, and generating discrepancy outputs with evidence citations, enabling downstream automation such as claim artifact population and dispute package assembly based on reproducible computations rather than abstract guidance.

Referring to FIG. 33, there is illustrated a claim artifact generation workflow that can be executed by the insurance policy-and-claim document normalization and event-driven claims readiness automation system to populate a claim-ready document template using structured discrepancy outputs and structured inventory item data. In the illustrated embodiment, the workflow includes technical steps 2302-2308 in which machine-usable data structures are transformed into a template-ready artifact output suitable for submission, sharing, or inclusion in a dispute package.

In step 2302, the system can generate and/or access a discrepancy data structure 2302 representing one or more discrepancies detected between policy coverage constraints and inventory item values. In an exemplary embodiment, the discrepancy data structure 2302 can include a discrepancy type field, a discrepancy severity field, and an evidence citation field that references an evidence index mapping to source spans in segmented policy clause data. The discrepancy data structure 2302 can be produced by comparing sublimit values in a canonical or enriched coverage representation to item values in an inventory item data structure, and can be scaled using enrichment-derived hazard classification data to reflect risk-sensitive exposure.

In step 2304, the system can generate and/or access an inventory item data structure 2304 comprising inventory item entries associated with an insured property and, where applicable, a claim record. In an exemplary embodiment, each inventory item entry can include an item category field and an item value field, and can optionally include attachment identifiers for receipts, photos, appraisals, or invoices. The inventory item data structure 2304 can be used to assemble claim-ready itemized lists and to compute subtotals by category or by inclusion criteria.

In step 2306, the system can select and apply a claim-ready document template 2306. In an exemplary embodiment, the claim-ready document template 2306 can be a proof-of-loss template, an inventory summary template, a discrepancy report template, or a dispute support template. The template can define structured fields and sections configured to be populated with values computed from the discrepancy data structure 2302 and the inventory item data structure 2304. The template can also include placeholders for evidence citations that reference specific policy source spans, enabling the produced artifact to remain evidence-anchored rather than being a generic narrative.

In step 2308, the system can generate a claim artifact data structure 2308 comprising an artifact output field configured to populate the claim-ready document template 2306 using at least the discrepancy data structure 2302 and the inventory item data structure 2304. In an exemplary embodiment, generating the claim artifact data structure 2308 can include assembling an itemized list of inventory item entries satisfying an inclusion rule, computing one or more subtotals from item values, inserting discrepancy summaries including the discrepancy type and severity, and inserting evidence citations that reference the evidence index. The claim artifact data structure 2308 can be stored as a machine-readable representation and can also be rendered into a human-readable output format for transmission or upload, while preserving linkage to the underlying evidence and the computational provenance of the values.

Advantageously, the workflow of FIG. 33 provides a practical application by producing a concrete, template-ready claim artifact output generated from structured data transformations rather than from manual drafting. Prior approaches typically require a user to manually compile inventory lists, locate policy clauses, and assemble supporting documentation. The present system improves computer processing by structuring both policy constraints and inventory records, generating discrepancies with evidence citations, and automatically populating a claim-ready template to produce a standardized artifact suitable for submission or dispute preparation. This grounding in specific data structures, template population operations, and evidence-linked outputs supports eligibility by emphasizing technical implementation and reproducible automation rather than abstract claim advice.

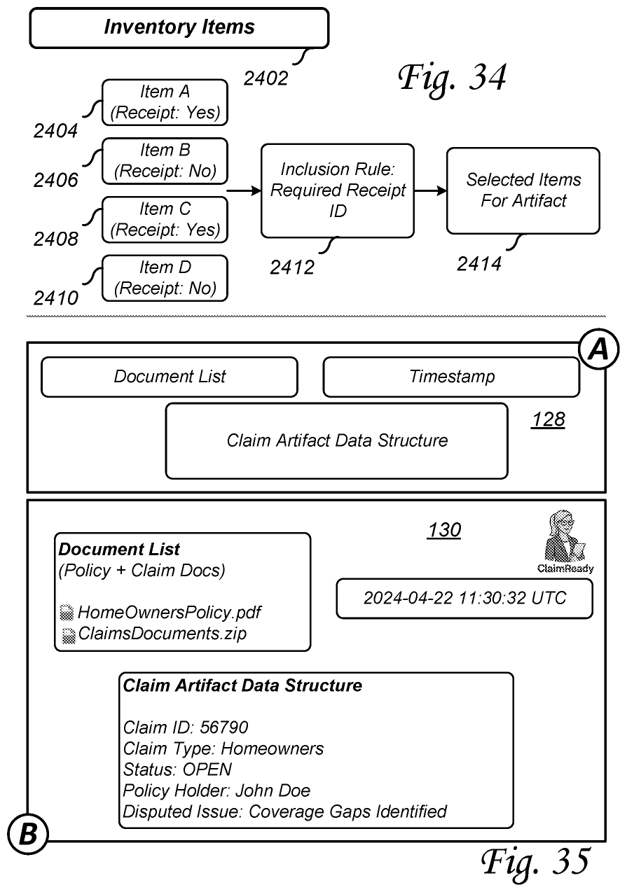

Referring to FIG. 34, there is illustrated an inclusion rule evaluation workflow that can be executed by the insurance policy-and-claim document normalization and event-driven claims readiness automation system to select a subset of inventory item entries for inclusion in a claim artifact based on a rule requiring supporting documentation. In the illustrated embodiment, the workflow includes elements 2402-2414, where 2402 identifies a category of inventory items (and is not itself a processing step), items 2406-2410 represent example inventory item entries under that category, and the system applies an inclusion rule 2412 to generate selected items 2414 for artifact population.

In step 2404, the system can generate and/or access an inventory dataset represented as a set of candidate inventory item entries that may be evaluated for inclusion in a claim artifact. In an exemplary embodiment, the system can obtain these candidate inventory item entries from an inventory item data structure associated with an insured property and, where applicable, a claim record. The candidate inventory item entries can include structured fields such as an item category field, an item value field, and a receipt attachment identifier field, enabling programmatic evaluation rather than manual review.

In step 2406, the system can evaluate a first inventory item entry 2406 (Item A) that includes an indicator reflecting whether a supporting receipt identifier is present. In the illustrated example, Item A is shown with “Receipt: Yes,” which can correspond to a populated receipt attachment identifier field or other evidence field. In an exemplary embodiment, the system can interpret this indicator as satisfying a required-evidence condition used for inclusion.

In step 2408, the system can evaluate a second inventory item entry 2408 (Item B) that is shown with “Receipt: No.” In an exemplary embodiment, this can correspond to a missing or null receipt attachment identifier field. The system can interpret this absence as failing to satisfy the required-evidence condition, and the system can either exclude the item from the selected set or generate a follow-on task requesting supporting documentation, depending on configuration.

In step 2410, the system can evaluate a third and fourth inventory item entry 2410 (Items C and D, respectively) with corresponding receipt indicators. In the illustrated example, Item C is shown with “Receipt: Yes” and Item D is shown with “Receipt: No.” In an exemplary embodiment, each item can be evaluated using the same inclusion rule logic such that the system can consistently apply documentary requirements across multiple inventory items without manual checking.

In step 2412, the system can apply an inclusion rule 2412 to the evaluated inventory item entries. In an exemplary embodiment, the inclusion rule 2412 can require that an inventory item entry include a receipt identifier, a photo identifier, an appraisal identifier, or another supporting evidence identifier, and can further include thresholds, such as applying the requirement only when an item value exceeds a configured value threshold or when the item category corresponds to a special limit category in the canonical or enriched coverage data structure. The inclusion rule 2412 can be stored in non-transitory memory and can be versioned as part of the system's configuration to support repeatable artifact generation.

In step 2414, the system can generate a selected items output 2414 representing inventory item entries that satisfy the inclusion rule 2412 and are therefore eligible for inclusion in a claim artifact. In an exemplary embodiment, the selected items output 2414 can be stored as a selection list data structure that can be consumed by an artifact generator to populate a claim-ready template with an itemized list and computed subtotals. The selected items output 2414 can also be used to drive workflow automation, such as generating tasks to obtain receipts for excluded items or to request additional evidence for items that are relevant to a discrepancy detected between policy sublimits and inventory values.

Advantageously, the workflow of FIG. 34 provides a practical application by performing a rule-based, machine-executable selection of inventory items for claim artifact population using structured evidence indicators, rather than relying on manual review of receipts and spreadsheets. Prior approaches often require a claimant to guess which items require documentation and to assemble proof ad hoc. The present system improves computer processing by representing inventory entries as structured records, applying deterministic inclusion rules, and generating a machine-usable selected set that can be directly used for template population and downstream automation, thereby grounding the functionality in specific data structures and computations rather than abstract guidance.

Referring to FIG. 35, there is illustrated a dispute package data structure that can be generated and stored by the insurance policy-and-claim document normalization and event-driven claims readiness automation system to package claim-support materials into a machine-usable, time-stamped record suitable for submission, sharing, and audit. FIG. 35 is shown in the lower portion of the page and includes a technical view designated by reference ‘A’ (dispute package structure 128) and a corresponding exemplary embodiment designated by reference ‘B’ (example data 130). The inclusion rule evaluation content shown elsewhere on the page is not part of FIG. 35 and is not described herein.

In the technical view ‘A’, the dispute package structure 128 can include a document list field, a timestamp field, and a claim artifact data structure region. In an exemplary embodiment, the dispute package structure 128 can be stored as a machine-readable container object associated with a claim record and can be configured to persist the specific set of documents and generated artifacts that support a coverage position, discrepancy assertion, or claim submission package. The dispute package structure 128 can be generated by one or more processors executing instructions stored in non-transitory memory and can be saved in a data store to enable retrieval and re-use without requiring a user to manually assemble materials each time.

In an exemplary embodiment, the document list field can identify source documents included in the dispute package structure 128. The source documents can include at least a policy document file and one or more claim-related document files, such as a denial letter, a reservation-of-rights letter, an estimate, an information request, and supporting attachments. In some embodiments, the document list field can store document identifiers that correspond to documents previously ingested by a document ingestion interface, along with optional metadata such as document hashes, file types, and ingestion timestamps, so that the dispute package remains tied to specific document versions and can be verified for integrity.

In an exemplary embodiment, the timestamp field can store a time value indicating creation time, revision time, and/or export time for the dispute package structure. The timestamp field can be used to support deadline compliance and auditability, such as demonstrating when a response package was assembled relative to a proof-of-loss deadline, an insurer request deadline, or another policy condition. In some embodiments, the timestamp field can be linked to a provenance log so that an audit view can reconstruct the rule set versions, enrichment sources, and formula versions used to compute values included in the claim artifact data structure.

In an exemplary embodiment, in reference ‘B’, the claim artifact data structure region can store a template-ready artifact output generated from one or more machine-usable intermediate representations. For example, the claim artifact data structure can include an itemized inventory list, computed subtotals, discrepancy summaries, and evidence citations that reference an evidence index mapping canonical coverage entries to source spans in segmented clause data. The claim artifact data structure can therefore serve as a structured payload that can be rendered into a claim-ready document template, such as a proof-of-loss template or discrepancy report template, while preserving evidence anchoring and computed values derived from canonical and enriched coverage representations.

In the exemplary embodiment ‘B’, the example data 130 can populate the dispute package structure 128 with representative values. In an exemplary embodiment, the document list field can list example documents, such as a homeowners' policy PDF and one or more claim-related correspondence items, and the timestamp field can include an example date and time corresponding to package generation. The claim artifact data structure region can include an example generated artifact identifier or artifact content summary indicating that a claim-ready package has been prepared, such as a proof-of-loss draft, an inventory excerpt, or a discrepancy summary tied to policy sublimits. While the example values are illustrative, the structure demonstrates how the system can store a dispute package as a cohesive machine-readable record rather than as manually assembled emails or unstructured folders.

Advantageously, the dispute package structure 128 provides a practical application by producing a concrete, structured container that bundles specific ingested documents and machine-generated claim artifacts into a time-stamped record suitable for downstream processing, transmission, and audit. Prior approaches commonly require a homeowner or professional to manually assemble PDFs and supporting materials and to reconstruct which version of a policy or estimate was used. The present system can improve computer processing by generating a dispute package from structured intermediate representations, maintaining integrity and traceability through document identifiers and timestamps, and preserving evidence-anchored outputs that remain linked to the underlying policy clauses. This grounding in specific data structures and automated packaging operations supports eligibility by emphasizing technical implementation and reproducible automation rather than abstract claim advice.

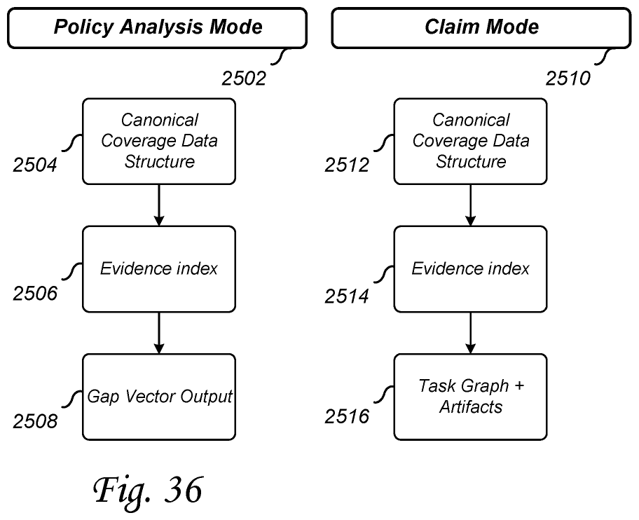

Referring to FIG. 36, there is illustrated an end-to-end operational mode framework in which the insurance policy-and-claim document normalization and event-driven claims readiness automation system can reuse the same machine-usable intermediate representations across a policy analysis mode and a claim mode. In the illustrated embodiment, policy analysis mode 2502 includes steps 2504-2508, and claim mode 2510 includes steps 2512-2516, with both modes sharing a common canonical coverage data structure and evidence index to provide consistent, evidence-anchored computation and automation.

In step 2504 under policy analysis mode 2502, the system can generate and/or access a canonical coverage data structure 2504 derived from one or more homeowners' policy document files. In an exemplary embodiment, the canonical coverage data structure 2504 can be produced by text extraction, clause segmentation, and canonicalization, and can include standardized fields such as coverage type, limits, sublimits, exclusions, and conditions. This structured representation can provide a technical improvement by converting heterogeneous policy documents into a machine-usable format that supports deterministic computation and consistent evaluation across different insurer formats.

In step 2506 under policy analysis mode 2502, the system can generate and/or access an evidence index 2506 that maps entries of the canonical coverage data structure 2504 to corresponding source spans in segmented clause data. In an exemplary embodiment, the evidence index 2506 can store evidence references that enable retrieval of specific policy clause text supporting a normalized entry or a computed gap output. This evidence mapping can enable explainability and auditability by preserving a reference path from each computed output back to the precise policy language used to generate it.

In step 2508 under policy analysis mode 2502, the system can generate a gap vector output 2508 comprising a plurality of structured gap signals. In an exemplary embodiment, each gap signal can include a gap type, severity, confidence, and evidence reference pointing into the evidence index 2506. The severity and confidence values can be computed using clause alignment and field completeness metrics, and can be further influenced by staged enrichment and formula-based exposure, modeling where policy documents omit coverage-relevant property and hazard fields. The gap vector output 2508 can be rendered in a report interface and can be exported as a machine-readable output record for downstream automation.

In step 2512 under claim mode 2510, the system can generate and/or access the canonical coverage data structure 2512 for use during a claim process. In an exemplary embodiment, the canonical coverage data structure 2512 can be the same representation generated in policy analysis mode 2502, or can be regenerated from stored inputs, thereby maintaining consistent coverage interpretation across pre-claim and post-loss scenarios. This reuse can improve technical consistency and reduce discrepancies that can arise when claim handling uses different representations than preparedness analysis.

In step 2514 under claim mode 2510, the system can generate and/or access the evidence index 2514 corresponding to the canonical coverage data structure 2512. In an exemplary embodiment, the evidence index 2514 can be used to surface policy clause evidence in claim-mode workflows, including for explaining why a task exists, why a deadline applies, or why a particular discrepancy is flagged. This enables the system to couple workflow automation with evidence anchoring so that claim actions remain traceable to policy language and extracted conditions.

In step 2516 under claim mode 2510, the system can generate and maintain task graph and artifacts 2516 using the canonical coverage data structure 2512 and the evidence index 2514. In an exemplary embodiment, the system can generate a document event stream from ingested claim-related document files, create and update a task graph with dependency edges, required artifact fields, deadline fields, and completion state fields, and maintain deadline timers that compute time-to-deadline values and trigger notifications. The system can also generate claim artifacts, including proof-of-loss template outputs and dispute package data structures, using structured inventory item data and discrepancy outputs that reference evidence citations tied to the evidence index 2514.

Advantageously, FIG. 36 illustrates a practical application that reuses the same machine-usable intermediate representations across distinct operational modes, enabling consistent computation, evidence-anchored explainability, and automated workflow control. Prior approaches commonly treat policy review and claim handling as separate, disconnected processes requiring redundant manual interpretation and re-entry of information. The present system improves computer processing by generating a canonical coverage representation and evidence index that can be reused for both gap vector outputs in policy analysis mode and task graph and artifact generation in claim mode, thereby grounding functionality in specific data structures, computed metrics, and automated outputs rather than abstract guidance.

### Additional Exemplary Embodiments

In an exemplary embodiment, the system can generate and maintain an insurance health score that represents a computed, machine-derived measure of policy readiness for a particular insured property. The insurance health score can be generated from a combination of normalized policy constraints in the canonical coverage data structure, enriched property and hazard fields in the enriched coverage data structure, and computed gap signals in the coverage-gap vector data structure. The score can be computed as a weighted function that penalizes high-severity and high-confidence gap signals while also incorporating completeness measures, such as whether required coverage-relevant fields have been populated through enrichment or user confirmation. The system can store historical score values in a time-series record associated with a user session or claim record, allowing the user interface to display improvements or degradations over time and allowing the processing core to re-compute scores when new policy versions, endorsements, enrichment results, or inventory updates are ingested. This longitudinal score history provides a concrete technical output that is reproducible from stored intermediate representations, rather than a subjective narrative assessment.

In an exemplary embodiment, the system can support a renewal workflow in which the policy analysis is re-executed when a renewal policy document file, endorsement, or declarations page is received. The system can perform document-change detection by comparing document hashes, form identifiers, extracted declarations values, and normalized coverage entries across versions, and can selectively re-run only those computational components impacted by detected differences. For example, if the system detects a change to a limit field, sublimit field, exclusion field, or condition field, the system can regenerate affected gap signals, re-compute severity and confidence fields, and update the insurance health score and exposure models. In some embodiments, the system can create tasks in the task graph to prompt review of changed values, to request updated inventory items for affected categories, or to confirm that enrichment-derived values remain accurate. This provides a technical improvement by enabling incremental recomputation and controlled updates from structured deltas rather than requiring manual re-reading of entire policy documents.

In an exemplary embodiment, enrichment operations can return conflicting values for the same property attribute field, such as square footage, construction type, or valuation. The system can implement a conflict resolution routine that normalizes candidate values into comparable units, assigns authority scores based on source type and recency, and selects a resolved value using precedence logic. The system can optionally surface conflicting values in a user interface confirmation panel, enabling a user to select a preferred value or to enter a corrected value. The system can store the selected value together with provenance metadata identifying whether the value was API-derived, web-agent-derived, or user-provided, and can store a retrieval log record documenting which sources were considered and how the resolution was performed. By structuring enrichment conflict resolution as a deterministic routine over machine-usable records, the system improves reliability and auditability relative to ad hoc manual lookup and reduces downstream propagation of incorrect modeling inputs.

In an exemplary embodiment, the system can compute and store an external data authority score for enrichment-derived values, where the authority score is based on source classification and retrieval metadata. Sources can be classified into categories, including structured APIs, authoritative public records, hazard repositories, or less authoritative web content. The authority score can be used in confidence composition for gap signals, where hazard-driven or valuation-driven severity scaling is reduced when enrichment inputs are uncertain. The system can also govern retrieval behavior using rate limiting, caching, and retrieval fallback logic, such as querying an API first, then using an AI web retrieval agent, and then prompting for manual user entry if external retrieval is unavailable. These governance controls provide concrete implementation details that support enablement and reinforce that the system performs controlled data acquisition and normalization rather than abstract “web searching.”

In an exemplary embodiment, the reference distribution dataset used to compute percentile ranking can be segmented into cohorts to improve relevance of comparative risk scoring. The system can select a cohort distribution using enrichment-derived attributes such as geographic region, hazard classification, construction type, dwelling value band, or home age band. The percentile computation subsystem can then compute percentile ranking within the selected cohort distribution and store both the resulting percentile value and a cohort identifier. In some embodiments, the system can apply smoothing or minimum-sample thresholds to avoid unstable rankings when cohort sizes are small, and can fall back to a broader cohort when necessary. These mechanisms provide additional technical depth to the percentile ranking subsystem and support a practical application where computed risk position is derived from structured datasets and deterministic computation rather than subjective labeling.

In an exemplary embodiment, the system can generate a recommendation package that includes selected gap signals, modeled exposure values, evidence references, and suggested coverage adjustments, and can transmit the recommendation package to a third party such as an insurance agent or a claims professional. The system can generate the recommendation package as a machine-readable export record containing canonical coverage entries, enriched values used for modeling, and provenance metadata identifying the data sources and version identifiers used during computation. The system can also generate a human-readable rendering of the package while preserving the ability to trace each recommendation to an evidence reference. This packaging and transmission functionality provides a practical application that moves beyond analysis into structured, evidence-backed outputs usable in real insurance workflows.

In an exemplary embodiment, the system can implement a retention policy that separates temporary processing artifacts from persistent machine-readable outputs. For example, raw uploaded policy PDFs and claim documents can be stored for a limited duration or in a user-controlled vault, while the canonical coverage data structure, evidence index pointers, and computed outputs can be stored in a reduced, privacy-preserving representation that omits unneeded personal identifiers. The system can selectively store source span descriptors and clause identifiers without storing full clause text, and can regenerate displayed text excerpts on demand using the evidence reference and controlled access to the source document. This approach provides a concrete technical mechanism for privacy and security while maintaining evidence-anchored explainability.

In an exemplary embodiment, the system can support multiple insured properties per user and can associate distinct canonical coverage data structures, enrichment records, and score histories with each property record. The system can further support multiple policy document files per property, such as separate homeowners, flood, and umbrella policies, and can normalize coverage fields across multiple policies into a combined coverage representation. In some embodiments, the system can generate cross-policy gap signals, such as identifying that flood exposure is elevated and that the homeowner lacks a flood policy file in the property record. This portfolio functionality strengthens enablement and supports broader commercial product use without narrowing the claims.

In an exemplary embodiment, the system can implement escalation logic that triggers additional user prompts, verification tasks, or notification signals when confidence is below a threshold or when time-to-deadline falls below a threshold. For example, when a claim correspondence document is classified with low classifier confidence, the system can request user confirmation of the document event type before creating high-urgency tasks. When a policy-derived deadline parameter is detected, the system can instantiate a deadline timer and can generate escalating reminders as the deadline approaches, optionally attaching an evidence-linked excerpt of the clause establishing the deadline.

### Insurance Exposure Mapping and Modeled Financial Exposure Outputs

In an exemplary embodiment, the system can generate and maintain an insurance exposure mapping for an insured property by transforming heterogeneous policy document files and claim-related document files into machine-usable intermediate representations and then computing one or more modeled exposure values that quantify potential financial exposure under the policy as written. The insurance exposure mapping can be particularly beneficial for homeowners' policies, where meaningful constraints are distributed across declarations pages, forms, endorsements, special limits, exclusions, and conditions, and where the significance of a given exclusion or limitation depends on property-specific attributes and hazard classification data that may not be explicitly stated in the policy document file.

In an exemplary embodiment, the insurance exposure mapping can be generated from a canonical coverage data structure that comprises standardized coverage fields and coverage entry objects normalized from policy text. The standardized coverage fields can include a coverage type field, a limit field, a sublimit field, an exclusion field, and a condition field. The system can generate an evidence index that maps each of a plurality of entries in the canonical coverage data structure to corresponding source spans in segmented clause data. As a result, the insurance exposure mapping can preserve an evidence-anchored relationship between computed exposure outputs and the underlying policy language that supports the standardized field values used in the computations. This evidence anchoring can enable reproducible recomputation and auditability by allowing the system to retrieve, display, and verify the clause excerpts that establish a limit, sublimit, exclusion, or condition that materially contributes to a computed exposure value.

In an exemplary embodiment, the system can detect missing coverage-relevant fields required to compute modeled exposure values and can populate such fields through staged enrichment. For example, when the canonical coverage data structure does not include sufficient property data to compute replacement cost or other loss modeling parameters, the system can initiate a first enrichment operation to retrieve supplemental property data from one or more external data sources and/or user input. The supplemental property data can include one or more of a home size value, a home configuration value, a home construction attribute value, or a home valuation value. The system can insert the supplemental property data into the canonical coverage representation to form an enriched coverage data structure that is suitable for downstream modeling. In an exemplary embodiment, after property enrichment, the system can identify a missing hazard classification field and can initiate a second enrichment operation to retrieve hazard data based on one or more property values obtained in the first enrichment operation. The hazard data can include FEMA flood zone data and related hazard modifiers. The system can insert hazard data into the enriched coverage data structure, thereby enabling exposure computations that incorporate both policy constraints and risk context.

In an exemplary embodiment, the system can compute a modeled loss amount as an intermediate value used to derive modeled financial exposure. The modeled loss amount can be computed using one or more deterministic formulas or models that operate on the enriched coverage data structure. For example, a dwelling-related modeled loss amount can be computed using a replacement cost value derived from home size, construction attributes, and a regional cost index. A contents-related modeled loss amount can be computed using inventory item values or category subtotals derived from an inventory item data structure. A code upgrade-related modeled loss amount can be computed using building age, configuration, jurisdictional indicators, or other attributes. The modeled loss amount can be computed as a single value or as a set of values corresponding to multiple coverage categories, and the system can store the modeled loss amount as a machine-usable value linked to provenance metadata that identifies the formulas, coefficients, or rule versions used during computation.

In an exemplary embodiment, the system can compute a coverage shortfall value by comparing a modeled loss amount to an applicable policy constraint stored in the canonical or enriched coverage representation. The applicable policy constraint can include a limit value, a sublimit value, a deductible value, or an exclusion-triggered effective coverage constraint. For example, a coverage shortfall can be computed as a difference between a replacement cost estimate and a dwelling coverage limit, or as a difference between an inventory category subtotal and a special limit sublimit. Where a deductible applies, the system can compute an out-of-pocket component representing the deductible contribution. Where exclusions apply, the system can compute an exclusion exposure indicator representing that a modeled loss component may not be recoverable under the policy due to an exclusion field match or an exclusion condition. The computed coverage shortfall can be stored as a machine-usable numeric value and can be associated with a gap signal record.

In an exemplary embodiment, the system can compute an adjusted exposure value by applying one or more hazard modifiers to a coverage shortfall value or to a modeled loss amount. Hazard modifiers can be derived from hazard classification fields, such as FEMA flood zone data, and can be stored as normalized hazard modifier values in the enriched coverage data structure. In one implementation, the system can apply a hazard modifier as a scalar multiplier that increases an exposure estimate in higher-risk zones to reflect increased likelihood or impact of loss scenarios. In another implementation, the system can apply hazard modifiers as categorical severity scalers that influence prioritization rather than direct dollar scaling. The system can store the applied hazard modifier and the adjusted exposure value as part of the insurance exposure mapping so that the computation can be reproduced and so that the effect of hazard data on exposure outputs can be explained.

In an exemplary embodiment, the insurance exposure mapping can be represented as a structured exposure profile data structure stored in a data store and associated with an insured property record and, when applicable, a claim record. The exposure profile data structure can include one or more modeled exposure values, one or more coverage shortfall values, one or more deductible or out-of-pocket components, and one or more hazard-adjusted exposure values. The exposure profile data structure can also include links to the evidence index through evidence references, enabling the system to retrieve policy source spans corresponding to the constraints used in each computation. The exposure profile data structure can further include computed confidence values that indicate reliability of particular exposure outputs, where confidence can be computed based on a clause match score, a field completeness score, an external data authority score, and a model reliability score. By storing exposure outputs and associated computed confidence values, the system can programmatically determine which outputs are suitable for automated prioritization and which outputs should be presented with additional user confirmation prompts.

In an exemplary embodiment, the system can generate and maintain a coverage-gap vector data structure comprising a plurality of gap signals, and each gap signal can be associated with one or more exposure mapping outputs. For example, a hazard exclusion gap signal can be associated with a hazard-adjusted exposure value that scales a coverage shortfall based on hazard classification. A sublimit restriction gap signal can be associated with an item-category shortfall value derived from inventory entries. A duration limit gap signal can be associated with a time-based exposure indicator computed from a condition field and estimated repair duration proxies. The system can use these associations to generate prioritized gap lists and to compute aggregate exposure summaries that quantify the total modeled exposure across multiple gap categories.

In an exemplary embodiment, the system can present insurance exposure mapping outputs via a user interface and/or export them in a machine-readable format. The user interface can present modeled exposure values, shortfall values, and hazard-adjusted exposure values along with evidence-anchored excerpts of the policy clauses that establish the underlying constraints. The system can provide user-selectable controls that permit a user to drill down from an exposure value to an associated gap signal and from the gap signal to the underlying source span in the policy document file. The system can also provide user-selectable controls that permit a user to confirm, correct, or override enrichment-derived property values and hazard classification values, and can recompute affected exposure outputs and gap signal severities responsive to such updates. The export format can include an exposure profile data structure, evidence references, and provenance metadata so that third-party systems or professional users can consume the outputs deterministically.

Advantageously, the insurance exposure mapping described herein provides a practical application that produces concrete, reproducible computer-generated outputs derived from structured intermediate representations and deterministic computations. Prior approaches often provide generalized recommendations or narrative summaries that do not quantify exposure, do not preserve an evidence path to specific policy clauses, and cannot be consistently recomputed when new documents or property data become available. In contrast, the described system improves computer processing of heterogeneous insurance documents by generating standardized coverage representations, linking those representations to source spans through an evidence index, augmenting missing fields through staged enrichment, and computing modeled exposure outputs and coverage shortfalls that can be ranked, audited, exported, and used to drive automated workflows. This architecture is rooted in specific data transformations, computed metrics, and stored machine-usable structures that provide technical improvements and concrete outputs beyond abstract policy interpretation.

### Exposure Profile Data Structure and Modeled Loss Outputs

In an exemplary embodiment, the system can generate an exposure profile data structure that stores one or more modeled loss outputs and one or more derived exposure outputs in a machine-usable form for reproducible processing, ranking, and reporting. The exposure profile data structure can be generated after the system has created a canonical coverage data structure and an evidence index, and after the system has populated missing coverage-relevant fields by generating an enriched coverage data structure. The exposure profile data structure can be associated with an insured property record and, when applicable, a claim record, and can be stored in a data store for later retrieval, recomputation, and audit.

In an exemplary embodiment, the exposure profile data structure can store a modeled loss amount. The modeled loss amount can be a computed numeric value representing a modeled cost associated with a loss scenario or a coverage category. The modeled loss amount can be computed using deterministic formulas, statistical models, or stored coefficients applied to fields in the enriched coverage data structure. For example, the modeled loss amount can be computed for a dwelling-related scenario using a replacement cost value derived from enrichment-derived property attributes such as home size and construction attributes and one or more construction cost index values. In another example, the modeled loss amount can be computed for a personal property scenario using values derived from an inventory item data structure, including item value fields and category subtotals. In another example, the modeled loss amount can be computed for a temporary housing scenario using policy-derived loss of use limits, duration conditions, and externally retrieved regional cost indicators. The system can store the modeled loss amount together with provenance metadata identifying inputs used, computation timestamp, and optionally a formula or model version identifier, enabling reproducible recomputation.

In an exemplary embodiment, the exposure profile data structure can store a coverage shortfall value computed by comparing the modeled loss amount to at least one policy constraint. The policy constraint can be a limit value stored in a limit field and/or a sublimit value stored in a sublimit field of the canonical or enriched coverage data structure. For example, the system can compute a dwelling shortfall by subtracting a dwelling coverage limit from a modeled replacement cost value. The system can compute a category shortfall by subtracting a policy special limit sublimit from an inventory category subtotal. The system can also incorporate deductible fields by computing a deductible contribution component that represents an out-of-pocket amount even when the modeled loss amount is below a limit value. The computed coverage shortfall value can be stored as a numeric field within the exposure profile data structure and can be linked to a corresponding coverage entry object and evidence reference, enabling the system to identify which policy clause established the constraint used in the computation.

In an exemplary embodiment, the exposure profile data structure can store an adjusted exposure value generated based on the coverage shortfall value. The adjusted exposure value can represent a computed estimate of financial exposure that can be used to prioritize gaps, generate recommendations, and support claim readiness outputs. In one implementation, the adjusted exposure value can be equal to the coverage shortfall value. In another implementation, the adjusted exposure value can incorporate scaling based on hazard classification fields, confidence scores, or other weighting functions. The system can store, alongside the adjusted exposure value, the intermediate values used to derive it, such as the modeled loss amount and the policy constraint values, so that the adjusted exposure value remains computable and auditable rather than being a standalone label.

In an exemplary embodiment, the exposure profile data structure can include links to evidence references that resolve to source spans in the evidence index. For example, when the exposure profile stores a coverage shortfall value based on a sublimit, the exposure profile can store an evidence reference that links to the specific policy clause establishing that sublimit. When the exposure profile stores an adjusted exposure value derived from a condition such as a duration limit, the exposure profile can store an evidence reference linking to the clause establishing that condition. These evidence links can enable an interface to display not only the computed values but also the precise policy language supporting the inputs to the computation, improving transparency and reducing disputes that arise from non-traceable summaries.

In an exemplary embodiment, the system can use the exposure profile data structure as an input to generate or update a coverage-gap vector and to control prioritization of outputs. For example, a gap signal associated with a high adjusted exposure value can be ranked above a gap signal with a lower adjusted exposure value, even when both gaps are present, and the ranking can be further refined using confidence fields and deadline-based risk conditions. The system can also compute aggregate exposure outputs by summing or otherwise aggregating adjusted exposure values across multiple gap categories, and can store such aggregate values as part of the exposure profile.

Advantageously, the exposure profile data structure provides a practical application by storing computed modeled loss amounts, coverage shortfall values, and adjusted exposure values as machine-usable outputs derived from structured intermediate representations. Prior approaches often provide narrative assessments or static checklists that do not preserve intermediate computed values and cannot be reproducibly recomputed when inputs change. The present system improves computer processing of heterogeneous insurance documents by producing standardized coverage representations, enriching missing coverage-relevant fields, computing modeled loss and shortfall values using deterministic computations, and storing those computed values in a structured exposure profile linked to evidence references. This architecture provides concrete, auditable outputs suitable for automated ranking, workflow control, and report generation rather than abstract policy interpretation.

### Hazard-Modifier Scaling of Coverage Shortfall for Adjusted Exposure Computation

In an exemplary embodiment, the system can compute an adjusted exposure value by applying a hazard modifier value derived from a hazard classification field to a coverage shortfall value. This hazard-modifier scaling can allow the system to account for contextual risk factors that materially affect the practical significance of a given policy limitation or exclusion, particularly in homeowners' policies where hazard exposure can vary substantially by location and property characteristics. The hazard-modifier scaling can be executed as a computer-implemented computation that operates on machine-usable intermediate representations, including an enriched coverage data structure, an exposure profile data structure, and a coverage-gap vector data structure.

In an exemplary embodiment, the system can generate or access a hazard classification field within an enriched coverage data structure. The hazard classification field can be populated through staged enrichment operations, including retrieving property attribute data in a first enrichment operation and retrieving hazard data in a second enrichment operation based on one or more values obtained in the first enrichment operation. The hazard data can comprise FEMA flood zone data, and the system can normalize the FEMA flood zone data into a standardized hazard classification token stored in the hazard classification field. In some embodiments, the hazard classification field can additionally store related attributes, such as panel identifiers, effective dates, elevation proxies, or other metadata, and can store provenance information indicating the external data source, retrieval timestamp, and authority score associated with the retrieved hazard data.

In an exemplary embodiment, the system can derive a hazard modifier value from the hazard classification field. The hazard modifier value can be computed or selected from a hazard modifier table stored in non-transitory memory and indexed by hazard classification token. For example, different FEMA flood zone classifications can map to different hazard modifier values, and the hazard modifier table can be versioned so that computations remain reproducible even when modifier mappings are updated over time. In some embodiments, the hazard modifier value can be computed using multiple factors, including hazard classification, property configuration, and construction attributes, such that the hazard modifier value reflects both geographic hazard exposure and structural vulnerability.

In an exemplary embodiment, the system can compute a coverage shortfall value using the exposure profile logic described herein. The coverage shortfall value can be computed by comparing a modeled loss amount to one or more policy constraints stored in standardized fields, such as a limit field or a sublimit field. The modeled loss amount can represent a computed replacement cost estimate, a contents category subtotal, a modeled additional living expense duration amount, or other modeled loss values derived from enriched coverage data and, where applicable, inventory data. The coverage shortfall value can represent an amount that exceeds an applicable policy constraint or an out-of-pocket component expected to be borne by the insured due to policy structure.

In an exemplary embodiment, the system can compute an adjusted exposure value by applying the hazard modifier value to the coverage shortfall value. In one implementation, the adjusted exposure value can be computed as a scalar multiplication in which the hazard modifier value scales the coverage shortfall value, thereby increasing or decreasing the adjusted exposure value based on hazard classification. In another implementation, the hazard modifier value can be applied in a bounded manner, such as clamping adjusted exposure values to defined ranges or applying tier-based scaling in which hazard modifiers select a severity band. In another implementation, the hazard modifier value can be applied selectively based on gap type, such that hazard-modifier scaling is applied primarily to hazard-sensitive gaps, such as water-related exclusions, drainage-related limitations, or elevation-sensitive risk categories, while other gaps are not hazard-scaled. The chosen scaling behavior can be stored as a configuration and can be logged in provenance metadata to preserve repeatability.

In an exemplary embodiment, the system can associate the adjusted exposure value with one or more gap signals in a coverage-gap vector data structure. For example, when an exclusion pattern match indicates that flood or surface water is excluded, and the hazard classification field indicates elevated flood exposure, the system can compute a coverage shortfall or exposure estimate and scale that value using the hazard modifier value. The resulting adjusted exposure value can then be stored as part of an exposure profile and can also be used to generate or modify the severity field of the gap signal. In some embodiments, the adjusted exposure value can be used as an input to a risk percentile computation subsystem that compares the adjusted exposure value against a reference distribution dataset and produces a percentile ranking value that can be displayed in a dashboard and used to prioritize recommendations.

In an exemplary embodiment, the system can preserve evidence-anchored explainability when applying hazard-modifier scaling. The hazard classification field can be associated with external data retrieval provenance, and the policy-derived exclusion or condition can be associated with an evidence reference that resolves to a source span in the policy document. The system can store, in the exposure profile and/or gap signal record, both the evidence reference for the policy clause and a retrieval log reference for the hazard data. The user interface can render an evidence-linked clause excerpt alongside the computed hazard classification and hazard modifier value, thereby enabling a user to understand that the adjusted exposure value reflects both policy language and external hazard context.

Advantageously, hazard-modifier scaling provides a practical application by producing a computed adjusted exposure value that can be used to prioritize coverage gaps, generate evidence-anchored recommendations, and drive automated claim readiness workflows. Prior approaches often treat hazard context and policy analysis as separate activities, requiring manual cross-referencing of maps, property data, and policy exclusions. The present system improves computer processing by integrating hazard classification retrieval into a staged enrichment pipeline, normalizing hazard data into structured fields, computing a hazard modifier value deterministically, and applying the hazard modifier to a computed coverage shortfall to generate an adjusted exposure value suitable for machine-driven ranking, reporting, and workflow control. This grounding in concrete data structures and deterministic computation strengthens technical character and provides reproducible, auditable outputs beyond abstract policy interpretation.

### Replacement Cost Computation Using External Cost Indices and Limit-Based Severity Generation

In an exemplary embodiment, the system can compute a replacement cost value using enrichment-derived property attributes and an externally retrieved construction cost index value, and can generate a severity value for a coverage-gap signal based on a difference between the replacement cost value and a policy limit value stored in a limit field. This embodiment can be particularly applicable to homeowners' policies where dwelling coverage adequacy is difficult to evaluate from policy documents alone because replacement-cost drivers such as square footage, construction type, and regional cost factors are not consistently stated in the policy document file.

In an exemplary embodiment, the system can populate a home size value and one or more home construction attribute values through a first enrichment operation using an AI web retrieval agent and/or a structured API interface. The home size value can include square footage or another standardized measure of size, and the home construction attribute values can include construction type, story count, roof type, construction year, or other structural descriptors. The system can normalize these values into standardized units and standardized tokens stored in an enriched coverage data structure so that subsequent computations operate on machine-usable fields rather than on free-form text.

In an exemplary embodiment, the system can retrieve a construction cost index value from one or more external data sources. The construction cost index value can represent regional or local cost factors that affect replacement cost and can be retrieved via an API, via a web retrieval agent, or via another controlled external interface. The system can normalize the construction cost index value into a standardized representation, such as a numeric multiplier or indexed cost-per-unit measure, and can store provenance metadata identifying the source identifier, retrieval timestamp, and optional authority score associated with the construction cost index value.

In an exemplary embodiment, the system can compute a replacement cost value by applying one or more formulas to the home size value, the home construction attribute values, and the construction cost index value. In one implementation, the system can compute a base replacement cost per unit area using the construction cost index value and a construction-type factor derived from the home construction attribute values, and can multiply the base replacement cost per unit area by the home size value to generate a base replacement cost value. The system can then apply one or more adjustment factors based on configuration values or detected property attributes, such as adding adjustments for multi-story configuration, specialty materials, or regional labor differentials. The system can store the replacement cost value as a computed field in an exposure profile data structure and/or in the enriched coverage data structure, and can store metadata identifying the computation formula version and input values used, enabling reproducible recomputation.

In an exemplary embodiment, the system can obtain a policy limit value from a limit field stored in a canonical coverage data structure. The limit field can be populated during canonicalization by extracting and normalizing dwelling coverage limits from declarations pages and related policy clauses and normalizing limit qualifiers into standardized tokens where applicable. The system can link the limit field to an evidence index entry that references a source span in segmented clause data, enabling later display of the policy language or declarations value supporting the extracted limit.

In an exemplary embodiment, the system can compute a limit difference value by comparing the replacement cost value to the policy limit value stored in the limit field. For example, the system can compute the limit difference value as the replacement cost value minus the policy limit value when the replacement cost value exceeds the policy limit value, representing a modeled underinsurance shortfall. In some embodiments, the system can compute a difference ratio or a shortfall percentage by dividing the limit difference value by the replacement cost value or by the policy limit value. The computed difference can be stored as a coverage shortfall value within an exposure profile and can be associated with one or more gap signals.

In an exemplary embodiment, the system can generate a severity value for a gap signal based on the difference between the replacement cost value and the policy limit value. In one implementation, the severity value can be proportional to the limit difference value, such as scaling severity based on the magnitude of the modeled shortfall. In another implementation, the severity value can be generated by mapping shortfall percentages into severity bands, such as low, medium, and high severity categories, with thresholds stored in non-transitory memory and optionally versioned for reproducibility. In another implementation, the system can combine the limit-based severity with hazard modifiers derived from hazard classification fields, such that dwelling underinsurance severity is increased when hazard indicators suggest higher expected losses.

In an exemplary embodiment, the system can generate an evidence-anchored output by associating the severity value and related computed fields with an evidence reference that references the evidence index. The evidence reference can resolve to the source span where the relevant policy limit value was extracted, such as a declarations page entry or a coverage clause. The system can also store provenance metadata and retrieval log records for the construction cost index value and the property attribute inputs used in computing replacement cost. The user interface can present the computed replacement cost value, the policy limit value, the computed shortfall, and the severity indication, and can allow a user to view the supporting policy source span and external-data provenance indicators. This structured linkage supports explainability and auditability for the computed outputs.

Advantageously, this embodiment provides a practical application by converting policy language and external property and cost index data into a computed replacement cost value and a computed severity value that can drive automated prioritization and workflow generation. Prior approaches often rely on generalized heuristics or manual estimates that are difficult to reproduce and that do not provide evidence-anchored justification. The present system improves computer processing by retrieving and normalizing missing property attributes and construction cost indices, applying deterministic formulas to compute replacement cost, comparing the computed replacement cost to a policy limit stored in standardized fields, and generating severity values that are traceable to both policy evidence and external-data inputs. This grounding in machine-usable data structures, deterministic computation, and evidence linkage strengthens the technical character of the disclosure and supports eligibility by emphasizing concrete computer-implemented transformations and outputs rather than abstract coverage advice.

The capabilities of the present invention can be implemented in software, firmware, hardware, or some combination thereof.

As one example, one or more aspects of the present invention can be included in an article of manufacture (e.g., one or more computer program products) having, for instance, computer usable media. The media has embodied therein, for instance, computer-readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

1. An insurance policy-and-claim document normalization and event-driven claims readiness automation system comprising:
a document ingestion interface configured to receive (i) a policy document file and (ii) a claim-related document file associated with the policy document file;
one or more processors;
a non-transitory memory storing instructions that, when executed by the one or more processors, cause the insurance policy-and-claim document normalization and event-driven claims readiness automation system to:
perform text extraction on the policy document file to generate policy text data;
segment the policy text data into a plurality of policy clauses to generate segmented clause data;
generate, from the segmented clause data, a canonical coverage data structure comprising a standardized set of coverage fields including at least: a coverage type field, a limit field, a sublimit field, an exclusion field, and a condition field;
generate an evidence index that maps each of a plurality of entries in the canonical coverage data structure to a corresponding source span in the segmented clause data;
detect, based on the canonical coverage data structure, a missing coverage-relevant field comprising at least one of a property value field, a property attribute field, or a property configuration field; initiate, responsive to detecting the missing coverage-relevant field, a first artificial intelligence (AI) web enrichment operation using an AI web retrieval agent to retrieve first supplemental property data from one or more external data sources, wherein the first supplemental property data comprises at least one of a home size value, a home configuration value, a home construction attribute value, or a home valuation value;
generate an enriched coverage data structure by inserting the first supplemental property data into the canonical coverage data structure to populate the missing coverage-relevant field;
generate, based on the enriched coverage data structure, a coverage-gap vector data structure comprising a plurality of gap signals, wherein each gap signal includes (i) a gap type field, (ii) a severity field, (iii) a confidence field, and (iv) an evidence reference that references the evidence index; and
output, via a user interface, (i) a gap signal from the plurality of gap signals and (ii) a corresponding source span identified by the evidence reference;
wherein generating the enriched coverage data structure provides a technical improvement in computer processing of heterogeneous insurance policy documents by automatically augmenting a machine-usable standardized coverage representation with externally retrieved property data to enable reproducible generation of the coverage-gap vector data structure across policy document files having incomplete or omitted coverage-relevant fields.

2. The insurance policy-and-claim document normalization and event-driven claims readiness automation system of claim 1, wherein the instructions further cause the system to generate an exposure profile data structure that stores (i) a modeled loss amount, (ii) a coverage shortfall value computed by comparing the modeled loss amount to at least one of a limit value stored in the limit field or a sublimit value stored in the sublimit field, and (iii) an adjusted exposure value generated based on the coverage shortfall value.

3. The insurance policy-and-claim document normalization and event-driven claims readiness automation system of claim 2, wherein the adjusted exposure value is computed by applying a hazard modifier value derived from a hazard classification field to the coverage shortfall value.

4. The insurance policy-and-claim document normalization and event-driven claims readiness automation system of claim 1, wherein the instructions further cause the system to generate an exposure profile data structure that stores (i) a modeled loss amount, (ii) a coverage shortfall value computed by comparing the modeled loss amount to at least one of a limit value stored in the limit field or a sublimit value stored in the sublimit field, and (iii) an adjusted exposure value generated based on the coverage shortfall value.

5. The insurance policy-and-claim document normalization and event-driven claims readiness automation system of claim 1, wherein the instructions further cause the system to:
detect, after generating the enriched coverage data structure, a missing hazard classification field;
initiate, responsive to detecting the missing hazard classification field, a second AI web enrichment operation using the AI web retrieval agent to retrieve second supplemental hazard data from one or more external data sources based on at least one of the home size value, the home configuration value, the home construction attribute value, or the home valuation value; and
insert the second supplemental hazard data into the enriched coverage data structure to populate the missing hazard classification field;
wherein the second supplemental hazard data comprises FEMA flood zone data.

6. The insurance policy-and-claim document normalization and event-driven claims readiness automation system of claim 1, wherein the confidence field is generated based on (i) a clause match score computed from the segmented clause data and (ii) a coverage-field completeness score computed from the enriched coverage data structure.

7. The insurance policy-and-claim document normalization and event-driven claims readiness automation system of claim 1, wherein the condition field comprises a deadline parameter extracted from the policy document file, and wherein the coverage-gap vector data structure comprises a gap signal indicating a deadline-based risk condition responsive to the deadline parameter satisfying a time-to-deadline threshold.

8. The insurance policy-and-claim document normalization and event-driven claims readiness automation system of claim 1, wherein generating the canonical coverage data structure comprises normalizing at least one of: (i) an endorsement identifier, (ii) an exclusion descriptor, or (iii) a limit qualifier into a standardized vocabulary stored in a normalization table in the non-transitory memory.

9. (canceled)

10. A method of using the insurance policy-and-claim document normalization and event-driven claims readiness automation system of claim 1, the method comprising the steps of:
receiving, via the document ingestion interface, the policy document file and the claim-related document file;
extracting the policy text data from the policy document file;
segmenting the policy text data into the segmented clause data;
generating the canonical coverage data structure from the segmented clause data;
generating the evidence index that maps an entry in the canonical coverage data structure to a source span in the segmented clause data;
detecting the missing coverage-relevant field based on the canonical coverage data structure;
retrieving, using the AI web retrieval agent, the first supplemental property data;
generating the enriched coverage data structure by inserting the first supplemental property data into the canonical coverage data structure; and
generating the coverage-gap vector data structure based on the enriched coverage data structure.

11. An insurance policy-and-claim document normalization and event-driven claims readiness automation system comprising:
a document ingestion interface configured to receive (i) a policy document file and (ii) a plurality of claim-related document files associated with a claim record;
one or more processors;
a non-transitory memory storing instructions that, when executed by the one or more processors, cause the insurance policy-and-claim document normalization and event-driven claims readiness automation system to:
generate, from the policy document file, a canonical coverage data structure comprising a standardized set of coverage fields, including at least a condition field;
generate an evidence index that maps an entry in the canonical coverage data structure to a corresponding source span in extracted policy text;
classify each claim-related document file of the plurality of claim-related document files into a corresponding document event type to generate a document event stream;
generate and maintain, based on (i) the document event stream and (ii) the condition field, a task graph data structure comprising (i) a plurality of task nodes and (ii) a plurality of dependency edges between task nodes;
maintain a deadline timer data structure comprising a plurality of deadline timers, each deadline timer being associated with a corresponding task node of the plurality of task nodes; and
update the task graph data structure by adding, removing, or re-ranking at least one task node responsive to detecting a change in the document event stream;
wherein generating and updating the task graph data structure using the document event stream and the condition field provides a technical improvement by automatically controlling task sequencing and timer state across heterogeneous claim-related document files using machine-usable intermediate representations.

12. (canceled)

13. The insurance policy-and-claim document normalization and event-driven claims readiness automation system of claim 11, wherein each task node comprises (i) a task identifier field, (ii) a required artifact field, and (iii) a completion state field, and wherein the instructions further cause the system to set the completion state field based on detecting, within the plurality of claim-related document files, an artifact corresponding to the required artifact field.

14. The insurance policy-and-claim document normalization and event-driven claims readiness automation system of claim 11, wherein at least one deadline timer of the plurality of deadline timers is generated based on a deadline parameter stored in the condition field of the canonical coverage data structure.

15. (canceled)

16. The insurance policy-and-claim document normalization and event-driven claims readiness automation system of claim 11, wherein the instructions further cause the system to:
detect a missing coverage-relevant field in a coverage record associated with the claim record;
initiate a first artificial intelligence (AI) web enrichment operation using an AI web retrieval agent to retrieve first supplemental property data comprising at least one of a home size value, a home configuration value, a home construction attribute value, or a home valuation value;
initiate a second AI web enrichment operation using the AI web retrieval agent to retrieve second supplemental hazard data comprising FEMA flood zone data based on at least one value of the first supplemental property data; and
update at least one of the task graph data structure or the deadline timer data structure based on the second supplemental hazard data.

17. A method of using the insurance policy-and-claim document normalization and event-driven claims readiness automation system of claim 11, the method comprising the steps of:
receiving, via the document ingestion interface, the policy document file and the plurality of claim-related document files associated with the claim record;
generating the canonical coverage data structure from the policy document file;
generating the evidence index that maps an entry in the canonical coverage data structure to the corresponding source span in extracted policy text;
classifying each claim-related document file into the corresponding document event type to generate the document event stream;
generating the task graph data structure and the deadline timer data structure based on the document event stream and the condition field; and
updating the task graph data structure responsive to detecting the change in the document event stream.

18. An insurance policy-and-claim document normalization and event-driven claims readiness automation system comprising:
a document ingestion interface configured to receive (i) a policy document file, (ii) an inventory dataset, and (iii) a claim-related document file associated with a claim record;
one or more processors;
a non-transitory memory storing instructions that, when executed by the one or more processors, cause the insurance policy-and-claim document normalization and event-driven claims readiness automation system to:
generate, from the policy document file, a canonical coverage data structure comprising a standardized set of coverage fields including at least a sublimit field and a deductible field;
generate an evidence index that maps an entry in the canonical coverage data structure to a corresponding source span in extracted policy text;
generate, from the inventory dataset, an inventory item data structure comprising a plurality of inventory item entries, wherein each inventory item entry includes at least an item category field and an item value field;
detect, based on the canonical coverage data structure, a missing coverage-relevant field comprising at least one of a property value field, a property attribute field, or a property configuration field;
initiate, responsive to detecting the missing coverage-relevant field, a first artificial intelligence (AI) web enrichment operation using an AI web retrieval agent to retrieve first supplemental property data comprising at least one of a home size value, a home configuration value, a home construction attribute value, or a home valuation value;
initiate, after retrieving the first supplemental property data, a second AI web enrichment operation using the AI web retrieval agent to retrieve second supplemental hazard data comprising FEMA flood zone data based on at least one value of the first supplemental property data;
generate an enriched coverage data structure by inserting at least the first supplemental property data and the second supplemental hazard data into the canonical coverage data structure;
generate a discrepancy data structure by comparing (i) the sublimit field of the enriched coverage data structure to (ii) the item value field of at least one inventory item entry having a corresponding item category field, wherein the discrepancy data structure includes an evidence citation field that references the evidence index; and
generate, based on the discrepancy data structure, a claim artifact data structure comprising an artifact output field configured to populate a claim-ready document template using at least the discrepancy data structure and the inventory item data structure;
wherein generating the enriched coverage data structure, the discrepancy data structure, and the claim artifact data structure provides a technical improvement by converting unstructured coverage constraints and inventory inputs, augmented by staged external data enrichment, into a template-ready artifact output with evidence-anchored traceability.

19. The insurance policy-and-claim document normalization and event-driven claims readiness automation system of claim 18, wherein the discrepancy data structure further comprises (i) a discrepancy type field and (ii) a discrepancy severity field, and wherein the discrepancy severity field is generated based on a difference between a sublimit value stored in the sublimit field and an item value stored in the item value field.

20. The insurance policy-and-claim document normalization and event-driven claims readiness automation system of claim 18, wherein the discrepancy severity field is further generated based on the FEMA flood zone data.

21. The insurance policy-and-claim document normalization and event-driven claims readiness automation system of claim 18, wherein the claim artifact data structure is configured to populate a proof-of-loss document template by inserting (i) a list of inventory item entries satisfying an inclusion rule stored in the non-transitory memory and (ii) a computed subtotal value derived from the item value field for the list of inventory item entries.

22. The insurance policy-and-claim document normalization and event-driven claims readiness automation system of claim 18, wherein the instructions further cause the system to store the claim artifact data structure in a dispute package data structure that comprises (i) a document list field identifying the policy document file and the claim-related document file and (ii) a timestamp field.

23. A method of using the insurance policy-and-claim document normalization and event-driven claims readiness automation system of claim 18, the method comprising the steps of:
receiving the policy document file, the inventory dataset, and the claim-related document file;
generating the canonical coverage data structure from the policy document file;
generating the evidence index that maps an entry in the canonical coverage data structure to the corresponding source span in extracted policy text;
retrieving, using the AI web retrieval agent, the first supplemental property data;
retrieving, using the AI web retrieval agent and based on at least one value of the first supplemental property data, the second supplemental hazard data comprising FEMA flood zone data;
generating the enriched coverage data structure by inserting the first supplemental property data and the second supplemental hazard data into the canonical coverage data structure;
generating the inventory item data structure from the inventory dataset;
generating the discrepancy data structure by comparing the sublimit field to the item value field of the at least one inventory item entry having the corresponding item category field; and
generating the claim artifact data structure comprising the artifact output field configured to populate the claim-ready document template.
